(19) United States
(12) Patent Application Publication
(10) Pub. No.: US 2026/0064034 A1
(43) Pub. Date: Mar. 5, 2026

(54) DEVELOPING APPARATUS, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: RYO SUGIYAMA, Shizuoka (JP); TAIJI KATSURA, Shizuoka (JP); KENTA MATSUNAGA, Shizuoka (JP); ATSUSHI NOGUCHI, Shizuoka (JP)

(21) Appl. No.: 19/304,772

(22) Filed: Aug. 20, 2025

(30) Foreign Application Priority Data
Aug. 27, 2024 (JP) 2024-145429

(51) Int. Cl. G03G 15/08; C09D 175/04; G03G 9/08; G03G 9/093; G03G 21/18

(52) U.S. Cl. CPC G03G 15/0808; C09D 175/04; G03G 9/0823; G03G 9/0827; G03G 9/09342; G03G 21/1814; G03G 2215/0604

(57) ABSTRACT

A developing apparatus comprising: a developing roller and a toner, wherein the developing roller comprises specific constitutions, an outer surface of the developing roller is formed of at least a specific first region and a second region having higher conductivity than the first region, the first region and the second region are placed adjacent to each other, the toner comprises a toner particle and a fine particle, the fine particle comprises a compound comprising a specific metal element, when the toner surface is measured by X-ray photoelectron spectroscopy, the abundance ratio of the metal element is 2.0 to 20.0 atomic %, and an average circularity of the toner is 0.970 or more.

### BACKGROUND

### Field of the Technology

The present disclosure relates to a developing apparatus, a process cartridge, and an electrophotographic image forming apparatus.

### Description of the Related Art

In order to increase printing speed, improvements in apparatus performance have been pursued in electrophotographic image forming apparatuses (electrophotographic apparatuses), such as increasing the process speed and reducing the interval between sheets of paper during printing. Furthermore, with the growing environmental awareness in recent years, energy saving in electrophotographic apparatuses has been increasingly demanded.

Increasing the process speed of the electrophotographic apparatus tends to increase the drive torque when driving the electrophotographic apparatus, resulting in an increase in energy consumption. For this reason, in order to save energy while increasing the process speed, it is required to significantly reduce the drive torque of the electrophotographic apparatus.

A large proportion of the drive torque of an electrophotographic apparatus is due to a developing apparatus, and among others, the torque generated between a toner supply roller and a developing roller accounts for most of the torque. Therefore, if the drive torque between the toner supply roller and the developing roller can be reduced, it can greatly contribute to an increase in process speed and energy saving. In order to reduce the drive torque of the developing apparatus, for example, the contact area of the toner supply roller with the developing roller is reduced, or the peripheral speed difference between the developing roller and the toner supply roller is reduced, or the toner supply roller may be eliminated. However, when the contact area of the toner supply roller is reduced, the peripheral speed difference is reduced, or the toner supply roller is eliminated as described above, the toner supply function of the toner supply roller to the developing roller may be impaired, resulting in a decrease in the toner transporting amount on the developing roller, which may lead to a decrease in image density.

In order to solve the problems associated with such a reduction in the drive torque of the developing apparatus, a developing roller having an outer surface formed of an insulating portion and a conductive portion has been studied. When this developing roller is used in an electrophotographic apparatus, the insulating portion on the surface is charged by triboelectric charging between the developing roller and the toner, and injection charging for injecting charges by a potential difference between the developing roller and another contact member, mainly, a developing blade. When the insulating portion is charged, a microelectric field due to a potential difference is formed between the charged insulating portion and a conductive portion which has high conductivity and is not charged. Due to this microelectric field, a gradient force, which is a force in the direction of attraction to the outer surface of the developing roller, is generated around the developing roller. Since the toner around the developing roller is attracted to the developing roller by this gradient force, the developing roller can transport a sufficient amount of the toner even when the drive torque between the toner supply roller and the developing roller is reduced.

In addition, if the insulating portion is charged by injection charging, it is less susceptible to the influence of factors other than the developing roller, such as the state of the toner, compared with triboelectric charging, and the toner transporting force can be stably ensured.

In addition, when the contact area of the toner supply roller is reduced, the peripheral speed difference is reduced, or the toner supply roller is eliminated, a recovery function of the toner supply roller, which is another function thereof, for recovering undeveloped toner from the developing roller, is impaired. When the toner is not recovered from the developing roller, the undeveloped toner on the developing roller undergoes repeated rubbing with a contact member such as a developing blade. On the other hand, toner newly coated on a region where the toner has been developed on the developing roller undergoes rubbing with a contact member only once.

As described above, there is a difference in the number of times the toner is rubbed between the region where the toner has been developed and the region where the toner has not been developed on the developing roller, so that a difference occurs in the toner charge amount in each region, and a ghost image may appear. Furthermore, the toner that has not been developed may deteriorate due to repeated rubbing on the developing roller, and the toner may melt-adhere to the developing roller and appear as a density non-uniformity image.

Japanese Patent Application Publication No. 2016-051097 discloses an image forming apparatus in which a potential difference between a developing roller, configured such that a plurality of dielectric portions are scattered on a surface composed of a conductive portion, and a developing blade is applied so as to be greater during non-image formation than during image formation. By making the potential difference between the developing roller and the developing blade greater during non-image formation than during image formation, it is possible to refresh the toner on the developing roller and thereby improve ghost suppression, solid image followability, and melt adhesion of toner to the developing roller.

### SUMMARY

However, according to the studies made by the inventors, in the image forming apparatus disclosed in Japanese Patent Application Publication No. 2016-051097, if the interval between sheets of paper is reduced during printing in order to increase the printing speed, a ghost image or melt adhesion of toner to a developing roller may occur.

The present disclosure provides a developing apparatus capable of suppressing the occurrence of ghost images, image density non-uniformity caused by melt adhesion of toner to the developing roller, and toner transport failure, without relying on control of the potential difference between the developing roller and the developing blade during non-image formation, even in a state where the drive torque of the developing apparatus is reduced. In addition, another aspect of the present disclosure provides a process cartridge, that is detachable from a main body of an electrophotographic image forming apparatus, and includes the above developing apparatus. Still another aspect of the present disclosure provides an electrophotographic image forming apparatus including the process cartridge.

The present disclosure relates to a developing apparatus comprising: a developing roller and a toner, wherein the developing roller comprises a substrate having a conductive outer surface, and a conductive layer on the outer surface of the substrate, an outer surface of the developing roller is formed of at least a first region and a second region having higher conductivity than the first region, the first region and the second region are placed adjacent to each other, the first region is placed on an outer surface of the conductive layer, the toner comprises a toner particle and a fine particle, the fine particle comprises a compound comprising a metal element, the metal element is at least one element selected from the group consisting of a titanium element, an aluminum element, a zirconium element, and a zinc element, when the toner surface is measured by X-ray photoelectron spectroscopy, the abundance ratio of the metal element is 2.0 to 20.0 atomic %, and an average circularity of the toner is 0.970 or more.

The present disclosure provides a process cartridge configured to be attachable to and detachable from a main body of an electrophotographic image forming apparatus, the process cartridge comprising a developing unit, wherein the developing unit comprises the above developing apparatus. Further, other embodiment of the present disclosure provides an electrophotographic image forming apparatus comprising a developing unit, wherein the developing unit comprises the above developing apparatus.

According to the present disclosure, there are provided a developing apparatus, a process cartridge, and an electrophotographic image forming apparatus capable of suppressing the occurrence of ghost images, image density non-uniformity caused by melt adhesion of toner to the developing roller, and toner transport failure, even in a state where the drive torque of the developing apparatus is reduced.

Features of the present disclosure will become apparent from the following description of embodiments with reference to the attached drawing. The following description of embodiments is described by way of example.

### BRIEF DESCRIPTION OF THE DRAWINGS

FIG. 1 is a schematic view of a developing apparatus;

FIG. 2A is a schematic cross-sectional view showing an example of a developing roller, and FIG. 2B is a schematic outer surface view showing an example of a developing roller;

FIG. 3 is a schematic cross-sectional view showing another example of the developing roller;

FIG. 4 is a schematic view of a process cartridge;

FIG. 5 is a schematic view of an electrophotographic image forming apparatus;

FIG. 6 is a schematic view showing a state in which a measuring electrode is formed on a developing roller;

FIG. 7 is a cross-sectional view of the developing roller and the measuring electrode;

FIG. 8 is a schematic view of an impedance measurement system;

FIG. 9 is a schematic view showing an example of an apparatus for measuring the surface potential of a developing roller;

FIG. 10 is a schematic view of a circuit for measuring a leakage current flowing from a toner to a developing roller; and

FIG. 11 is a schematic view of an electrophotographic image forming apparatus for image evaluation.

### DESCRIPTION OF THE EMBODIMENTS

In the present disclosure, the description “from XX to YY” or “XX to YY” representing a numerical range means a numerical range including a lower limit and an upper limit, which are endpoints, unless otherwise specified. In a case where numerical ranges are described stepwise, an upper limit and a lower limit of each numerical range can be arbitrarily combined. In addition, in the present disclosure, the description such as “at least one selected from the group consisting of XX, YY, and ZZ” means any of XX, YY, and ZZ, a combination of XX and YY, a combination of XX and ZZ, a combination of YY and ZZ, or a combination of XX, YY, and ZZ. In a case where XX is a group, a plurality of members may be selected from XX, and the same is true for YY and ZZ.

The inventors have estimated the reasons why ghost images and melt adhesion of toner to developing rollers occur when the interval between sheets of paper is shortened during printing in the image forming apparatus according to Japanese Patent Application Publication No. 2016-051097 as follows.

As the interval between sheets of paper during printing is shortened, the non-image forming section also becomes shorter. As the non-image forming section becomes shorter, the non-image forming section becomes narrower than one turn of the developing roller. In this case, it is assumed that even if the potential difference between the developing roller and the developing blade during non-image formation is made larger than that during image formation, the toner on the developing roller cannot be sufficiently refreshed. Therefore, it is considered that a difference in the number of times the toner is rubbed between a region where the toner is developed and a region where the toner is not developed on the developing roller may result in the appearance of a ghost image, or that the repeatedly rubbed toner may melt-adhere to the developing roller.

The present inventors considered that, if the toner on the developing roller can be replaced without relying on control of the potential difference between the developing roller and the developing blade during non-image formation, ghost images and melt adhesion of toner can be suppressed regardless of the interval between sheets of paper, even when the drive torque of the developing apparatus is reduced.

Specifically, a study was conducted to reduce the non-electrostatic attachment force by removing charged electricity from the toner during rubbing with a contact member, through control of the triboelectric series between the toner and a contact member such as the developing roller or a regulating member. However, in the above method, it was difficult to stably achieve both the provision of charged electricity to the toner, which is necessary for obtaining proper image quality, and sufficient removal of charged electricity from the toner for replacing the toner on the developing roller. In addition, when used for a long period in an environment such as a low-temperature and low-humidity environment where toner components are likely to adhere to each contact member, it was difficult to maintain the balance between the provision of charged electricity to the toner and the removal of charged electricity from the toner, due to a change in the triboelectric series relationship with the toner caused by a change in the surface characteristics of each contact member.

That is, it was recognized that, in order to achieve excellent image quality while realizing reduction in drive torque of the developing apparatus, improvement in printing speed, and long-term use, a new solution is required that does not rely on bias control during non-image formation or control of the triboelectric series between the toner and the contact member. Based on such recognition, the inventors further conducted studies.

As a result, it has been recognized that the developing apparatus of the present disclosure is effective as the above solution.

The present disclosure relates to a developing apparatus comprising: a developing roller and a toner, wherein the developing roller comprises a substrate having a conductive outer surface, and a conductive layer on the outer surface of the substrate, an outer surface of the developing roller is formed of at least a first region and a second region having higher conductivity than the first region, the first region and the second region are placed adjacent to each other, the first region is placed on an outer surface of the conductive layer, the toner comprises a toner particle and a fine particle, the fine particle comprises a compound comprising a metal element, the metal element is at least one element selected from the group consisting of a titanium element, an aluminum element, a zirconium element, and a zinc element, when the toner surface is measured by X-ray photoelectron spectroscopy, the abundance ratio of the metal element is 2.0 to 20.0 atomic %, and an average circularity of the toner is 0.970 or more.

The present inventors assume the following as the reason why the developing apparatus was able to suppress ghost images and image density non-uniformity caused by melt adhesion of toner, without relying on bias control during non-image formation or control of the triboelectric series between the toner and the contact member, by satisfying the above requirements.

The first reason is that charge exchange between toners is more likely to occur. The toner according to the present disclosure includes a toner particle and a fine particle having a compound containing a metal element, and the metal element is at least one element selected from the group consisting of a titanium element, an aluminum element, a zirconium element, and a zinc element. In addition, when the toner surface is measured by X-ray photoelectron spectroscopy, the abundance ratio of the metal element is from 2.0 to 20.0 atomic %. As a result, the conductivity of the toner in the surface direction is appropriately reduced, and charge exchange is likely to occur when the toners come into contact with each other.

The second reason is that the toner carried on the developing roller is liable to roll when subjected to a shear force due to contact with the toner in the developing apparatus. In order to roll the toner on the developing roller by the shear force, it is necessary that the toner has a sufficiently spherical shape to roll and that the toner and the developing roller have an attachment force sufficient to prevent them from slipping.

First, since the average circularity of the toner is 0.970 or more, the toner becomes a spherical shape that allows the toner to roll, and the toner becomes easy to roll when a shear force is applied to the toner.

Further, the developing roller has a first region and a second region having higher conductivity than the first region placed adjacent to each other on the outer peripheral surface. The first region is an insulating portion, and the second region is a conductive portion. By using such a developing roller, a gradient force, which is a force in a direction to be attracted to the surface of the developing roller, is generated in the vicinity of the surface of the developing roller. The gradient force is relatively smaller than the image force, and since it acts as a moderate attachment force, the toner becomes likely to roll on the developing roller without sliding relative to the developing roller. As the toner on the developing roller rolls, the contact area between the toner on the developing roller and the toner in the developing apparatus increases significantly as compared with the case where the toner does not roll. In addition, the occurrence of toner transport failure is suppressed.

Due to the above two reasons, namely, that the toner easily exchanges charge with other toner and that the toner easily rolls on the developing roller, thereby increasing the contact area between toners, rapid charge exchange occurs between the charged toner on the developing roller and the uncharged toner in the developing apparatus. As a result, the charge amount of the toner on the developing roller is rapidly reduced, and the attachment force between the developing roller and the toner is rapidly reduced. As a result, the toner on the developing roller is peeled off from the developing roller by the shear force or centrifugal force generated by the rotation of the developing roller, and the toner in the developer container is newly attracted to the developing roller by the gradient force. That is, the toner on the developing roller is spontaneously replaced while it passes through the developing apparatus.

Thus, by combining the developing roller and the toner according to the present disclosure, the toner on the developing roller can be spontaneously replaced without depending on the bias control during non-image formation or the control of the triboelectric series between the toner and the contact member. As a result, it is assumed that the occurrence of the above ghost images and density non-uniformity images caused by melt adhesion of toner to the developing roller could be suppressed, and the occurrence of toner transport failure could also be suppressed.

Hereinafter, the present disclosure will be described in detail.

### Developing Apparatus

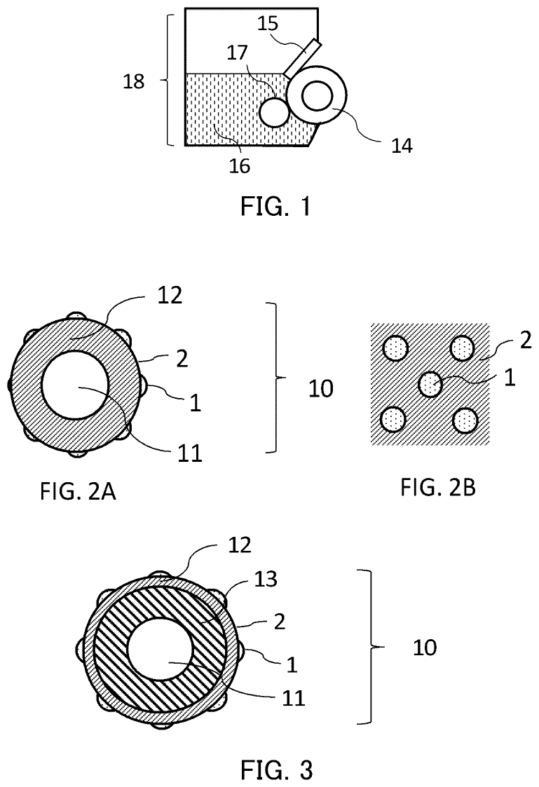

A developing apparatus according to the present disclosure includes a developing roller and a toner. An example of a cross-sectional view of a developing apparatus according to the present disclosure is illustrated in FIG. 1. The developing apparatus 18 is filled with a toner 16. The toner 16 is supplied to the surface of a developing roller 14 by a toner supply roller 17, or attracted to the developing roller 14 by a gradient force, and a layer of the toner 16 having a predetermined thickness is formed on the surface of the developing roller 14 by a developing blade 15.

### Developing Roller

A developing roller includes a substrate having a conductive outer surface and a conductive layer on the outer surface of the substrate. An outer surface of the developing roller is formed of at least a first region (insulating portion) and a second region (conductive portion) having higher conductivity than the first region, the first region and the second region are placed adjacent to each other, and the first region is placed on an outer surface of the conductive layer.

An example of a schematic cross-sectional view of the developing roller is shown in FIG. 2A and an example of a schematic outer surface view is shown in FIG. 2B. In a developing roller 10 illustrated in FIG. 2A, a conductive layer 12 is laminated on the outer peripheral surface of a substrate 11 in a cylindrical or hollow tubular shape. Further, the outer surface of the developing roller is formed of a first region 1 and a second region 2 having higher conductivity than the first region, and the second region 2 is formed of the outer surface of the conductive layer 12. The first region 1 is formed of an outer surface of an insulator disposed on the outer surface of the conductive layer 12 so that the outer surface of the conductive layer is exposed. The first region may be configured by disposing an insulator on an outer surface of the conductive layer 12, or may be configured by exposing an insulator incorporated in the conductive layer 12.

Note that the configuration of the layer of the developing roller is not limited to the configuration illustrated in FIG. 2A. Another embodiment of the developing roller is, as shown in FIG. 3, a developing roller having an elastic layer 13 between a substrate 11 and a conductive layer 12 provided on the outer peripheral surface of the substrate 11.

In addition, it is preferable that the developing roller satisfies the following two requirements, since toner transport failure can be suppressed while further suppressing the above ghost images and image density non-uniformity.

### Requirement (1)

When a metal film is directly provided on an outer surface of a developing roller, and while changing the frequency between 1.0×10⁻¹ to 1.0×10⁵ Hz, an AC voltage with an amplitude of 50 V is applied between an outer surface of the substrate and the metal film while a DC voltage of 50 V is applied in an environment at a temperature of 23° C. and a relative humidity of 50%, an impedance at a frequency of 1.0×10⁰ to 1.0×10¹ Hz is 1.0×10⁶Ω or more.

### Requirement (2)

In a case where when a corona discharger having a grid portion with a width of 3.0 mm is placed in an environment at a temperature of 23° C. and a relative humidity of 50% such that a distance between the grid portion and an outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured, the potential at t=0.06 [sec] is denoted by V_{INI} [V], a change in the potential at 30.00≤t≤100.00 is fitted to formula (X′) below by a least squares method to obtain V_{0,1} [V] and τ₁ [sec], when a value of a potential V₁(t) at the time of substituting t=0.06 [sec] into formula (X′) is denoted by V₁ [V], V_{INI}−V₁ is less than 20.0 V.

$${V}_{1} ( t ) = {V}_{0 , 1} exp ( - t / {τ}_{1} ) \qquad ( X ’ )$$

The above requirements (1) and (2) will be described in detail below.

### Technical Significance of Requirement (1)

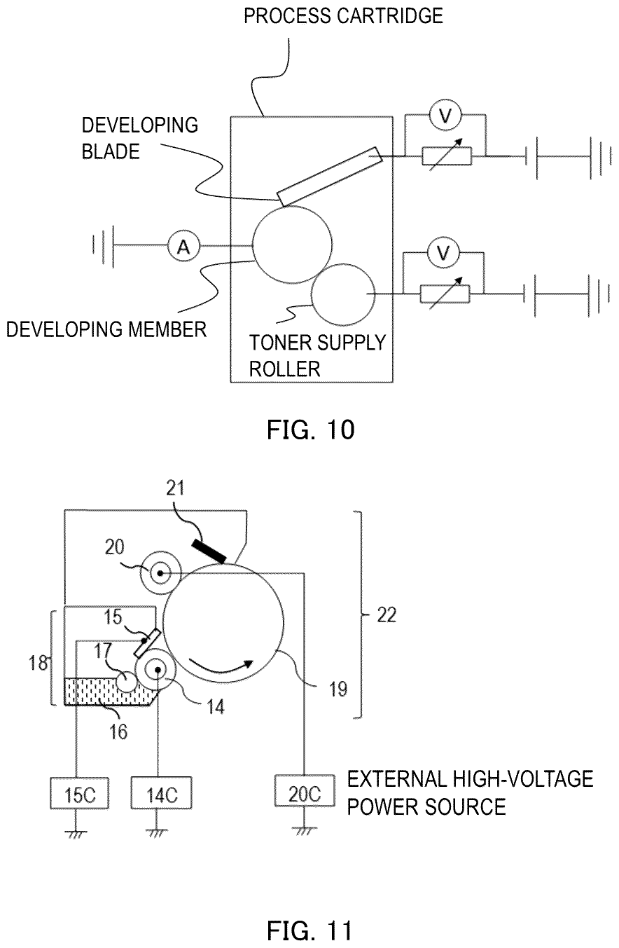

The requirement (1) specifies a numerical value of the impedance of the developing roller. This impedance is a physical property value showing the property of charge leakage from the toner to the second region forming the outer surface of the developing roller, that is, the conductive portion. The inventors measured a current value (leakage current value) flowing through the developing roller when a blade bias is applied to a developing blade according to a circuit diagram shown in FIG. 10. As a result, it was found that this current value shows a higher correlation with the impedance value of the developing roller than the electric resistance value of the developing roller.

Furthermore, it was found that, when the outer surface of the developing roller is formed of an insulating portion (first region) and a conductive portion (second region), the impedance value exhibits the property of the conductive portion having higher conductivity.

That is, charge leakage indicates that not only a resistance component of the developing roller (conductive portion) but also the influence of an electrostatic capacitance component needs to be considered. This is considered to be because when the electrical characteristics of the developing roller are pseudo-represented by an RC parallel circuit, charges are sufficiently accumulated in a capacitor component, and the transient state to the steady state in which a resistance component is dominant has a large influence on the charge leakage.

The voltage application condition for impedance measurement is that an AC voltage of 50 V is superposed on a DC voltage of 50 V. That is, sine waves with the minimum and maximum values of the applied voltage of 0 V and 100 V (Vpp 100 V) are applied. The value of Vpp 100 V is a value obtained by assuming the maximum value of the shared voltage applied to the developing roller when a voltage is applied so that a voltage difference of 300 V is applied between the developing roller and the developing blade in the electrophotographic image forming apparatus.

Although the impedance exhibits bias dependence and has a property of decreasing the impedance with increasing bias, it has been found that the degree of decrease varies depending on the developing roller. While the voltage application condition is generally an AC voltage of 1 V in the conventional impedance measurement of the developing roller, the AC voltage of 1 V is clearly lower than the voltage (generally several hundred volts) applied between the developing roller and the developing blade in an actual electrophotographic image forming apparatus. For this reason, the behavior of the developing roller in the electrophotographic image forming apparatus is often not simulated, and the impedance measurement conditions are often inadequate.

Therefore, in the present disclosure, a voltage application condition simulating a high blade bias applied to an actual electrophotographic image forming apparatus is adopted. The sine wave with the minimum applied voltage of 0 V simulates a rectangular wave commonly used for applying the blade bias of the actual electrophotographic image forming apparatus.

In the present disclosure, an impedance at a frequency of 1.0×10⁰ to 1.0×10¹ Hz is specified, and the low frequency range of the frequency of 1.0×10⁰ to 1.0×10¹ Hz is a region where the transient state is completed and a steady state in which the resistance component is dominant is reached. That is, the influence of both the electrostatic capacitance component and the resistance component is reflected, and this is a region suitable for ascertaining the property of charge leakage from the toner to the conductive portion. When the impedance at a frequency of 1.0×10⁰ to 1.0×10¹ Hz is 1.0×10⁶Ω or more, the charge leakage property of the conductive layer is low, so the charge leakage from the toner to the conductive layer is likely to be suppressed under a high blade bias. The toner according to the present disclosure has low resistance in the surface direction and is likely to be injected with charge from the developing blade. Furthermore, since charge leakage to the conductive layer is suppressed, it becomes easier to quickly impart charge to the toner having a low charge amount after being replaced on the developing roller. Thus, a difference in the charge amount of the toner on the developing roller is less likely to occur, and ghost images can be more easily suppressed.

The impedance at the frequency of 1.0×10⁰ to 1.0×10¹ Hz is preferably 1.4×10⁶Ω or more. The value of the impedance is preferably as high as possible, and the upper limit thereof is not particularly limited, and is, for example, 5.0×10⁷Ω or less.

The impedance at a frequency of 1.0×10⁰ to 1.0×10¹ Hz is preferably 1.4×10⁶Ω or more, more preferably 2.0×10⁶Ω or more, particularly preferably 3.0×10⁶Ω or more, and even more preferably 5.0×10⁶Ω or more. A preferable range of the impedance is from 1.0×10⁶Ω to 5.0×10⁷Ω, preferably from 1.4×10⁶Ω to 5.0×10⁷Ω, more preferably from 2.0×10⁶Ω to 5.0×10⁷Ω, particularly preferably from 3.0×10⁶Ω to 5.0×10⁷Ω, even more preferably from 5.0×10⁶Ω to 5.0×10⁷Ω.

### Technical Significance of Requirement (2)

The requirement (2) specifies the surface potential of the outer surface of the developing roller. This surface potential corresponds to the surface potential of the conductive portion which is the second region. The surface potential of the conductive portion indicates the ease of residual charges in the conductive portion, and the higher the surface potential, the less likely the charges injected into the conductive portion are removed. As a result, the potential difference between the conductive portion and the insulating portion decreases, that is, the gradient force decreases, which may cause toner transport failure or make it difficult for the toner to roll on the developing roller.

In the present disclosure, when a voltage of 8 kV is applied to the grid portion and the corona discharger is relatively moved along the axial direction of the developing roller at a speed of 400 mm/sec, the decay behavior, that is, the relaxation curve, of the potential of the outer surface of the developing roller after the passage of the grid portion of the corona discharger is checked.

The relaxation curve of the surface potential of the developing roller whose outer surface is formed of a conductive portion and an insulating portion is a curve obtained by combining a relaxation curve corresponding to the conductive portion showing fast decay and a relaxation curve corresponding to the insulating portion showing slow decay. The relaxation curve is generally represented by formula (X) below.

$$V = {V}_{0} exp ( - t / τ ) \qquad ( X )$$

In formula (X), V₀ represents the surface potential [V] when t=0, t represents the elapsed time [sec], and τ represents the time constant.

In addition, since the surface potential of the developing roller at 30.00≤t≤100.00 is considered to be less affected by the relaxation curve corresponding to the conductive portion showing fast decay, V₁(t) in a case where a change in the surface potential of the developing roller at 30.00≤t≤100.00 is fitted to formula (X′) below to obtain the values of V_{0,1} [V] and τ₁ [sec] is a relaxation curve corresponding to a region where charge decay is slow on the outer surface of the developing roller, that is, an insulating portion.

$${V}_{1} ( t ) = {V}_{0 , 1} exp ( - t / {τ}_{1} ) \qquad ( X ’ )$$

In formula (X′), V_{0,1} represents the surface potential [V] of the insulating portion when t=0, and τ₁ represents the time constant [sec] of the insulating portion.

Therefore, V₁, which is a value when t=0.06 is substituted into the potential V₁(t), represents the surface potential of the insulating portion at 0.06 seconds after passage of the grid portion of the corona discharger.

On the other hand, V_{INI} is an actual measurement of the surface potential of the outer surface of the developing roller including the conductive portion and the insulating portion at 0.06 seconds after passage of the grid portion of the corona discharger. That is, the surface potential of the conductive portion at 0.06 seconds after passage of the grid portion of the corona discharger can be represented by V_{INI}−V₁.

If the surface potential of the conductive portion is less than 20.0 V, charges injected into the conductive portion when passing through a contact member such as a developing blade or a photosensitive drum can be removed quickly. Therefore, even if the conductive portion repeatedly passes through the developing blade or a photosensitive drum by the rotation of the developing roller, no charges are accumulated and no static electricity is generated in the conductive portion, and a potential difference between the conductive portion and the insulating portion does not decrease, thereby generating a stable gradient force. Therefore, toner transport failure can be more easily suppressed. In addition, the toner on the developing roller is easily rolled, and charge exchange between the toner on the developing roller and the toner in the developer container is easily caused, so that ghost images and image density non-uniformity are easily suppressed.

A time at 0.06 seconds after passage of the grid portion of the corona discharger simulates a time until the conductive portion of the developing roller reaches the contact position with another contact member, such as the photosensitive drum, after passage of the developing blade in a model with a high process speed. Thus, in an electrophotographic image forming apparatus with a high process speed, even when triboelectric charging with not only the developing blade but also the photosensitive drum or the like, or injection charging is performed, charges are not accumulated in the conductive portion, and toner transport failure, ghost images, and density non-uniformity image can be more easily suppressed.

The surface potential (V_{INI}−V₁) of the conductive portion is preferably 15.0 V or less, and more preferably 10.0 V or less. The lower the maximum value of the potential on the outer surface, the more preferable, and the lower limit is not particularly limited.

The surface potential of the conductive portion is preferably, for example, 0.0 V or more and less than 20.0 V, particularly from 0.0 V to 15.0 V, and even more preferably, from 0.0 V to 10.0 V.

### Substrate

The substrate is electrically conductive and functions as a support member for a developing roller and, in some cases, an electrode. Specific examples of the substrate include solid cylindrical and hollow tubular substrates.

Materials forming the substrate may be selected, as appropriate, from those known in the field of electrophotographic conductive members and materials available as such a developing roller. Examples thereof include metals represented by aluminum and stainless steel, carbon steel alloys, conductive synthetic resins, and metals or alloys such as iron and copper alloys.

Furthermore, the material forming the substrate may be subjected to oxidation treatment or plating treatment with chromium, nickel, or the like. As the type of plating, either electroplating or electroless plating may be used. From the viewpoint of dimensional stability, electroless plating is preferable. Examples of the type of electroless plating used here may include nickel plating, copper plating, gold plating, and other various types of alloy plating. The plating thickness is preferably 0.05 μm or more, and the plating thickness is preferably 0.1 to 30 μm in consideration of the balance between working efficiency and antirust ability.

A primer may be applied to the surface of the substrate in order to improve the adhesion between the substrate and the conductive layer or the elastic layer. As the primer, known primers can be selected and used in accordance with a rubber material for forming the conductive layer, a material of a support, and the like. Examples of the material for the primer may include a thermosetting resin or a thermoplastic resin, and specific examples may include materials such as a phenolic resin, a polyurethane, an acrylic resin, a polyester resin, a polyether resin, and an epoxy resin.

### Conductive Layer and Second Region (Conductive Portion)

The developing roller has a conductive layer on an outer surface of a substrate. The outer surface of the developing roller is formed of at least a first region and a second region having higher conductivity than the first region.

That is, the conductive layer is provided on the outer surface of the substrate, and the second region (conductive portion) forming the outer surface of the developing roller is formed of the outer surface of the conductive layer. The conductive layer may contain a binder resin.

### Binder Resin

The binder resin of the conductive layer is preferably a polyurethane from the viewpoint of durability, flexibility, and electrical characteristics as a surface layer. That is, the conductive layer preferably contains a polyurethane. Examples of such a polyurethane include a polyurethane having a polyether structure, a polyurethane having a polyester structure, a polyurethane having a polycarbonate structure, and the like.

Among them, from the viewpoint of suppression of charge leakage from the toner to the conductive layer, it is more preferable to use a polyurethane having a polycarbonate structure. That is, the conductive layer preferably contains a polyurethane having a polycarbonate structure.

Furthermore, in order to sufficiently maintain the flexibility of the conductive layer for reducing the load on the toner and the wear resistance of the conductive layer while preventing charge leakage from the insulating portion to the conductive layer, it is more preferable to use a polyurethane having a structure described below as the binder resin of the conductive layer.

It is preferable that the conductive layer contains a polyurethane, and the polyurethane satisfies at least two of the following (A), (B), and (C). All of the following (A), (B), and (C) may be satisfied:
(A) the polyurethane has a structure represented by structural formula (1) below in a molecule;
(B) the polyurethane has one or both structures of a structure represented by structural formula (2) below and a structure represented by structural formula (3) below in a molecule; and
(C) the polyurethane has a structure represented by structural formula (4) below in a molecule.

In other words, the polyurethane preferably satisfies at least one of the following:
Having at least a structure represented by structural formula (1) and a structure represented by structural formula (2);
Having at least a structure represented by structural formula (1) and a structure represented by structural formula (3);
Having at least a structure represented by structural formula (1) and a structure represented by structural formula (4);
Having at least a structure represented by structural formula (2) and a structure represented by structural formula (4); and
Having at least a structure represented by structural formula (3) and a structure represented by structural formula (4).

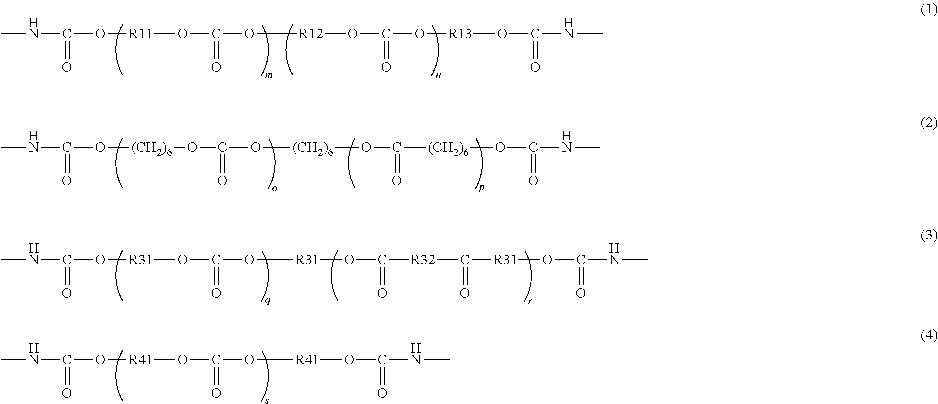

In structural formula (1), R11, R12, and R13 represent a divalent hydrocarbon group having 3 to 9 carbon atoms. However, R11 and R12 are different from each other, and R13 is the same as at least one selected from the group consisting of R11 and R12. m and n are average numbers of moles added, and each independently represent a number of 1.0 or more (preferably 1.0 to 20.0, more preferably 2.0 to 12.0).

In structural formula (2), o and p are average numbers of moles added, and each independently represent a number of 1.0 or more (preferably 1.0 to 15.0, more preferably 4.0 to 10.0).

In structural formula (3), R31 and R32 each independently represent a divalent hydrocarbon group having 3 to 8 carbon atoms. q and r are average numbers of moles added, and each independently represent a number of 1.0 or more (preferably 1.0 to 20.0, more preferably 2.0 to 14.0).

In structural formula (4), R41 represents a divalent hydrocarbon group having 6 to 9 (preferably 5 to 8) carbon atoms. s is an average number of moles added, and represents a number of 1.0 or more (preferably 1.0 to 22.0, more preferably 4.0 to 18.0).

The structure represented by structural formula (1) is a structure resulting from a reaction of a copolymerized polycarbonate polyol in which crystallinity is reduced by bonding two carbonate groups with two different types of hydrocarbon groups with an isocyanate. Because crystallinity is reduced, aggregation energy in a soft segment is small, and flexibility and a high volume resistivity can be imparted to the conductive layer.

The adhesiveness of the conductive layer can be reduced by using the structure of structural formula (1) in combination with the structures of (2) to (4) described above for the conductive layer. Thus, it is possible to prevent the adhesion of a toner, a powder, or the like to the surface of the conductive layer, so that an increase in the electric resistance value of the surface of the conductive layer due to dirt is prevented, and it becomes easier to quickly remove charges injected into the conductive portion.

In structural formula (1), R11 and R12 are each independently a divalent hydrocarbon group having 3 to 9 carbon atoms. R11 and R12 are different from each other, and R13 is the same as at least one selected from the group consisting of R11 and R12.

When the number of carbon atoms in R11 and R12 is 3 or more, the amount of carbonate groups that are polar functional groups and have strong aggregation energy is not too large in the polyurethane, and the conductive layer is easily kept flexible and with a high electric resistance.

When the number of carbon atoms in R11 and R12 is 9 or less, the amount of carbonate groups in the polyurethane is not too small, and the strength of the polymer can be maintained. In addition, since R11 and R12 have different structures, crystallinity of the polymer is reduced, and flexibility can be imparted to the conductive layer. m and n each independently represent a number of 1.0 or more. The hydrocarbon groups represented by R11, R12, and R13 may have a branched structure or a cyclic structure.

The structures represented by structural formula (2) and structural formula (3) are structures resulting from a reaction of a copolymer polyol obtained by copolymerizing a polycarbonate structure and a polyester structure with an isocyanate. The crystallinity of the polymer is reduced by copolymerizing a polycarbonate structure and a polyester structure, and a soft segment is moderately reinforced by introducing an ester group having stronger aggregation energy than a carbonate group, so that wear resistance can be imparted to the conductive layer.

When the conductive layer is formed using a polymer in which the structure represented by structural formula (2) and/or structural formula (3) is combined with the structure of formula (1) or (4) described above, it is possible to impart a sufficient volume resistivity to the conductive layer while having an ester group with polarity, and it becomes easier to prevent charge leakage from the toner to the conductive layer.

In structural formula (2), o and p are each independently represent a number of 1.0 or more.

In structural formula (3), R31 and R32 each independently represent a divalent hydrocarbon group having 3 to 8 carbon atoms, and q and r are each independently represent a number of 1.0 or more. When the number of carbon atoms in R31 and R32 is 3 or more, the amount of carbonate groups and ester groups which are polar functional groups and have strong aggregation energy is not too large in the polyurethane, and the conductive layer can be kept flexible. When the number of carbon atoms in R31 and R32 is 8 or less, the amount of carbonate groups and ester groups in the polyurethane is not too small, and wear resistance can be imparted to the conductive layer.

The structure represented by structural formula (4) is a structure resulting from a reaction of a highly crystalline polycarbonate polyol in which two carbonate groups are bonded with a single hydrocarbon group with an isocyanate.

This structure has high crystallinity and is easily arranged in a soft segment, so that wear resistance and a high volume resistivity can be imparted to the conductive layer. By forming the conductive layer using a polymer in which the structure represented by structural formula (4) is combined with the structures of formulae (1) to (3) described above, the hardness of the conductive layer is not too high and is easy to control properly.

In structural formula (4), R41 represents a divalent hydrocarbon group having 6 to 9 carbon atoms, and s represents a number of 1.0 or more. When the number carbon atoms in R41 is 6 or more, crystallinity is easily exhibited, and wear resistance and a high volume resistivity can be imparted to the conductive layer. When the number carbon atoms in R41 is 9 or less, excessive crystallinity can be prevented, and therefore by further incorporating at least one of the structures represented by structural formulae (1), (2), and (3) in the polymer, an increase in hardness of the conductive layer can be prevented.

The conductive layer preferably contains a polymer having a urethane bond, that is, a polyurethane as the binder resin, and the polymer preferably satisfies at least two selected from the group consisting of the above (A), (B), and (C). As a result, the conductive layer is flexible and less worn.

The structure of the polymer contained in the conductive layer of the developing roller can be checked by, for example, analysis by pyrolysis GC/MS, FT-IR, or NMR.

The polyurethane can be produced using a polyol compound (A) and a polyisocyanate compound (B). Usually, the following methods (1) and (2) are used for the synthesis of the polyurethane.
(1) A one-shot method in which a polyol component and a polyisocyanate component are mixed and allowed to react with each other
(2) A method in which an isocyanate group-terminated prepolymer obtained by a reaction of a part of a polyol with an isocyanate, and a chain extender such as a low molecular diol or a low molecular triol are allowed to react with each other

In the present disclosure, the polyurethane may be synthesized by any of the methods described above, and a method in which a hydroxyl group-terminated prepolymer resulting from a reaction of a raw polyol with an isocyanate and an isocyanate group-terminated prepolymer resulting from a reaction of a raw polyol with an isocyanate are subjected to a thermal curing reaction is more preferable.

The polyurethane is preferably a reaction product of a mixture containing a hydroxyl group-terminated prepolymer and an isocyanate group-terminated prepolymer. The mixture can be used as a conductive layer-forming coating liquid. The polyurethane is more preferably a reaction product of a mixture containing a hydroxyl group-terminated prepolymer, an isocyanate group-terminated prepolymer, a conductive filler, and an additive.

When there are many hydroxyl groups, isocyanate groups, urea bonds, allophanate bonds, isocyanurate bonds, and the like, the water absorbability of the polymer may increase and the volume resistivity of the conductive layer may decrease because many polar functional groups are present in the polyurethane. Meanwhile, by thermal curing the hydroxyl group-terminated prepolymer and the isocyanate group-terminated prepolymer, a polyurethane with less unreacted polyols and polar functional groups can be obtained without excessive use of an isocyanate. Therefore, it is preferable from the viewpoint of further preventing charge leakage from the toner to the conductive layer.

### Polyol Compound (A)

As the polyol compound, a polyol known for the synthesis of a urethane resin or capable of being used for the synthesis of a urethane resin can be used. Examples of the polyol compound include the following polyol compounds: polyolefin polyols, such as a polycarbonate polyol, a polyether polyol, a polyester polyol, a polybutadiene polyol, and a polyisoprene polyol, a so-called polymeric polyol obtained by polymerization of an ethylenically unsaturated monomer in a polyol, and a polyester-polycarbonate copolymer polyol.

Among them, the polyol compound is preferably at least one selected from the group consisting of a polycarbonate polyol and a polyester-polycarbonate copolymer polyol.

Examples of the polycarbonate polyol include the following polycarbonate polyols: polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random or block copolymers thereof.

Examples of the polyester-polycarbonate copolymer polyol may include the following polyester-polycarbonate copolymer polyols: a copolymer obtained by polycondensation of the polycarbonate polyol with a lactone such as F-caprolactone, and a copolymer of a diol such as 1,4-butanediol, 1,5-pentanediol, 1,6-hexanediol, 3-methylpentanediol, or neopentyl glycol with a polyester obtained by polycondensation of a dicarboxylic acid such as adipic acid or sebacic acid.

### Polyisocyanate Compound (B)

The polyisocyanate is selected from commonly used known polyisocyanates, and examples thereof include the following polyisocyanates: toluene diisocyanate (TDI), diphenylmethane diisocyanate (MDI), polymeric diphenylmethane polyisocyanate, hydrogenated MDI, polymeric MDI, xylylene diisocyanate (XDI), hexamethylene diisocyanate (HDI), and isophorone diisocyanate (IPDI). Among them, aromatic isocyanates such as toluene diisocyanate (TDI), diphenylmethane diisocyanate (MDI), polymeric diphenylmethane polyisocyanate, and polymeric MDI are more suitably used.

The ratio of the number of isocyanate groups to the number of hydroxyl groups (hereinafter also referred to as “NCO/OH ratio”) is preferably 1.0 to 2.0. If the NCO/OH ratio is 1.0 to 2.0, the crosslinking reaction proceeds, and the oozing, so-called “bleeding” of unreacted components or low molecular weight polyurethanes is prevented. This NCO/OH ratio is more preferably 1.0 to 1.6. If the NCO/OH ratio is 1.0 to 1.6, bleeding is prevented, and the hardness of the polymer can be reduced.

The content of the polyurethane in the conductive layer is not particularly limited, but preferably 50 to 95 mass %, more preferably 60 to 80 mass %, and even more preferably 65 to 75 mass %.

### Conductive Filler

The conductive layers preferably contain a conductive filler in order to obtain conductivity. It is more preferable to use an electron conductive agent as the conductive filler in the conductive layer. The electron conductive agent is preferably a conductive particle exhibiting electron conductivity, and preferably has a surface functional group capable of interacting with a functional group present in an additive to be described later.

Examples of the electron conductive agent exhibiting these properties include at least one selected from the group consisting of carbon blacks such as furnace black, thermal black, acetylene black, and Ketjen black, metal oxide-based conductive particles such as titanium oxide having a surface treated with an acidic functional group, and metal-based conductive particles such as aluminum or iron having a surface treated with an acidic functional group.

Among them, at least one selected from the group consisting of carbon blacks having high stability of the surface functional group is suitably used. The conductive filler preferably contains a carbon black. Furthermore, in order to obtain a desired impedance value and surface potential, a carbon black in which the number average diameter of primary particles that can achieve higher dispersion in the conductive layer is 30 nm or less, the DBP absorption amount is 90 ml/100 g or less, and the pH is 4.0 or less is particularly suitably used.

When the number average diameter of primary particles of the carbon black is 30 nm or less, an aggregate (primary aggregate), which is a smallest dispersible unit of the carbon black, becomes small, and a structure (size of connection of particles) also becomes small, so that a conductive path is less likely to be formed. Therefore, a sufficiently high impedance is easily obtained. The primary particle diameter of the carbon black can be calculated with a transmission electron microscope (TEM). The lower the number average diameter, the more preferable, and the lower limit is not particularly limited. For example, the number average diameter of primary particles of the carbon black is more preferably 5 to 30 nm or 20 to 28 nm.

When the DBP absorption amount of the carbon black is 90 ml/100 g or less, the carbon black structure becomes small, and a conductive path is less likely to be formed, so that a sufficiently high impedance is easily obtained. The lower the DBP absorption amount, the more preferable, and the lower limit is not particularly limited. For example, the DBP absorption amount of the carbon black is preferably 30 to 90 ml/100 g, more preferably 40 to 60 ml/100 g.

When the pH of the carbon black is 4.0 or less, an effect of dispersion stability is obtained by repulsion of the surface functional group of the carbon black, and aggregation of the carbon black is less likely to occur, so that a sufficiently high impedance is easily obtained. The lower the pH of the carbon black, the more preferable, and the lower limit is not particularly limited. For example, the pH of the carbon black is preferably 2.0 to 4.0, more preferably 2.2 to 2.8.

However, even if the number average diameter of primary particles, DBP absorption amount, and pH of the carbon black are within the above ranges, when polycarbonate urethane is used as the binder resin, the resin cannot be sufficiently dispersed, and a desired impedance may not be obtained. The reason why the carbon black, which is a desired raw material property, cannot be dispersed when polycarbonate urethane is used as the binder resin is not clearly known, but is presumed as follows.

The hydroxyl group, which is the surface functional group of the carbon black, tends to interact with the terminal hydroxyl group of the polycarbonate diol. Meanwhile, the structure in which the carbonate bond and the hydrocarbon group are bonded, which is present between the two hydroxyl groups of the polycarbonate diol, is hydrophobic due to the presence of the hydrocarbon group, and is difficult to interact with the carbon black. Since the structure is more stable when hydrophobic sites are present near each other or when hydrophilic sites are present near each other, a hydrophilic carbon black is present near the same hydrophilic carbon black. As a result, the carbon black tends to aggregate and is considered to be hardly dispersed.

In order to sufficiently disperse the carbon black in which the number average diameter of primary particles, DBP absorption amount, and pH are in the above numerical ranges using polycarbonate urethane as the binder resin, it is more preferable to add an additive to be described later.

The carbon black is desirably added to achieve a desired volume resistivity, and the content of the carbon black is preferably 30 parts by mass or less with respect to 100 parts by mass of the polyurethane forming the conductive layer. The content is more preferably 10 to 30 parts by mass, and still more preferably 15 to 25 parts by mass.

When the content is 30 parts by mass or less, the distance between the carbon black particles in the coating liquid is moderately maintained, the collision probability due to Brownian motion or the like of the carbon black is reduced, and the carbon black is less likely to aggregate. As a result, the carbon black is easily dispersed, and dispersion stability is also improved. As a result, the carbon black is well dispersed in the conductive layer formed by depositing the coating liquid.

In order to achieve the above specific impedance and surface potential, it is preferable to control the dispersion of the carbon black. As for the dispersed particle diameter of the carbon black, the arithmetic mean Rc of the circle-equivalent diameter of the carbon black in the conductive layer is preferably 60.0 nm or less. It is more preferable that when the standard deviation of the circle-equivalent diameter is denoted by as σc [nm], σc/Rc is 0.000 to 0.650.

As for the distance between carbon black particles, it is more preferable that the arithmetic mean d of the inter-wall distance of the carbon black in the conductive layer is 80.0 to 150.0 nm, and ad/d is 0.000 to 0.600 when the standard deviation of the inter-wall distance is denoted by ad [nm].

The reason why a high impedance and a low surface potential are more easily achieved when the circle-equivalent diameter and the inter-wall distance are in the above numerical ranges is estimated as follows.

When the dispersed particle diameter is large, there is a place where the inter-wall distance is short, and a conductive path is easily formed, and thus both impedance and surface potential decrease. On the other hand, when the dispersed particle diameter is reduced, the inter-wall distance approaches uniformity, and a conductive path is less likely to be formed, and the resistance increases, and thus the impedance increases. As for the surface potential, local charge accumulation is less likely to occur, and the surface potential can be decreased.

Note that multiple types of carbon blacks may be used in combination as long as they do not affect the impedance value and the surface potential.

The arithmetic mean Rc of the circle-equivalent diameter is more preferably 40.0 to 60.0 nm, and still more preferably 45.0 to 55.0 nm. 6c/Rc is more preferably 0.500 to 0.650 and still more preferably 0.550 to 0.650.

The arithmetic mean Rc and standard deviation 6c of the circle-equivalent diameter can be changed depending on the dispersion state in a mill or the like when preparing a conductive layer-forming coating liquid, for example. When the dispersion is weakened, Rc and σc tend to increase, and when the dispersion is strengthened, Rc and σc tend to decrease. Usually, Rc converges, and therefore beyond a certain dispersion state, σc can be decreased while Rc is left substantially constant, and it is possible to decrease σc/Rc.

The arithmetic mean d of the inter-wall distance is preferably 90.0 to 120.0 nm and more preferably 95.0 to 115.0 nm. σd/d is more preferably 0.500 to 0.600 and still more preferably 0.540 to 0.590.

The arithmetic mean d and standard deviation ad of the inter-wall distance can be changed depending on the dispersion state in a mill or the like when preparing a conductive layer-forming coating liquid, for example. When the dispersion is weakened, d tends to decrease and ad tends to increase, and when the dispersion is strengthened, d tends to increase and ad tends to decrease. Therefore, when the dispersion is weak, ad/d tends to increase, and when the dispersion is strong, ad/d tends to decrease.

### Additive

It is also one of the preferable aspects to use an additive to further improve the dispersibility of the carbon black in the binder resin using polycarbonate urethane. Here, as the additive, for example, at least one compound selected from the group consisting of a compound having a structure represented by structural formula (5) below, a compound having a structure represented by structural formula (6) below, and a compound having a structure represented by structural formula (7) below can be suitably used. In other words, it is preferable that the conductive layer contains at least one compound selected from the group consisting of a compound represented by structural formula (5) below, a compound represented by structural formula (6) below, and a compound represented by structural formula (7) below.

One of the methods of incorporating the above additive into the conductive layer is a method of incorporating a dispersing agent into a surface layer-forming coating liquid. In a surface layer formed using a surface layer-forming coating liquid containing at least one compound selected from the group consisting of a compound having a structure represented by structural formula (5) and a compound having a structure represented by structural formula (6), the compound may be incorporated at the end of a polymer chain of a polyurethane. Even in such a case, the effect of improving the dispersibility of the carbon black can be expected, but it is preferable that the additive is present in the surface layer independently of the polyurethane.

Among the compounds having structures represented by structural formulae (5) to (7), the compound having a structure represented by structural formula (5) is more suitably used because the dispersibility of the carbon black and the affinity for polycarbonate urethane are particularly excellent.

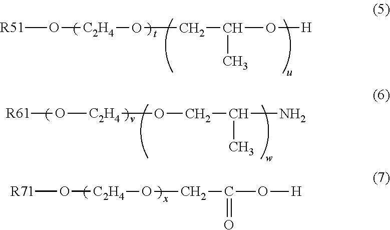

In structural formula (5), R51 represents a monovalent hydrocarbon group having 1 to 12 (preferably 3 to 12) carbon atoms, and t and u are average numbers of moles added, and each independently represent a number of 1.0 or more (preferably 5.0 to 30.0, more preferably 10.0 to 25.0).

In structural formula (6), R61 represents a monovalent hydrocarbon group having 1 to 8 (preferably 1 to 4) carbon atoms, and v and w are average numbers of moles added, and each independently represent a number of 1.0 or more (preferably 1.0 to 30.0, more preferably 5.0 to 30.0).

In structural formula (7), R71 represents a monovalent hydrocarbon group having 1 to 12 carbon atoms, and x is an average number of moles added, and represents a number of 1.0 or more (preferably 1.0 to 30.0 and more preferably 4.0 to 15.0).

Structural formula (5) is a polyoxyethylene polyoxypropylene alkyl ether, and is a polyether monool having a structure in which ethylene oxide and propylene oxide are addition-polymerized in a block form. The terminal hydroxyl group of the polyether monool interacts with the surface functional group of the carbon black, which is the conductive filler, by a hydrogen bond, and acts as a dispersing agent for the carbon black. In addition, in order to enhance the effect of the carbon black as the dispersing agent, it has a structure having good compatibility with polycarbonate urethane.

Ethylene oxide is introduced into the structure to make the additive uniformly present in polycarbonate urethane. This is considered to be because the ethylene group in ethylene oxide is compatible with the hydrophobic hydrocarbon group in polycarbonate urethane. Propylene oxide is also introduced into the structure to improve the dispersibility of the conductive filler dispersed in the conductive layer. This is considered to be because the side chain methyl group of propylene oxide interacts with the conductive filler to improve the dispersibility of the conductive filler.

R51, which is a monovalent hydrocarbon group having 1 to 12 carbon atoms, is introduced into the structure in order to make the additive uniformly present in polycarbonate urethane. The monovalent hydrocarbon group is compatible with the hydrophobic hydrocarbon group in polycarbonate urethane, and the additive can be uniformly present in polycarbonate urethane. When the number of carbon atoms is 12 or less, steric hindrance with polycarbonate urethane is less likely to occur, and the additive tends to be present uniformly.

Since the compound of formula (5) has a monool structure, the compound has lower reactivity than a diol, is less likely to be incorporated during a urethanization reaction by a reaction between an isocyanate and a polyol, and is less likely to cause a decrease in resistance of the polyurethane due to introduction of an ether structure into polycarbonate urethane.

A polyoxyethylene polyoxypropylene alkyl ether can be obtained by using a commercial product or by synthesis. The polyoxyethylene polyoxypropylene alkyl ether can be synthesized through a step (B) after a step (A) below. The step (B) may be performed on a commercial product having a structure completed up to the step (A).
Step (A): A Reaction of an Alcohol with Ethylene Oxide
Step (B): A Reaction of a Product Obtained in the Step (A) with Propylene Oxide

In the step (A), a reaction can be allowed to proceed by adding ethylene oxide to an alcohol in the presence of a catalyst at 50° C. to 200° C., more preferably 100° C. to 160° C. Since ethylene oxide has a boiling point of 10.7° C. and is a gas at the above temperature, the reaction is preferably performed in an environment pressurized in a sealed container. The pressure is preferably 0.1 to 1.0 MPa. The reaction time is not particularly limited, but is preferably about 1 to 3 hours in order to reduce unreacted ethylene oxide.

As the catalyst, an acid catalyst or an alkali catalyst can be used, but an alkali catalyst is preferable in order to facilitate purification after completion of the reaction. Examples of the alkali catalyst include hydroxides of alkali metals such as sodium hydroxide and potassium hydroxide, hydroxides of alkaline earth metals such as calcium hydroxide and barium hydroxide, ammonium hydroxide, and tertiary amines. In view of ease of reaction and reaction efficiency, sodium hydroxide and potassium hydroxide are particularly preferable. Examples of the acid catalyst include Broensted acids such as sulfuric acid and phosphoric acid, and Lewis acids such as stannous chloride and boron trifluoride.

The amount of the catalyst used is preferably 0.1 to 5 mol % with respect to 1 mol of the alcohol in the case of sodium hydroxide or potassium hydroxide. Ethylene oxide reacts with water to produce ethylene glycol, so that moisture is avoided as much as possible, and if necessary, dehydration treatment may be performed prior to the reaction in the step (A).

The step (B) can be performed under similar conditions to the step (A). The boiling point of propylene oxide is 34.2° C. and is gas at the reaction temperature of 50° C. to 200° C. Therefore, the reaction is preferably performed in an environment pressurized in a sealed container. As the catalyst, the catalyst used in the step (A) may be used as such or a catalyst may be added newly. When a catalyst is added newly, the same catalyst as used in the step (A) is preferable.

Structural formula (6) is a polyetheramine (monoamine) having a structure in which ethylene oxide and propylene oxide are addition-polymerized in a block form. The terminal amino group of this polyetheramine interacts with the surface functional group of the carbon black, which is the conductive filler, by a hydrogen bond, and acts as a dispersing agent for the carbon black. In addition, in order to enhance the effect as the dispersing agent, R61 which is a monovalent hydrocarbon group having 1 to 8 carbon atoms is introduced to form a structure that is easily compatible with the hydrophobic functional group of polycarbonate urethane, and to form a structure that has good compatibility with polycarbonate urethane.

A polyether monoamine can be obtained by using a commercial product or by synthesis. A polyether monoamine can be synthesized through a step (D) after a step (C) below.
Step (C): An Oxidation Reaction of a Compound of Structural Formula (5) Which Is a Secondary Alcohol
Step (D): A Reductive Amination Reaction of a Product Obtained in the Step (C)

The step (C) is a reaction to form a ketone in an oxidation reaction of a secondary alcohol. Ketone synthesis by oxidation of a secondary alcohol includes an oxidation reaction using a heavy metal salt such as chromic acid or manganese dioxide and a derivative thereof, and an oxidation reaction of a non-heavy metal salt using dimethyl sulfoxide (DMSO) or a hypohalous acid such as hypochlorous acid.

Synthesis may be performed using any method, but in view of the environmental impact of heavy metals, an oxidation reaction using dimethyl sulfoxide (DMSO) or a hypohalous acid such as hypochlorous acid is preferable. Furthermore, a method using a hypohalous acid is more preferable because dimethyl sulfoxide (DMSO) explosively reacts at room temperature depending on the electrophilic activation reagent used, and a low temperature such as −60° C. is required. Examples of the hypohalous acid include hypochlorites such as sodium hypochlorite and calcium hypochlorite (chlorinated lime). A reaction of such a hypochlorite with a secondary alcohol in acetic acid provides a ketone.

When dimethyl sulfoxide (DMSO) is used, an electrophilic activation reagent is also required. The electrophilic activation reagent increase the electrophilicity of sulfur in dimethyl sulfoxide (DMSO), allowing it to undergo nucleophilic attack by an alcohol hydroxyl group. This nucleophilic attack produces a dimethylalkoxysulfonium salt, which is degraded to give a ketone and a dimethyl sulfide. Examples of the electrophilic activation reagent include dicyclohexylcarbodiimide (DCC), acetic anhydride, phosphorus pentoxide, a sulfur trisulfide-pyridine complex, trifluoroacetic anhydride, oxalyl chloride, and halogen.

The step (D) is a reductive amination reaction that converts a ketone to an amine. The reaction is divided into two stages. First, a carbonyl group reacts with an amine to produce an iminium cation. Subsequently, a hydride reducing agent nucleophilically attacks the iminium cation to produce an amine. As the reducing agent, a borohydride reagent is preferably used. Examples of the borohydride reagent include sodium cyanoborohydride, sodium triacetoxyborohydride, and 2-picoline-borane, and among these, sodium triacetoxyborohydride and 2-picoline-borane, which are less toxic, are preferable. A reductive amination reaction with the borohydride reagent makes it difficult to produce an iminium cation due to steric hindrance if it has a bulky structure. Therefore, R61 in structural formula (6) is preferably a monovalent hydrocarbon group having 1 to 8 carbon atoms.

Structural formula (7) is a polyoxyethylene alkyl ether acetate. The terminal carboxylic acid in structural formula (7) interacts with the surface functional group of the carbon black, which is the conductive filler, by a hydrogen bond, and acts as a dispersing agent for the carbon black. In addition, in order to enhance the effect as the dispersing agent, R71 which is a monovalent hydrocarbon group having 1 to 12 carbon atoms is introduced to form a structure that is easily compatible with the hydrophobic functional group of polycarbonate urethane, and to form a structure that has good compatibility with polycarbonate urethane.

The polyoxyethylene polyoxypropylene alkyl ether acetate can be obtained by using a commercial product or by synthesis. The polyoxyethylene polyoxypropylene alkyl ether acetate can be synthesized through a step (F) after a step (E) below. The step (F) may be performed on a commercial product having a structure completed up to the step (E).
Step (E): A Reaction of an Alcohol with Ethylene Oxide
Step (F): An Oxidation Reaction of a Primary Alcohol Being a Product in the Step (E)

The step (E) is the same as the step (A), and preparation can be performed in the same manner as in the step (A).

The step (F) is a step of oxidizing a primary alcohol to produce a carboxylic acid. Oxidation of a primary alcohol requires selection of a method and conditions for a reaction that does not stop with an aldehyde because further oxidation produces a carboxylic acid after an aldehyde is produced. Examples of the method for obtaining a carboxylic acid by oxidation of a primary alcohol include oxidation with an oxidizing agent and a catalytic dehydrogenation reaction with a catalyst. Examples of the oxidizing agent include a permanganate, chromic acid, ruthenium tetroxide, and a hypochlorite. Examples of the catalyst for the dehydrogenation reaction include palladium, platinum, iridium, rhodium, and manganese.

The compounds represented by structural formulae (5) to (7) are compounds having a function as a dispersing agent for the carbon black and high affinity for polycarbonate urethane. A surfactant is usually used as a method for increasing the dispersibility and dispersion stability of the carbon black. However, the compounds represented by structural formulae (5) to (7) have a small number of functional groups acting on the surface functional group of the carbon black, and thus show a weak surfactant effect and are not commonly used. A coupling agent or a nonionic surfactant has been utilized as a common dispersing agent for the carbon black.

As the coupling agent, a silane coupling agent, a titanate coupling agent, and an aluminum coupling agent are used, and as the nonionic surfactant, a polyester or polyether-based nonionic surfactant is used. However, when these dispersing agents are added in the polycarbonate urethane to a level at which the dispersibility of the carbon black is sufficiently enhanced (mass ratio with respect to carbon black: 50 to 100%), the conductivity of the carbon black or the binder resin is inhibited. Conversely, if the amount is at a level not inhibiting the conductivity of the carbon black or the binder resin (mass ratio with respect to carbon black: 10 to 40%), the dispersibility of the carbon black cannot be achieved.

The amount of the compounds represented by structural formulae (5) to (7) added is preferably 3.0 to 7.0 mass % based on the solid content in the conductive layer-forming coating liquid. The amount is more preferably 3.0 to 5.0 mass %. The total content is preferably 18.9 to 46.0 parts by mass with respect to 100 parts by mass of the carbon black in the conductive layer-forming coating liquid.

When the content of the additive in the conductive layer-forming coating liquid is within the above range, the dispersibility of the carbon black into the polyurethane is further improved, and a desired impedance value and surface potential can be more easily achieved.

Checking of the presence of additives in the conductive layer and quantitative evaluation can be analyzed in the following manner. The conductive layer of the developing roller is cut out, and the slice is analyzed using, for example, ¹H-NMR, ¹³CNMR, XPS, and FT-IR. Thereby, the carbonate structure of the binder resin, the ether structure of the additive, the amine structure, and the carboxylic acid structure can be detected in the conductive layer, the ratio can be calculated from the proportions of peaks and the like.

Also, the slice is subjected to extraction by immersion in an organic solvent such as 2-butanone (methyl ethyl ketone; MEK), and the extract and the slice after extraction is analyzed using ¹H-NMR, ¹³C-NMR, XPS, and FT-IR. This makes it possible to calculate the proportions of the additive incorporated and the additive not incorporated during the polymerization reaction of the resin.

The conductive layer may have a structure in which at least one of compounds having structures represented by structural formulae (5) and (6) is bonded to the polyurethane (a structure reacted during polymerization of the polyurethane). The structure reacted during polymerization of the polyurethane includes, for example, the following aspects.
In the case of a structure represented by structural formula (5), a structure in which a compound having a structure represented by structural formula (5) is urethanized in the polyurethane
In the case of a structure represented by structural formula (6), a structure in which a compound having a structure represented by structural formula (6) is urea-converted in the polyurethane

### Coarse Particles

The conductive layer may contain coarse particles. The coarse particles may be, for example, spherical particles. The particle diameter of the coarse particles is, for example, preferably in the range of 1 to 150 μm and more preferably in the range of 5 to m. For example, at least one spherical particle selected from the following particles is included:
urethane resin particles, acrylic resin particles, phenol resin particles, silicone resin particles, polyacrylonitrile resin particles, polystyrene resin particles, polyurethane resin particles, nylon resin particles, polyethylene resin particles, and polypropylene resin particles. Preferably, the particles are urethane resin particles.

The content of the coarse particles in the conductive layer is preferably 1 to 50 mass %, more preferably 5 to 30 mass %.

### Production Method for Conductive Layer

The method for forming the conductive layer is not particularly limited, but examples thereof may include methods by spraying, dip coating, and roll coating using a coating material. For example, the conductive layer can be formed by applying a conductive layer-forming coating liquid onto a substrate or an elastic layer formed on the outer surface of the substrate by a known method and heating and drying the coating liquid. The conditions for heating and drying are not particularly limited, and examples thereof include a method of drying under conditions at 120° C. to 200° C. The thickness of the conductive layer is also not particularly limited, and is preferably 1 to 50 μm, and more preferably 5 to 20 μm.

### Time Constant of Surface Potential of Conductive Portion

A time constant of the surface potential of the conductive portion of 6.0 seconds or less is preferable because charges injected into the conductive portion are easily removed quickly.

Specifically, in a case where when a corona discharger having a grid portion with a width of 3.0 mm is placed in an environment at a temperature of 23° C. and a relative humidity of 50% such that a distance between the grid portion and an outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured, a change in the potential at 0.06≤t≤100.00 is fitted to formula (Y) below by a least squares method to obtain V_{0,2} [V] and τ₂ [sec], τ₂ is preferably 6.0 seconds or less. τ₂ is more preferably 5.0 seconds or less, and still more preferably 4.0 seconds or less. The lower limit is not particularly limited, and the range of T₂ may be, for example, 0.1 to 6.0 seconds, 0.1 to 5.0 seconds, or 0.1 to 4.0 seconds.

$$V ( t ) = {V}_{1} ( t ) + {V}_{2} ( t ) \qquad ( Y )$$

$$In formula ( Y ) , {V}_{2} ( t ) = {V}_{0 , 2} exp ( - t / {τ}_{2} ) \qquad ( Z )$$

As described above, V₁(t) indicates a relaxation curve corresponding to the insulating portion. The change in potential at 0.06≤t≤100.00 also includes the influence of the relaxation curve corresponding to the conductive portion showing fast decay. Therefore, V₂(t) in formula (Y) obtained by fitting the change in potential at 0.06≤t≤100.00 indicates a relaxation curve corresponding to the conductive portion. Therefore, V_{0,2} represents the surface potential of the conductive portion when t=0, and T₂ represents the time constant of the surface potential of the conductive portion. Detailed measurement conditions for V_{0,2} and T₂ will be described later.

The time constant of the surface potential of the conductive portion can be controlled by the blending of the binder resin and the conductive filler.

### First Region (Insulating Portion)

The first region (insulating portion) is placed on the outer surface of the conductive layer. The first region is formed of, for example, an outer surface of an insulator exposed on the outer surface of the conductive layer. The first region may be, for example, present in a dotted pattern on the conductive layer, or may be connected to such an extent that the conductive layer (second region) is exposed.

When a square observation region having a side length of 300 μm is placed on the outer surface of the developing roller such that the axial direction of the developing roller and one side of the observation region are parallel to each other, the proportion of the total area of the first region to the area of the square observation region is preferably 10 to 60 area %, more preferably 15 to 50 area %, and still more preferably 20 to 40 area % from the viewpoint of applying an appropriate gradient force to the developing roller.

The proportion of the total area of the first region can be controlled by the wettability of a constituent material solution of the first region, the viscosity of the solution, the drying speed, the surface roughness of the conductive layer, the solid content of the solution, and the like.

The height of each insulating portion from a contact portion with the conductive layer is preferably 0.1 to 10.0 μm. By setting this height to 0.1 μm or more, the toner is easily attracted when the first region is charged. Further, by setting the height to 10.0 μm or less, the toner is easily charged between the first region and the contact member.

The ratio of the total area and the height of this first region can be measured using, for example, a laser microscope (trade name: VK-X100, manufactured by KEYENCE CORPORATION). This will be specifically described later.

### Surface Potential of Insulating Portion

In a case where when a corona discharger having a grid portion with a width of 3.0 mm is placed in an environment at a temperature of 23° C. and a relative humidity of 50% such that a distance between the grid portion and an outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured, a change in the potential at 30.00≤t≤100.00 seconds is fitted to formula (X′) by a least squares method to obtain V_{0,1} [V] and τ₁ [sec], τ₁ is preferably 60.0 seconds or more.

A time constant (τ₁) of the surface potential of the insulating portion of 60.0 seconds or more is preferable because charges injected into the insulating portion are less likely to be removed and the insulating portion can be charged quickly. Since the insulating portion is quickly charged, a potential difference between the insulating portion and the conductive portion becomes clear from the start of printing, and a toner transporting force is easily exhibited.

τ₁ is more preferably 100.0 seconds or more, still more preferably 1000.0 seconds or more. The upper limit of τ₁₁ is not particularly limited, and the range of τ₁ may be 60.0 to 5000.0 seconds, 100.0 to 4500.0 seconds, or 1000.0 to 4000.0 seconds.

τ₁ can be adjusted, for example, by using the following materials or adjusting the blending amount thereof.

Detailed measurement conditions of τ₁ will be described later.

In a case where when a corona discharger having a grid portion with a width of 3.0 mm is placed in an environment at a temperature of 23° C. and a relative humidity of 50% such that a distance between the grid portion and an outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured, a change in the potential at 30.00≤t≤100.00 is fitted to formula (X′) by a least squares method to obtain V_{0,1}[V] and τ₁ [sec], when a value of a potential V₁(t) at the time of substituting t=0.06 [sec] into formula (X′) is denoted by V₁ [V], V₁ is preferably 5.0 V or more.

When the surface potential immediately after charging is performed by the corona discharger is 5.0 V or more, a gradient force necessary for transporting the toner is easily exhibited when charges are injected into the insulating portion. V₁ is more preferably 6.0 V or more, still more preferably 10.0 V or more. The upper limit of V₁ is not particularly limited, and the range of V₁ may be 5.0 to 35.0 V, 6.0 to 33.0 V, or 10.0 to 20.0 V.

In order to obtain τ₁ and V₁ as described above, the volume resistivity of the insulating portion is preferably from 1.0×10¹³Ω ·cm to 1.0×10¹⁸Ω ·cm, and more preferably from 1.0×10¹⁴Ω ·cm to 1.0×10¹⁷Ω ·cm.

The volume resistivity of the insulating portion can be adjusted, for example, by using the following materials or adjusting the blending amount thereof.

### Material Forming Insulating Portion

Various electrically insulating materials can be used as the material forming the insulating portion. Further, the material is preferably a material which is relatively hard to break when it is deformed by contact of the developing member with other members. Specific examples thereof include metal oxides such as silicon dioxide and aluminum oxide, and inorganic materials such as diamond. In addition, examples thereof include resins such as polyethylene, polystyrene, a polycarbonate, a polyacrylic, polytetrafluoroethylene, a phenol resin, a urea resin, a silicone resin, and a polyimide resin. Resins such as polystyrene, a polycarbonate, a polyacrylic, polytetrafluoroethylene, a silicone resin, and a polyimide resin, and copolymers of these resins are particularly preferable because they have high electric resistance, are hard to break even by some deformation, and are resistant to rubbing.

### Method for Forming First Region

The method for forming the first region to be the insulating portion is not particularly limited, but for example, the following methods can be used. That is, there is a method in which an insulating portion-forming coating liquid prepared by diluting an insulating material with a solvent is applied in an island shape onto the conductive layer by screen printing, a jet dispenser, or the like, and then solidified by drying the solvent. Further, there is a method in which an insulating portion-forming coating liquid is uniformly applied onto the conductive layer by dipping or the like, repelled so that the conductive layer is exposed by controlling wettability, and then solidified by drying the solvent. Further, there is a method in which an insulating portion-forming coating liquid containing a raw material of an insulating material is applied in an island shape onto the conductive layer by screen printing, a jet dispenser, or the like, and then the raw material of the insulating material is cured by heating, ultraviolet irradiation, or the like as necessary. In addition, there is a method in which an insulating portion-forming coating liquid containing a raw material of an insulating material is uniformly applied onto the conductive layer by dipping or the like, repelled so that the conductive layer is exposed by controlling wettability, and then the raw material of the insulating material is cured by heating, ultraviolet irradiation, or the like as necessary.

As the method of controlling the wettability, for example, a method of adding a surface adjusting agent to the conductive layer can be used.

### Elastic Layer

The developing roller may have an elastic layer on the outer surface of the substrate. The developing roller includes, for example, an elastic layer between the substrate and the conductive layer. The elastic layer is not particularly limited, and a known elastic layer may be used as the elastic layer of the developing roller. Examples thereof include a cured product of an addition cure-type liquid silicone rubber mixture.

### Impedance of the Developing Roller

In the impedance measurement of the developing roller, the response of the developing roller when an AC voltage and a DC voltage are applied is examined while changing the frequency. An AC voltage is applied and measured separately into two of a response without a phase shift and a response with a phase shift of π/2 with respect to the applied AC voltage, plotted as a complex plane with the impedance of the response without a phase shift as Z′ (real part) and the impedance of the response with a phase shift as Z″ (imaginary part), and a distance from the origin to the plot is calculated as an impedance value.

When the electrical characteristics of the developing roller are pseudo-represented by an RC parallel circuit, the real part without a phase shift indicates a resistance component, and the imaginary part with a phase shift indicates an electrostatic capacitance component. Note that the meanings of the measurement conditions and measurement values have been described in Technical Significance of Requirement (1) mentioned above, and thus are omitted in this section.

The impedance of the developing roller measuring method, measuring apparatus, and measurement conditions will be described below.

### Impedance of the Developing Roller Measuring Method

The impedance of the developing roller can be measured by the following methods (1) and (2).
(1) A method in which a thin film electrode is provided on a surface of a developing roller, and measurement is performed using two terminals of the electrode and the substrate.
(2) A method in which a developing roller is pressed against a metal drum with a constant load, and measurement is performed using two terminals of the metal drum and the substrate.

Although the impedance can be measured by any method, the method (2) is affected by the width of the nip and the contact area between the developing roller and the metal drum, and thus it is necessary to measure the impedance with the developing roller having an equivalent hardness. Therefore, in the present disclosure, measurement is performed by the method (1). Hereinafter, the measurement method (1) will be described, and more specific conditions will be described later.

In the measurement of the impedance, in order to eliminate the influence of the contact resistance between the developing roller and the measuring electrode, it is preferable to deposit a low-resistance thin film on the surface of the developing roller and measure the impedance with two terminals using the thin film as an electrode and a conductive substrate as a ground electrode.

Examples of a method for forming the thin film include a method for forming a metal film such as metal vapor deposition, sputtering, application of a metal paste, and attachment of a metal tape. Among them, from the viewpoint of reducing the contact resistance with the developing roller, a method for forming a metal thin film of, for example, platinum or palladium as an electrode by vapor deposition is preferable. Vacuum platinum vapor deposition is adopted in the present disclosure.

When the metal thin film is formed on the surface of the developing roller, it is preferable to use a vacuum vapor deposition apparatus in which a mechanism capable of holding the developing roller is provided to the vacuum vapor deposition apparatus and a rotation mechanism is further provided to the developing roller having a cylindrical cross section in consideration of simplicity and uniformity of the thin film.

It is preferable that a metal thin film electrode having a width of about 10 mm in the longitudinal direction of the developing roller is formed, and a metal sheet wound around the metal thin film electrode in a direction intersecting the longitudinal direction without a gap is connected to a measuring electrode coming out of a measuring apparatus to perform measurement. In the case of a cylindrical developing roller, it is preferable to use a metal sheet wound without a gap in the circumferential direction of the developing roller. As a result, the impedance measurement can be performed without being affected by the fluctuation of the size of the outer edge (the outer diameter in the case of a cylindrical developing roller) in the cross section orthogonal to the longitudinal direction of the developing roller or the surface profile. As the metal sheet, an aluminum foil, a metal tape or the like can be used.

### Impedance of the Developing Roller Measurement Conditions

The impedance measuring apparatus may be any apparatus capable of measuring an impedance in a frequency range of up to 1.0×10⁻¹ to 1.0×10⁵ Hz, such as an impedance analyzer, a network analyzer, or a spectrum analyzer. Among them, it is preferable to perform measurement with an impedance analyzer from the viewpoint of the electric resistance range of the developing roller.

The impedance measurement conditions will be described. The impedance in the frequency range of 1.0×10⁻¹ to 1.0×10⁵ Hz is measured using an impedance measuring apparatus. As the measurement environment, the temperature is 23° C. and the relative humidity is 50%. The impedance measurement point is a central portion in the longitudinal direction of the developing roller. The voltage application condition is that an AC voltage of 50 V is superposed on a DC voltage of 50 V.

More details are as follows.

First, as a pretreatment, vacuum platinum vapor deposition is performed on a developing roller while rotating to prepare a measuring electrode. In the vapor deposition, a vacuum vapor deposition apparatus having a mechanism for holding a base portion of a roller as an object to be coated and rotating the base portion in a circumferential direction is used, and vapor deposition is performed so that the film thickness is 100 nm or more by controlling the roller rotation speed, vapor deposition distance, and vapor deposition time. At this time, a masking tape is used to form an electrode with a width of 1.5 cm. By forming the electrode with a film thickness of 100 nm or more, the contribution of the contact area between the measuring electrode and the developing roller can be reduced as much as possible by the surface roughness of the developing roller.

Next, an aluminum sheet is wound around the electrode without any gap, and the aluminum sheet is connected to the measuring electrode of an impedance measuring apparatus (trade name: Solartron 1260 and Solartron 1296, manufactured by Solartron, Inc.) and a high voltage system (trade name: 6792 and HVA-500, manufactured by TOYO Corporation).

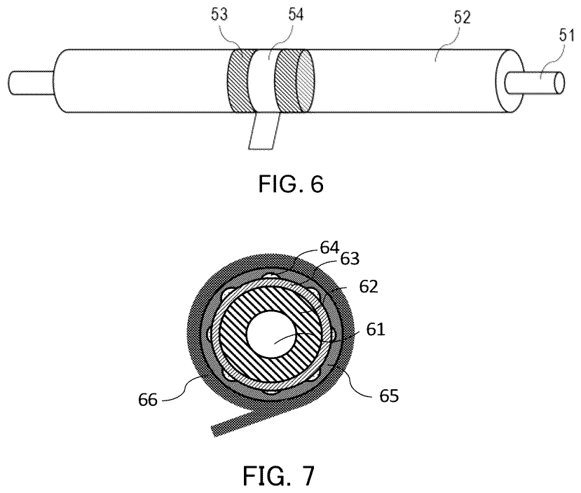

FIG. 6 shows a schematic view of a state in which the measuring electrode is formed on the developing roller. In FIG. 6, reference numeral 51 denotes a conductive substrate, reference numeral 52 denotes a conductive layer, reference numeral 53 denotes a platinum vapor deposition layer, and reference numeral 54 denotes an aluminum sheet. Although not shown in the figure, the elastic layer is present between the substrate 51 and the conductive layer 52.

FIG. 7 shows a cross-sectional view of a state in which the measuring electrode is formed on the developing roller. Reference numeral 61 denotes a conductive substrate, reference numeral 62 denotes an elastic layer, reference numeral 63 denotes a conductive layer, reference numeral 64 denotes an insulating portion, reference numeral 65 denotes a platinum vapor deposition layer, and reference numeral 66 denotes an aluminum sheet. As shown in FIG. 7, it is important to sandwich the conductive layer between the conductive substrate and the measuring electrode.

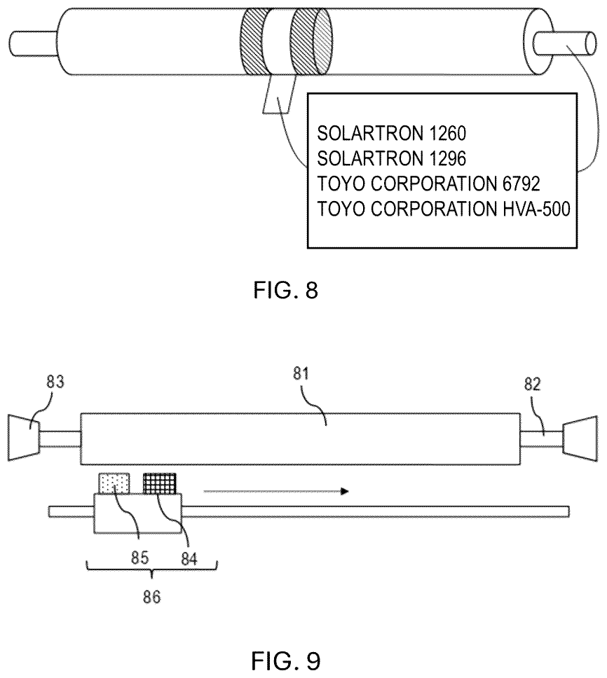

Then, the aluminum sheet is connected to the measuring electrode on a side of an impedance measuring apparatus (trade name: Solartron 1260 and Solartron 1296, manufactured by Solartron, Inc.) and a high voltage system (trade name: 6792 and HVA-500, manufactured by TOYO Corporation). FIG. 8 shows a schematic view of the measurement system. Impedance measurement is performed by using the conductive substrate and the aluminum sheet as two electrodes for measurement.

In the impedance measurement, a DC voltage of 50 V and an AC voltage of 50 V are applied in an environment at a temperature of 23° C. and a relative humidity of 50%, and an absolute value of an impedance is obtained at a frequency of 1.0×10⁻¹ to 1.0×10⁵ Hz. Then, the minimum value of the impedance value at a frequency of 1.0×10⁰ to 1.0×10¹ Hz is checked. The impedance measurement point is a central portion in the longitudinal direction of the developing roller.

### Surface Potential of the Developing Roller

A corona discharger having a grid portion with a width of 3.0 mm is placed in an environment at a temperature of 23° C. and a relative humidity of 50% such that a distance between the grid portion and an outer surface of the developing roller is 1.0 mm and a width direction of the grid portion is aligned with an axial direction of the developing roller. A voltage of 8 kV is applied to the grid portion, and the corona discharger is relatively moved along the axial direction of the developing roller at a speed of 400 mm/sec to charge the outer surface of the developing roller. The corona discharger is stopped at the measuring position on the developing roller, and the change in the surface potential of the developing roller at 0.06 seconds to 100.00 seconds after passage of the grid portion is measured at 0.01 second intervals.

When the time after passage of the grid portion is denoted by t (sec), the surface potential at t=0.06 is denoted by V_{INI}. Furthermore, the measurement results at 30.00≤t≤100.00 are fitted to formula (X′) below by a least squares method to calculate V_{0,1} and τ₁.

$${V}_{1} ( t ) = {V}_{0 , 1} exp ( - t / {τ}_{1} ) \qquad ( X ’ )$$

Further, V_{INI}−V₁ is calculated from V₁ that is a value when t=0.06 [sec] is substituted into the above formula.

In addition, the measurement results at 0.06≤t≤100.00 are fitted to formula (Y) below by a least squares method to calculate V_{0,2} [V] and T₂.

$$V ( t ) = {V}_{1} ( t ) + {V}_{2} ( t ) \qquad ( Y )$$

$$In formula ( Y ) , {V}_{2} ( t ) = {V}_{0 , 2} exp ( - t / {τ}_{2} ) \qquad ( Z )$$

The measurement is performed at 9 points in total, 3 points in the longitudinal direction×3 points in the circumferential direction of the developing roller, and the arithmetic means thereof are defined as V_{INI}−V₁, τ₁, and τ₂ of the developing roller.

The surface potential of the developing roller can be measured by the apparatus shown in FIG. 9, for example. Both end portions of a substrate 82 of a developing roller 81 are held by a chuck 83, and a measuring unit 86 in which a corona discharger 84 and a surface electrometer 85 are disposed in parallel at an interval of 25 mm is disposed facing the surface of the developing roller 81 at an interval of 1.0 mm distance. In a state where the developing roller 81 is stationary, a voltage of 8 kV is applied to the grid portion of the corona discharger 84, the measuring unit 86 is moved in the axial direction of the developing roller 81 at a speed of 400 mm/sec, and a change in the surface potential of the developing roller at 0.06 seconds to 100.00 seconds after passage of the corona discharger 84 is measured at 0.01 second intervals using the surface electrometer 85.

The meanings of the measurement conditions and measurement values have been described in Technical Significance of Requirement (2) mentioned above, and thus are omitted in this section.

More details are as follows.

The surface potential of the developing roller is measured using a charge amount measuring apparatus (trade name: DRA-2000L, manufactured by Quality Engineering Associates, Inc.). Specifically, a corona discharger having a grid portion is placed in an environment at a temperature of 23° C. and a relative humidity of 50% such that a distance between the grid portion and an outer surface of the developing roller is 1.0 mm and a width direction of the grid portion is aligned with an axial direction of the developing roller. The grid portion of the corona discharger of the apparatus has a width of 3.0 mm.

Subsequently, a voltage of 8 kV is applied to the corona discharger, and the corona discharger is relatively moved along the axial direction of the developing roller at a speed of 400 mm/sec to charge the outer surface of the conductive member. The change of the surface potential of the developing roller at 0.06 seconds to 100.00 seconds after passage of the grid portion is measured at 0.01 second intervals.

Calculation of Physical Properties Such as Circle-Equivalent Diameter and Inter-Wall Distance of Carbon Black Dispersed in Resin Layer

The dispersed particle diameter and inter-wall distance of the carbon black dispersed in the resin layer are measured by the following method.

First, a slice (with a thickness of 0.5 to 1.0 mm) is cut out using a razor so that a cross section perpendicular to the longitudinal direction of the developing roller can be observed. If the adhesiveness between the substrate and the resin layer is high, and it is difficult to cut out a slice with a razor, the entire substrate is cut out with a metal saw or the like, and then cross-sectional processing is performed with a focused ion beam (FIB) apparatus.

The slice is then platinum-deposited, and a scanning electron microscope (SEM) (trade name: JSM-7800F, manufactured by JEOL Ltd.) is used to take an image of the resin layer at 15,000× to obtain a cross-sectional image.

Furthermore, in order to quantify the cross-sectional image obtained by SEM observation, 8-bit gray scaling is performed on the cross-sectional image using image processing software (trade name: Luzex AP, manufactured by NIRECO Corporation) to obtain a 256-gradation monochrome image. Subsequently, black and white of the image are reversed so that the carbon black in the cross-sectional image becomes white, and then a threshold for binarization is set on the basis of the algorithm of Otsu's discriminant analysis method for the brightness distribution of the image to obtain a binarized image in which the carbon black is white, and the binder resin portion is black.

Then, the circle-equivalent diameter and the adjacent inter-wall distance of the white carbon black portions in the obtained binarized image are calculated using image processing software (trade name: Luzex AP, manufactured by NIRECO Corporation). The image region for calculating the circle-equivalent diameter and the adjacent inter-wall distance is set to a region inside 0.075 μm (If there is a text section describing SEM measurement conditions or the like, 0.075 μm inside from the part where the actual image started) in the actual image dimensions to eliminate uncertainty in the calculated values of the carbon black that is divided at the top, bottom, left and right edges of the image, and the circle-equivalent diameter and the adjacent inter-wall distance for all the carbon black in the designated image region are calculated.

Then, an arithmetic mean and a standard deviation are calculated for the distribution of the obtained circle-equivalent diameter and adjacent inter-wall distance. The number of sheets of images to be analyzed may be one, but at least three or more sheets of images may be analyzed in order to eliminate the influence of the differences in positions in the longitudinal direction of the carbon black dispersed in the resin layer of the developing roller.

The number average diameter of primary particles of the carbon black dispersed in the resin is measured with a transmission electron microscope (TEM). First, a sliced sample is prepared. A known method can be used for forming a thin slice. For example, a sample can be sliced with an ion beam, a diamond knife, or the like. In the present disclosure, a 40 nm-thick sliced sample for observation is prepared using an ultramicrotome (trade name: ULTRACUT-S, manufactured by Leica Microsystems, Inc.).

Then, a TEM image is acquired using a transmission electron microscope (trade name: H-7100FA, manufactured by Hitachi High-Tech Co., Ltd.) under measurement conditions of a TE mode and an acceleration voltage of 100 kV.

Then, with respect to the obtained TEM image, the circle-equivalent diameters of 50 primary particles of the carbon black in the TEM image are measured using image analysis software (trade name: WinROOF, manufactured by MITANI CORPORATION), and the number average value of the 50 primary particles is defined as the number average diameter of the primary particles.

### Checking of First Region and Second Region

The outer surface of the developing roller is observed using a laser microscope (trade name: VK-X100, manufactured by KEYENCE CORPORATION) with an objective lens of 20 times. On the roller surface, the first region that is repelled in an island shape and the second region that is exposed on the surface of the conductive layer can be checked.

### Proportion of Total Area of First Region

An objective lens with a magnification of 20 times is installed on a laser microscope (trade name: VK-X100, manufactured by KEYENCE CORPORATION). Then, an image of the surface of the developing roller is taken in 9 regions in total, two locations at 10 mm inward from both end portions in the longitudinal direction, one location at the center, and three locations in the circumferential direction (at intervals of 120°).

Next, it is assumed that the axial direction of the developing roller and the observation image are parallel by performing tilt correction of the obtained observation image in a quadratic curved surface correction mode. At the center of the corrected image, the total area occupied by the first region in a square area with a side length of 300 μm is measured. A value obtained by dividing the total area occupied by the first region within the square area with a side length of 300 μm is defined as the proportion of the total area of the first region. The arithmetic mean of the proportion of the total area obtained in the 9 regions is obtained and defined as the proportion of the total area of the first region of the developing roller.

### Measurement of Resistance of First Region

A sample including the first region is cut out from the developing roller, and a slice sample with a plane size of 50 μm square and a thickness t of 100 nm is prepared by a microtome. Next, this slice sample is placed on a metal flat plate, and the slice sample is pressed with a metal terminal having a pressing surface with an area S of 100 μm² from the upper side. In this state, a voltage of 1 V is applied between the metal terminal and the metal flat plate with an electrometer 6517B (trade name, manufactured by KEITHLEY) to obtain a resistance R. A volume resistivity pv (Ω·cm) is calculated from the resistance R using the following formula.

$$pv = R \times S / t$$

### Measurement of DBP Absorption Amount of Carbon Black

The DBP absorption amount of the carbon black is measured according to the Japanese Industrial Standards (JIS) K 6217-4 on the powder of the carbon black.

### Measurement of pH of Carbon Black

The pH of the carbon black is measured according to ASTM D1512 on the powder of the carbon black.

### Toner

The toner according to the present disclosure includes a toner particle and a fine particle having a compound containing a metal element. The metal element is at least one element selected from the group consisting of a titanium element, an aluminum element, a zirconium element, and a zinc element. In addition, when the toner surface is measured by X-ray photoelectron spectroscopy, the abundance ratio of the metal element is from 2.0 to 20.0 atomic %. The average circularity of the toner is 0.970 or more.

### Toner Particle

A toner particle according to an aspect of the present disclosure includes a binder resin. In addition, the toner particle may also contain a colorant and other components.

As the binder resin, a resin that is generally used as a binder resin for toner can be used. Specifically, examples thereof include a styrene-acrylic resin (such as a styrene-acrylic acid ester copolymer or a styrene-methacrylic acid ester copolymer), a polyester resin, an epoxy resin, a polyurethane resin, a polyamide resin, a cellulose resin, a polyether resin, a styrene-butadiene copolymer, a mixture of these resins, or a composite resin thereof. The resin is preferably an amorphous resin.

As the colorant, any known colorant can be used without particular limitation.

The toner particle may contain a release agent. The release agent is not particularly limited, and known release agents such as those listed below can be used. Petroleum-based waxes such as paraffin waxes, microcrystalline waxes, petrolatum and derivatives thereof, montan waxes and derivatives thereof, hydrocarbon waxes and derivatives thereof by the Fischer-Tropsch method, polyolefin waxes such as polyethylene and polypropylene and derivatives thereof, natural waxes such as carnauba waxes and candelilla waxes and derivatives thereof, higher aliphatic alcohols, fatty acids such as stearic acid and palmitic acid, or compounds thereof, acid amide waxes, ester waxes, ketones, hydrogenated castor oils, and derivatives thereof, vegetable waxes, animal waxes, and silicone resins. The derivatives include oxides, block copolymers with a vinyl-based monomer, and graft-modified products. These can be used alone or in combination.

The toner particle may contain a crystalline resin. The crystalline resin is not particularly limited, and a known crystalline resin can be used. Specific examples thereof include crystalline polyester resins and crystalline acrylic resins. The crystalline resin may be a block polymer having a crystalline segment and an amorphous segment.

The toner particle may contain a charge control agent, and known charge control agents can be used.

In addition, an example of a method for producing a toner particle will be described below.
(1) Suspension Polymerization Method: The toner particle is obtained by granulating a polymerizable monomer composition containing a polymerizable monomer capable of forming a binder resin and, as necessary, a release agent and a colorant in an aqueous medium and polymerizing the polymerizable monomer.
(2) Pulverization Method: The binder resin, and, if necessary, a release agent, a colorant, and the like are melted and kneaded and pulverized to obtain a toner particle.
(3) Dissolution Suspension Method: The toner particle is obtained by dissolving a binder resin, and as necessary, a release agent and a colorant, in an organic solvent to prepare an organic phase dispersion, suspending, granulating, and polymerizing the dispersion in an aqueous medium, and then removing the organic solvent. In addition, the toner particle obtained by a pulverization method may be subjected to heat spheronization to adjust the average circularity.
(4) Emulsion Polymerization and Aggregation Method: The toner particle is obtained by aggregating and associating binder resin particles, and optionally particles such as release agent particles and colorants, in an aqueous medium. Examples of the aqueous medium include the following. Water; and a mixed solvent of water and alcohols such as methanol, ethanol, propanol.

Among them, a suspension polymerization method is preferable. The toner particle produced by the suspension polymerization method is preferred because the individual particles are approximately spherical, have an increased average circularity, and tend to cause the toner to roll on the developing roller.

### Fine Particle

The fine particle has a compound containing a metal element. The metal element is at least one selected from the group consisting of a titanium element, an aluminum element, a zirconium element, and a zinc element.

The compounds containing such metal elements include at least one selected from the group consisting of titanium-based compounds, aluminum-based compounds, zirconium-based compounds, and zinc-based compounds. Specifically, examples include metal oxides such as titanium oxide, aluminum oxide, and zinc oxide; composite oxides such as strontium titanate and barium titanate; and polybasic acid metal salts such as titanium phosphate, zirconium phosphate, and aluminum phosphate. It is preferable that the compound containing a metal element is at least one selected from the group consisting of titanium oxide, aluminum oxide, zinc oxide, strontium titanate, zirconium phosphate, and titanium phosphate.

Note that whether the compound containing a metal element is a metal oxide, a composite oxide, or a polybasic acid metal salt can be confirmed by observing the toner surface using STEM-EDS, which will be described later.

The fine particles are preferably particles of a compound containing a metal element.

In addition, when the toner surface according to the present disclosure is measured by X-ray photoelectron spectroscopy, the abundance ratio of the metal element is 2.0 to 20.0 atomic %.

The compound containing at least one element selected from the group consisting of a titanium element, an aluminum element, a zirconium element, and a zinc element as a metal element has low electrical resistance. The abundance ratio of the metal element measured by X-ray photoelectron spectroscopy indicates the abundance of the compound containing the metal element on the toner surface.

Then, by causing a compound containing a metal element to be present on the toner surface such that the abundance ratio of the metal element is 2.0 atomic % or more, the electrical resistance of the toner surface can be reduced, thereby enabling charge exchange between the toners. Further, by causing a compound containing a metal element to be present on the toner surface such that the abundance ratio of the metal element is 20.0 atomic % or less, the toner can maintain its charge retention property, thereby suppressing transfer failures caused by an excessive reduction in charge. The abundance ratio of the metal element is more preferably 5.0 atomic % or more. The abundance ratio of the metal element may be from 5.0 to 20.0 atomic %, and may be from 5.0 to 10.0 atomic %.

In a case where there are a plurality of types of metal elements, the abundance ratio of metal elements is the sum of the abundance ratios of all metal elements.

As a method for setting the abundance ratio of the metal element within the above range, for example, a method of externally adding the above fine particle to the toner particle by mixing them using a mixer, or a method of precipitating the fine particles in a particulate form on the toner particle surface may be employed.

As the mixer for externally adding the fine particle to the toner particle, any known mixer, whether of a dry or wet type, can be used without particular limitation. For example, an FM mixer (manufactured by NIPPON COKE & ENGINEERING CO., LTD.), a Super Mixer (manufactured by KAWATA MFG. CO., LTD.), a Nobilta (manufactured by Hosokawa Micron Group), or a Hybridizer (manufactured by Nara Machinery) can be used. In order to control the coating state of the fine particles, the toner can be prepared by adjusting the rotation speed and processing time of the above-mentioned external addition apparatus, as well as the water temperature and water amount in the jacket.

By these methods, the content of the fine particles for making the abundance ratio of the metal element within the above range is preferably from 2.0 parts by mass to 10.0 parts by mass or less relative to 100 parts by mass of the toner particles. More preferably, the amount is from 3.0 parts by mass to 10.0 parts by mass.

The conductivity of the fine particles obtained by impedance measurement is preferably from 1.0×10⁻⁹ to 1.0×10² S/m. By setting the conductivity of the fine particles to 1.0×10⁻⁹ S/m or more and the abundance ratio of the metal element within the above range, the electrical resistance in the surface direction of the toner tends to decrease, making it easier for the toner particle to exchange charges with each other. Further, by setting the conductivity to 1.0×10² S/m or less, excessive reduction in the toner charge can be suppressed more easily. The conductivity of the fine particles is more preferably from 1.0×10⁻⁸ to 1.0×10⁻¹ S/m, and still more preferably 1.0×10⁻⁸ to 1.0×10⁻³ S/m.

The conductivity of the fine particles can be changed by changing the type of compound containing the metal element.

A method for measuring the conductivity of the fine particles will be described later.

When an EDS mapping image of the constituent elements in the cross section of the toner obtained by analyzing the cross section of the toner observed by a scanning transmission electron microscope using an energy-dispersive X-ray spectrometer is obtained, it is preferable that the number average length of the fine particles having the signals derived from the metal element, in the normal direction to the contour of the toner particle at the contact point between the fine particles having the signal derived from the metal element and the toner particle is from 0.01 to 0.50 μm. The number average length of the fine particles represents the number-average particle diameter of the fine particles. When the number average length of the fine particles is 0.01 μm or more, charge exchange between toners is likely to occur upon contact. Also, by setting the number average length to 0.50 μm or less, it becomes easier to reduce the surface-direction resistance of the toner when the abundance ratio of the metal element is within the above range.

The number average length of the fine particles is more preferably 0.30 μm or less. More preferably, it is 0.20 μm. The number average length of the fine particles may be from 0.01 to 0.30 μm, and may be from 0.01 to 0.20 μm.

The number average length of the fine particles can be adjusted by changing the number-average particle diameter of the primary particles of the fine particles.

The method of measuring the number average length of the fine particles will be described later.

The toner may contain conventionally known external additives other than the above-described fine particles, without any particular limitation.

Specific examples thereof may include the following:
raw silica fine particles such as wet silica and dry silica, or surface-treated silica fine particles obtained by subjecting such raw silica fine particles to surface treatment with a treating agent such as a silane coupling agent, a titanium coupling agent, or silicone oil; resin fine particles such as vinylidene fluoride fine particles and polytetrafluoroethylene fine particles; and the like.

The content of the external additive is not particularly limited, and may be from 0.01 to 2.00 parts by mass relative to 100 parts by mass of the toner particles.

The average circularity of the toner is 0.970 or more. Since the average circularity of the toner is 0.970 or more, the toner becomes a spherical shape that allows the toner to roll, and the toner is easy to roll when shear force is applied to the toner. The average circularity of the toner is preferably from 0.970 to 1.000, and more preferably from 0.980 to 1.000. Further, the range may be from 0.970 to 0.990 or from 0.980 to 0.990.

The average circularity of the toner can be adjusted by a method for producing the toner particle. In order to adjust the average circularity to the above range, it is preferable to select a suspension polymerization method. In addition, in a case where other producing methods are selected, the above range can be adjusted by adding a spheroidization process.

A method for measuring the average circularity of the toner will be described below.

The volume-average particle diameter of the toner is preferably from 6.4 to 7.0 μm, and more preferably from 6.6 to 7.0 μm. If the volume-average particle diameter of the toner is within the above range, the toner is readily spontaneously replaced from the developing roller.

A method for measuring the volume-average particle diameter of the toner will be described later.

### Method of Determining Presence and Number-Average Particle Diameter of Fine Particles

### Observation of Toner Surface by STEM-EDS

Using a scanning transmission electron microscope (STEM), the section containing the outermost surface of the toner is observed by the following method.

First, after sufficiently dispersing the toner in a room-temperature-curable epoxy resin, the mixture is cured for two days in an atmosphere at 40° C. Using a microtome equipped with a diamond blade (EM UC7, manufactured by Leica), a thin slice sample having a thickness of 50 nm and including the outermost surface of the toner is cut out from the obtained cured product. This sample is enlarged 100,000 times under the conditions of an acceleration voltage of 200 V and an electron beam probe size of 1 mm using a STEM (model JEM-2800, manufactured by JEOL Ltd.), and the outermost surface of the toner is observed.

Subsequently, the constituent elements on the outermost surface of the obtained toner are analyzed using energy dispersive X-ray spectroscopy (EDS) to produce an EDS mapping image (256×256 pixels (2.2 nm/pixels), integration times 200 times).

In the produced EDS mapping image, in a case where a signal derived from a metal element is observed on the surface of the toner and particles are observed at the same position in the STEM image, the particles are defined as fine particles according to the present disclosure. Also, by the element detected at the same position as the signal derived from the metal element, it is confirmed that the fine particles are metal oxide, composite oxide, polybasic acid metal salt, or the like.

Further, in the region outside of the contour of the toner particle, the length of the fine particle having the signal derived from the metal element in the normal direction with respect to the contour of the toner particle at the contact point between the fine particle having the signal derived from the metal element and the toner particle is measured. The lengths of 30 fine particles are measured by the above method, and the arithmetic mean is set as the number average length of the fine particles. The normal to the contour of the toner particle is determined based on the point among the contact points between the fine particle having a signal derived from the metal element and the toner particle, which is located closest to the center of the toner particle.

### Method of Measuring Abundance Ratio of Metal Elements on Toner Surface

Calculation of Abundance Ratio of Metal Elements Using X-ray Photoelectron Spectroscopy

The abundance ratio of metal elements is calculated by measuring the toner under the following conditions:
Measuring device: X-ray photoelectron spectroscopy: Quantum 2000 (manufactured by ULVAC-PHI, INCORPORATED.)
X-ray source: Monochromic Al Kα
Xray Setting: 100 μmφ (25 W (15 KV))
Photoelectronic pick-up angle: 45 degrees
Neutralization conditions: A combination of a neutralizing gun and an ion gun
Analysis region: 300 μm×200 μm
Pass Energy: 58.70 eV
Step size: 0.125 eV
Analytical software: Maltipak (PHI)

Next, a method of obtaining a quantitative value of a metal element by analysis will be described with reference to a case where Ti element is used as the metal element as an example below.

First, the peak derived from the C—C bond of the carbon is orbital is corrected to 285 eV. Then, based on the peak area of the Ti 2p orbital whose peak top is detected in the range of 452 to 468 eV, the amount of Ti derived from the Ti element with respect to the total amount of constituent elements is calculated using the relative sensitivity factor provided by ULVAC-PHI, and this value is defined as the abundance ratio (atomic %) of Ti element present on the toner surface.

In the case of the Al element, a peak area derived from an Al 2p orbital where a peak top is detected near 73 eV is used.

In the case of the Zr element, a peak area derived from the Zr 3d orbital at which a peak top is detected at from 170 to 190 eV is used.

In the case of the Zn element, a peak area derived from the Zn 2p orbital in which a peak top is detected at from 1020 to 1050 eV is used.

### Method of Measuring Average Circularity of Toner

The average circularity of the toner is measured using a flow particle image analyzer “FPIA-3000” (manufactured by Sysmex Corporation) under measurement and analysis conditions during a calibration operation.

A specific measurement method is as described below.

First, 20 mL of ion exchanged water, from which impurities and solid contaminants have been removed in advance, is placed into a glass container. Then, 0.2 mL of a dilution prepared by diluting “CONTAMINON N” (10 mass % aqueous solution of a neutral detergent for washing a precision measuring instrument, composed of a nonionic surfactant, an anionic surfactant, and an organic builder, with a pH of 7; manufactured by FUJIFILM Wako Pure Chemical Corporation) threefold by mass with ion exchanged water is added thereto as a dispersing agent. Subsequently, 0.02 g of the measurement sample is added, and the mixture is subjected to dispersion treatment for 2 minutes using an ultrasonic dispersion device to obtain a dispersion liquid for measurement. At this time, the dispersion liquid is appropriately cooled so that the temperature thereof is maintained in the range of 10° C. to 40° C. As the ultrasonic dispersion device, a benchtop ultrasonic cleaning-type disperser having an oscillation frequency of 50 kHz and an electrical output of 150 W (for example, “VS-150”, manufactured by VELVO-CLEAR) is used. A predetermined amount of ion exchanged water is placed in the water tank, and 2 mL of the above-mentioned CONTAMINON N is added to the water tank.

For the measurement, a flow particle image analyzer equipped with “LUCPLFLN” (magnification: 20 times, numerical aperture: 0.40) as an objective was used, and a particle sheath “PSE-900A” (manufactured by Sysmex Corporation) was used as a sheath solution. The dispersion prepared in accordance with the above-described procedure is introduced into the flow particle image analyzer, and 2000 toners are measured in an HPF measurement mode and in a total count mode.

In addition, the binarization threshold value upon particle analysis is set to 85%, the analyzed particle diameter is limited to a circle-equivalent diameter of 1.977 μm or more and less than 39.54 μm, and the average circularity of the toner particle is obtained.

Upon the measurement, automatic focus adjustment is performed using a standard latex particle (for example, “RESEARCH AND TEST PARTICLES Latex Microsphere Suspensions 5100A” manufactured by Duke Scientific Corp. is diluted with ion exchanged water) before the start of the measurement. After that, focus adjustment is performed every two hours from the start of the measurement.

Here, in examples, a flow particle image analyzer that has been calibrated by Sysmex Corporation and has received a calibration certificate issued by Sysmex Corporation is used. The measurement is performed under measurement and analysis conditions when calibration certification was received, except that the analyzed particle diameter is limited to a circle-equivalent diameter of 1.977 μm or more and less than 39.54 μm.

### Method of Measuring Volume-Average Particle Diameter of Toner

The volume-average particle diameter of the toner and the toner particle (hereinafter referred to as the toner) is calculated in the following manner.

The volume-average particle diameter (Dv) of the toner is calculated as follows. As the measurement device, a particle counting analyzer employing the pore electrical resistance method and equipped with a 100 μm aperture tube, “CDA-1000X” (manufactured by Sysmex Corporation), is used. The measurement condition settings and analysis of the measured data are performed using the dedicated software “CDA-1000X” (manufactured by Sysmex Corporation) provided with the device.

As the aqueous electrolytic solution used for the measurement, for example, “CELLPACK” (manufactured by Sysmex Corporation) can be used.

Here, before performing the measurement and analysis, dedicated software is set as follows.

On a “measurement condition setting” screen of the dedicated software, the total count number is set to 50,000, the number of repeated measurements is set to one, and the measurement mode is set to total count (not limited).

Specific measurement methods are as follows.
(1) 150 ml of an aqueous electrolytic solution is placed in a dedicated glass round-bottom beaker, set on a sample stage, and stirring of the stirring propeller is performed at 500 rpm. Then, the “blank check measurement” of the dedicated software is clicked to start the measurement and confirm that the count number is less than 500. In a case where the count number is 500 or more, the beaker and aperture are washed repeatedly.
(2) 30 mL of the aqueous electrolytic solution is put into a 100-mL flat-bottom glass beaker. Then, 0.3 mL of a diluted solution obtained by diluting “CONTAMINON N” (a 10 mass % aqueous solution of a neutral detergent for washing a precision measuring instrument having a pH of 7 composed of a nonionic surfactant, an anionic surfactant, and an organic builder, manufactured by FUJIFILM Wako Pure Chemical Corporation) with ion exchanged water approximately threefold by mass is added thereto as a dispersing agent.
(3) An ultrasonic dispersion device “Ultrasonic Dispension System Tetra 150” (manufactured by Nikkaki-Bios Co., Ltd.) having an electrical output of 120 W is prepared by incorporating two oscillators with an oscillation frequency of 50 kHz in a state where the phases are shifted by 180 degrees. 3.3 L ion exchanged water is placed in a water tank of an ultrasonic dispersion device, and 2 mL of CONTAMINON N is added into the water tank.
(4) The beaker in (2) is set in a beaker fixing hole of the ultrasonic dispersion device, and the ultrasonic dispersion device is operated. In addition, the height position of the beaker is adjusted so that the resonance state of the liquid level of the aqueous electrolytic solution in the beaker is maximized.
(5) In a state where the aqueous electrolytic solution in the beaker in the (4) has been irradiated with ultrasonic waves, 10 mg of the toner is added little by little and dispersed. In addition, an ultrasonic dispersion treatment is additionally continued for 60 seconds. In the ultrasonic dispersion, the water temperature of the water tank is appropriately adjusted to from 10° C. to 40° C.
(6) The aqueous electrolytic solution in the (5) in which the toner has been dispersed is added dropwise to the round bottom beaker in the (1) set in the sample stand using a pipette, and the measurement concentration is adjusted to about 6%. In addition, the measurement is performed until the number of measurement particles reaches 50,000.
(7) The measured data is analyzed by a dedicated software attached to the apparatus to calculate the volume-average particle diameter (Dv).

### Method of Measuring Impedance of Fine Particle and Calculation of Conductivity

Capacitance and conductivity of air and powder are measured by impedance measurement using a parallel plate capacitor method.

The apparatus uses a toner measurement tool composed of a four-terminal sample holder SH2-Z (manufactured by Toyo Technica) and a torque wrench adapter SH-TRQ-AD (optional), and a material testing system ModuLab XM MTS (manufactured by Solartron Analytical).

Also, a noise cut transformer NCT-I3, 1.4 kVA (manufactured by DENKENSEIKI Research Institute Co., Ltd.) for suppressing commercial power source noise and a shield box for suppressing electromagnetic wave noise are used.

The measurement tool uses a four-terminal sample holder and an optional torque wrench adapter SH-TRQ-AD, and uses an upper electrode (Φ 25 mm solid electrode) SH-H25AU, a lower electrode for liquid/powder (central electrode (Φ 10 mm; guard electrode (26 mm) SH-2610AU as parallel plate electrodes, and is configured to measure resistance ranging from 0.1Ω to 1 T Ω for electrical signals up to 500 Vp-p and DC to 1 MHz.

Also, in order to adjust the pressure of the sample, a torque wrench adapter SH-TRQ-AD (manufactured by Toyo Technica) is attached to a micrometer provided in the four-terminal sample holder and used for measuring the film thickness between the upper and lower electrodes.

As the torque driver used for the pressurization management, when the powder to be measured is fine particles, a torque driver RTD30CN (manufactured by Tohnichi Mfg. Co., Ltd.) and a 6.35 mm square bit are used, and the clamping torque can be managed to 20.0 cN·m.

The measurement of the electrical AC characteristics uses a material testing system ModuLab XM MTS (manufactured by Solartron Analytical) to perform impedance measurements.

The ModuLab XM MTS is composed of a control module XM MAT 1 MHz, a high-voltage module XM MHV100, a femtoammeter module XM MFA, and a frequency response analysis module XM MRA 1 MHz. The control software used is XM-studio MTS Ver. 3.4 (manufactured by the same company).

The measurement conditions for the fine particles are set to Normal Mode for measurement only, with an AC level of 0.5 Vrms, a DC bias of 0 V, and a sweep frequency from 1 MHz to 0.01 Hz (12 points/decade or 6 points/decade).

Furthermore, in consideration of noise suppression and reduction of measurement time, the following settings are additionally applied for each sweep frequency.

Sweep frequency: 1 MHz to 10 Hz; measurement integration time: 64 cycles

Sweep frequency: 10 Hz to 1 Hz; measurement integration time: 24 cycles

Sweep frequency: 1 Hz to 0.01 Hz; measurement integration time: 1 cycle

The measurement of impedance characteristics, which are the electrical AC characteristics of the fine particles, is performed under the above measurement conditions.

By performing measurements under the above conditions, impedance characteristics of both air and the sample at a thickness d corresponding to the applied pressure torque can be obtained using a powder measuring tool based on the parallel plate capacitor method, with a measuring electrode S of Φ 10 mm.

From the obtained impedance characteristics of air and the sample, data correction processing of the measurement system is performed to obtain highly reliable capacitance C and conductance (conductivity) G. From the obtained capacitance C, conductance (conductivity) G, and the geometrical configuration of the measurement jig (electrode size S of the parallel plate and sample film thickness), dielectric constant and conductivity, which are electrical properties, are calculated.

In a case of using the four-terminal sample holder SH2-Z for the first time, it is necessary to conduct two verifications in advance in order to identify optimal measurement conditions, because individual variation exists in the four-terminal sample holders SH2-Z used in the powder measuring tool.

The first verification is the thickness dependence characteristic of the four-terminal sample holder. The dependence on the air thickness (distance between the upper and lower electrodes) is measured, and the error between the theoretical and measured values of the capacitance is confirmed, in order to identify the film thickness that provides the optimal range or optimal value at which the measurement error is minimized.

The second verification is the measurement of mechanical error. For the measurement of the powder sample, a load is applied under torque control in order to maintain a constant bulk density. In contrast, for the measurement of air, the measurement is conducted under a no-load condition. At this time, a film thickness error occurs due to dimensional influences such as mechanical machining accuracy. Therefore, the offset value between the loaded state (with the tightening torque control value of 6.5 cN·m in this tool) and the no-load condition is checked and used as the offset correction value.

Specific sample preparation and measurement procedures are as follows.
(1) Powder is placed on the central electrode portion of the lower electrode and shaped into a trapezoidal form having a height of 5 mm.
(2) The lower electrode on which the powder is placed is attached to the four-terminal sample holder SH2-Z, and the upper electrode is lowered.
(3) At this time, the upper electrode is lowered to the upper end of the powder while keeping it constant so as not to rotate inadvertently.
(4) While rotating the upper electrode to the left and right, smoothing processing is performed so that the surface of the powder becomes smooth.
(5) While adjusting to achieve a predetermined film thickness using a micrometer, the rotational direction of the upper electrode is maintained uniformly in a single direction.
(6) Pressure is applied using a torque driver.
(7) The sample film thickness is measured using a micrometer.
(8) Impedance measurement is performed under the above conditions.
(9) After the measurement is completed, the upper electrode is raised, and the lower electrode is removed. At this time, the lower electrode is removed with sufficient care so that the powder does not enter the contact terminals for the lower electrode of the four-terminal sample holder, and the terminals are protected with masking tape.
(10) The upper and lower electrodes are cleaned.
(11) The masking tape is removed, and the lower electrode is mounted.
(12) Adjustment is made so that the air thickness t, which accounts for the offset correction under the no-load condition, corresponds to the sample film thickness d obtained in Process (7), while maintaining the rotational direction of the upper electrode uniformly in a single direction.
(13) Impedance measurement of air is performed.
(14) If the air measured data (dielectric loss tangent; tan 6) measured in Process (13) is 0.002 or more in the frequency range of 100 Hz to 0.01 Hz, it indicates insufficient cleaning, and the procedure is restarted from the cleaning process in Process (10).

The measurement is performed at 25° C.

The specific data processing procedure is as follows.
(15) From the measured impedance characteristics of the air, the error of the phase characteristics relative to the theoretical value is calculated to obtain phase correction data of the material testing system ModuLab XM MTS (manufactured by Solartron Analytical).
(16) The phase correction data calculated in Process (15) is applied to the impedance characteristics of air measured in Process (13), thereby obtaining the phase-corrected impedance characteristics of air.
(17) From the admittance Ya=Ga+jωCa of the phase-corrected impedance characteristics of air, the capacitance Ca is calculated, and the error with respect to the theoretical value is also calculated to obtain correction data a for film thickness error.
(18) The phase correction processing obtained in Process (15) is applied to the impedance characteristics of the powder sample measured in Process (8).
(19) By performing calculation on the complex admittance Ym=Gm+jωCm of the characteristics subjected to the phase correction processing in Process (18), using the air capacitance Ca and the correction data a obtained in Process (17), highly reliable dielectric constant and conductivity of the powder sample are obtained.

The conductivity of the microparticles in the present disclosure is the value of conductivity at a frequency of 0.01 Hz.

### Method of Measuring Work Function

The work functions of the conductive portion, the insulating portion, the fine particles, and the external additive of the developing roller are measured by the following measurement method. The work function is quantified as energy (eV) for extracting electrons from the substance. The work function is measured using a surface analysis device (AC-2 manufactured by RIKEN KEIKI CO., LTD.). In the above device, measurement is performed using a deuterium lamp under the following conditions.
Irradiation light amount: 800 nW
Spectrometer: Single-color light
Spot size: 4 [mm]×4 [mm]
Energy scanning range: 3.6 to 6.2 [eV]
Anode voltage: 2910 V
Measurement time: 30 [sec/1 point]

Then, the photoelectrons emitted from the sample surface are detected, and calculation processing is performed using the work function calculation software incorporated in the surface analysis device. The work function is measured with a repeatability (standard deviation) of 0.02 [eV]. When measuring powder, a cell for powder measurement is used.

In the above surface analysis, when the excitation energy of monochromatic light is scanned from the lower side to the higher side at intervals of 0.05 eV, photoelectron emission begins at a certain energy value [eV], and this energy threshold is defined as the work function [eV].

In the measurement curve of the work function obtained by the measurement under the above conditions, the horizontal axis represents the excitation energy [eV], and the vertical axis represents the value of 0.5 power (normalized photoelectron yield) of the number of emitted photoelectrons. Generally, when the excitation energy value exceeds a threshold, the emission of photoelectrons, i.e., normalized photoelectron yield, increases rapidly and the work function measurement curve rises rapidly. The excitation energy at which the rise occurs is defined as the photoelectric work function value Wf [eV]. This photoelectric work function value Wf [eV] is used as the work function of the sample.

The work functions of the conductive portion and the insulating portion of the developing roller are measured by applying a conductive layer-forming coating liquid or a coating liquid for forming the insulating portion onto an aluminum sheet, followed by drying and curing under the respective conditions described in the following production examples.

The work function of the conductive portion of the developing roller is not particularly limited, and may be from 4.0 to 5.0. The work function of the insulating portion of the developing roller is not particularly limited, and may be from 4.0 to 5.0. The work function of the fine particles is not particularly limited, and may be from 4.0 to 6.0. The work function of the external additive is not particularly limited, and may be from 4.0 to 6.0.

### Process Cartridge and Electrophotographic Image Forming Apparatus

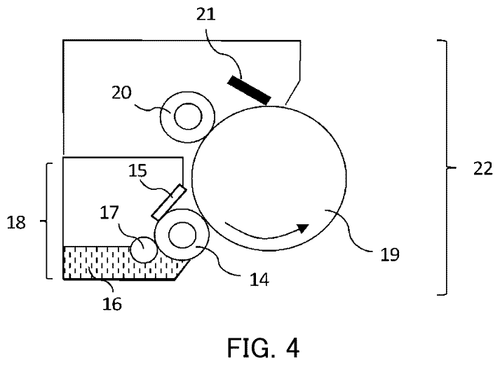

The developing roller of the present disclosure can be suitably used as a developing roller in a process cartridge. FIG. 4 is a schematic sectional view of an example of the process cartridge according to one aspect of the present disclosure. A process cartridge 22 is configured to be attachable and detachable to the main body of the electrophotographic image forming apparatus. The process cartridge 22 includes a developing apparatus 18 provided with a developing roller 14 and a developing blade 15, a photosensitive member 19; a charging roller 20, and a cleaning blade 21, which are integrated together. That is, the process cartridge includes a developing unit, and the developing unit includes the developing apparatus 18. The developing apparatus 18 is further filled with a toner 16. The toner 16 is supplied to the surface of the developing roller 14 by the toner supply roller 17, and a layer of the toner 16 having a predetermined thickness is formed on the surface of the developing roller 14 by the developing blade 15.

The developing roller 14 is in contact with the photosensitive member 19 and is driven to rotate at a predetermined peripheral speed ratio with respect to the photosensitive member 19. A predetermined bias is applied to the developing roller 14 to develop and visualize the electrostatic latent image on the photosensitive member 19 using the toner 16.

The toner supply roller 17 is in contact with the developing roller 14, penetrates in a predetermined penetration level, and rotates in the same direction as or reverse direction to the rotational direction of the developing roller 14. Further, a predetermined bias may be applied to the toner supply roller 17. By reducing the difference in relative speed between the toner supply roller 17 and the developing roller 14 or by reducing the penetration level for the developing roller 14 of the toner supply roller 17, the drive torque can be significantly reduced.

One end of the developing blade 15 is fixed to the developing apparatus 18, and the other free end is disposed in contact with the developing roller 14 in a counter direction to the rotational direction of the developing roller 14. By disposing the developing blade 15 in contact with the developing roller 14, the amount of the toner on the developing roller 14 is regulated and made thin to form a toner layer having a uniform thickness. A predetermined bias is applied to the developing blade 15, and charges are applied to the toner 16 and the insulating portion on the outer surface of the developing roller 14.

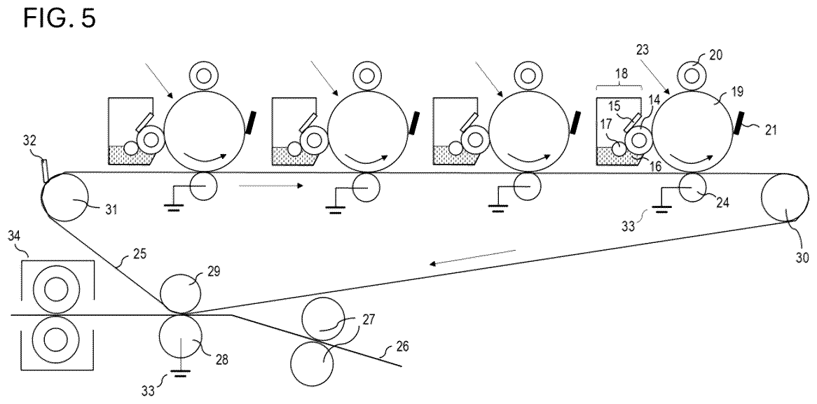

FIG. 5 is a schematic cross-sectional view showing an example of an electrophotographic image forming apparatus including a contact-type developing apparatus using a one-component toner.

The developing apparatus 18 includes a toner 16 as one-component toner, a developing roller 14, a toner supply roller 17 that supplies the toner to the developing roller 14, and a developing blade 15 for regulating the thickness of the toner layer on the developing roller 14. That is, the electrophotographic image forming apparatus includes a developing unit, and the developing unit includes the developing apparatus 18. The developing roller 14 is located in an opening in the developing apparatus 18 extending in the longitudinal direction and is installed in contact with the photosensitive member 19. The photosensitive member 19, the charging roller 20, and the cleaning blade 21 may be disposed in the main body of the electrophotographic image forming apparatus. The developing apparatus 18 is provided with respective color toners of black, cyan, magenta, and yellow, which makes it possible to perform color printing.

The printing operation of the electrophotographic image forming apparatus will be described below. The photosensitive member 19 rotates in the direction of the arrow and is uniformly charged by the charging roller 20 for charging the photosensitive member 19. Next, an electrostatic latent image is formed on the surface of the photosensitive member 19 by a laser light 23, which is an exposure unit. The electrostatic latent image is visualized (developed) as a toner image by applying the toner 16 from the developing roller 14 disposed in contact with the photosensitive member 19 by the developing apparatus 18. The development is so-called reversal development for forming a toner image on an exposed portion.

The toner image formed on the photosensitive member 19 is transferred to an endless belt-shaped intermediate transfer member 25 by a transfer roller 24 that is a transfer member.

A paper sheet 26, which is a recording medium, is fed into the apparatus by a paper feed roller 27 and a secondary transfer roller 28, and is transported to a nip portion between the secondary transfer roller 28 and a driven roller 29 together with the intermediate transfer member 25 having the toner image, and the toner image is transferred to the paper sheet 26. The intermediate transfer member 25 is operated by the driven roller 29, a driver roller 30, and a tension roller 31. The toner remaining on the intermediate transfer member 25 is cleaned by a cleaning apparatus 32.

A voltage is applied from a bias power source 33 to the developing roller 14, the developing blade 15, the transfer roller 24, and the secondary transfer roller 28. The paper sheet 26 to which the toner image is transferred is subjected to fixing by a fixing apparatus 34 and ejected to the outside of the apparatus, and the printing operation is finished. Meanwhile, the transfer residual toner remaining on the photosensitive member 19 without being transferred is scraped off by a cleaning blade 21, which is a cleaning member for cleaning the surface of the photosensitive member. The cleaned photosensitive member 19 repeats the above printing operation.

### EXAMPLES

The present disclosure will be described in further detail below by way of examples, which are not limiting the present disclosure at all. Hereinafter, “part(s)” refers to “part(s) by mass” unless otherwise specified.

### 1. PRODUCTION EXAMPLE OF DEVELOPING ROLLER

Although this example describes a developing roller in which a conductive layer is laminated on an elastic roller provided with an elastic layer on an outer surface of a substrate, and further an insulating portion is placed, but the developing roller is not limited to this configuration.

### 1-1. Preparation and Production Example of Raw Material for Forming Conductive Layer

### 1-1-1. Preparation of Raw Polyol and Production Example

Hereinafter, a synthesis example for obtaining a polyurethane resin layer will be described.

### Measurement of Number Average Molecular Weight of Raw Polyol

The apparatus used to measure the number average molecular weight (Mn) in the present production example, and conditions are as follows.
Measuring apparatus: HLC-8120 GPC (manufactured by Tosoh Corporation)
Column: TSKgel Super HZMM (manufactured by Tosoh Corporation)×2
Solvent: Tetrahydrofuran (THF) (20 mmol/l triethylamine added)
Temperature: 40° C.
Frow rate of THF: 0.6 ml/min

As the measuring sample, 0.1 mass % THE solutions were used. Furthermore, measurement was performed using an RI (refraction index) detector as a detector.

Calibration curves were prepared using TSK standard polystyrene A-1000, A-2500, A-5000, F-1, F-2, F-4, F-10, F-20, F-40, F-80, and F-128 manufactured by Tosoh Corporation as standard samples for preparing a calibration curve. Based on this calibration curve, the number average molecular weight was determined from the retention time of the obtained measuring sample.

### Preparation of Raw Polyol

Commercial products were used for A-1 to A-5, which are 5 types of raw polyols shown in Table 1 below. Also, raw polyols A-6 and A-7 were synthesized by the following method.

TABLE 1

| No. | Raw polyol |
|---|---|
| A-1 | Duranol T5652 Mn = 2000 (Manufactured by |
| | Asahi Kasei Chemicals Corporation) |
| A-2 | Duranol G3452 Mn = 2000 (Manufactured by |
| | Asahi Kasei Chemicals Corporation) |
| A-3 | ETERNACOLL UH-200 Mn = 2000 (Manufactured |
| | by Ube Industries, Ltd.) |
| A-4 | Nippolan 982 Mn = 2000(Manufactured by |
| | Tosoh Corporation) |
| A-5 | ETERNACOLL UM-90(1:3) Mn = 900 (Manufactured |
| | by Ube Industries, Ltd.) |

### Synthesis of Raw Polyol A-6

Under a nitrogen atmosphere, 100.0 g of 1,3-propanediol, 49.4 g of adipic acid, and 69.5 g of ethylene carbonate were mixed and heated, and ethylene glycol and water formed from the reaction system were distilled off while raising the temperature to 200° C. After ethylene glycol and water were distilled off, 15 ppm of titanium tetraisopropoxide was added, and the polycondensation reaction was further allowed to proceed under a reduced pressure of 266.7 Pa. The reaction liquid was cooled to room temperature to yield a raw polyol A-6. The number average molecular weight of the resulting raw polyol A-6 was 2030.

### Synthesis of Raw Polyol A-7

A raw polyol A-7 was synthesized in the same manner as in the case of the raw polyol A-6 except that the starting materials shown in Table 2 below were used. The number average molecular weight of the raw polyol A-7 was 2040.

TABLE 2

| | | Dicarboxylic | Ethylene | Ester | Number average |
|---|---|---|---|---|---|
| Raw polyol | Diol | acid | carbonate | group/carbonate | molecular |
| No. | (Parts by mass) | (Parts by mass) | Parts by mass | group (Molar ratio) | weight |
| A-6 | 1,3-propanediol | Adipic acid | 69.5 | 3/7 | 2030 |
| | (100.0) | (49.4) | | | |
| A-7 | 1,6-hexanediol | Sebacic acid | 19.2 | 7/3 | 2040 |
| | (100.0) | (102.8) | | | |

### 1-1-2. Preparation of Raw Isocyanates B-1 to B-3

Raw isocyanates shown in Table 3 below were prepared.

TABLE 3

| No. | Raw isocyanate |
|---|---|
| B-1 | Diphenylmethane diisocyanate (MDI) (Trade name: |
| | Millionate MT Manufactured by Tosoh Corporation) |
| B-2 | Polymethylene polyphenyl polyisocyanate |
| | (polymeric MDI) (Trade name: Millionate MR200 |
| | Manufactured by Tosoh Corporation) |
| B-3 | Isocyanurate trimer of hexamethylene diisocyanate |
| | (Trade name: Duranate TPA-100 Manufactured |
| | by Asahi Kasei Chemicals Corporation) |

### 1-1-3. Production of Hydroxyl-Terminated Urethane Prepolymers C-1 to C-3

### Synthesis of Hydroxyl-Terminated Urethane Prepolymer C-1

Under a nitrogen atmosphere, the materials shown in Table 4 below were heated and stirred at a temperature of 90° C. for 3 hours to cause a reaction. After that, 2-butanone (MEK) was added to the resulting reaction product to prepare a hydroxyl-terminated urethane prepolymer C-1 as a solution with a solid content of 50 parts by mass.

TABLE 4

| | Parts |
|---|---|
| Material | by mass |
| Raw polyol A-1 | 100 |
| (Trade name: Duranol T5652 Manufactured by | |
| Asahi Kasei Chemicals Corporation) | |
| Raw isocyanate B-1 | 6.3 |
| (Trade name: Millionate MT Manufactured by | |
| Tosoh Corporation) | |

### Synthesis of Hydroxyl-Terminated Urethane Prepolymers C-2 to C-5

Hydroxyl-terminated urethane prepolymers C-2 to C-5 were synthesized in the same manner as in the case of the synthesis of the hydroxyl-terminated urethane prepolymer C-1 except that the starting materials shown in Table 5 below were used.

The chemical structures of these hydroxyl-terminated urethane prepolymers C-1 to C-5 were identified using ¹H-NMR and ¹³C-NMR. It is to be noted that in Table 5, m, n, q, r, and s in structural formulae (1), (3), and (4) are the average numbers of moles added.

TABLE 5

| Hydroxyl-terminated | | | Raw | | | | | |
|---|---|---|---|---|---|---|---|---|
| urethane prepolymer | Raw polyol | | isocyanate | | | | | |
| No. | No. | Parts | No. | Parts | Structure contained in molecule | | | |
| C-1 | A-1 | 100 | B-1 | 6.3 | Structural | R11 = | R12 = | m, n = 6.9 |
| | | | | | formula (1) | (CH₂)₅ | (CH₂)₆ | |
| C-2 | A-2 | 100 | B-1 | 6.3 | Structural | R11 = | R12 = | m, n = 8.8 |
| | | | | | formula (1) | (CH₂)₃ | (CH₂)₄ | |
| C-3 | A-3 | 100 | B-1 | 6.3 | Structural | R41 = | | s = 13.2 |
| | | | | | formula (4) | (CH₂)₆ | | |
| C-4 | A-6 | 100 | B-1 | 6.3 | Structural | R31 = | R32 = | q = 12, |
| | | | | | formula (3) | (CH₂)₃ | (CH₂)₄ | r = 5.1 |
| C-5 | A-7 | 100 | B-1 | 6.3 | Structural | R31 = | R32 = | q = 2.7, |
| | | | | | formula (3) | (CH₂)₆ | (CH₂)₈ | r = 6.3 |

Regarding the hydroxyl group-terminated urethane prepolymers C-1 and C-2 containing the structure represented by structural formula (1) in the molecule, R13 in structural formula (1) was the same as R12.

In the table, with respect to the description of “x, y=A” such as m, n=6.9, it indicates that the average numbers of moles added of each of x and y is A. The same applies to the following tables. The term “parts” represents “parts by mass”.

### 1-1-4. Production of Isocyanate Group-Terminated Prepolymers D-1 to D-3 Synthesis of Isocyanate Group-Terminated Prepolymer D-1

Under a nitrogen atmosphere, the materials shown in Table 6 below were heated and stirred at a temperature of 90° C. for 3 hours to cause a reaction. After that, 2-butanone (MEK) was added to the resulting reaction product to prepare a solution with a solid content of 50 parts by mass, and an isocyanate group-terminated prepolymer D-1 was prepared.

TABLE 6

| | Parts |
|---|---|
| Material | by mass |
| Raw polyol A-4 | 100 |
| (Trade name: Nippolan 982 Manufactured by | |
| Tosoh Corporation) | |
| Raw polyisocyanate B-2 | 33.5 |
| (Trade name: Millionate MR200 Manufactured by | |
| Tosoh Corporation) | |

### Synthesis of Isocyanate Group-Terminated Prepolymers D-2 and D-3

Isocyanate group-terminated prepolymers D-2 and D-3 were prepared in the same manner as in the case of the synthesis of the isocyanate group-terminated prepolymer D-1 except that starting materials of the type and amount shown in Table 7 below were used.

The chemical structures of these isocyanate group-terminated prepolymers D-1 to D-3 were identified using ¹H-NMR and ¹³C-NMR. It is to be noted that in Table 7, m, n, o, p, and s in structural formulae (1), (2), and (4) are the average numbers of moles added. The term “parts” represents “parts by mass”.

TABLE 7

| Isocyanate | | | | | | | | |
|---|---|---|---|---|---|---|---|---|
| group- | | | | | | | | |
| terminated | | | Raw | | | | | |
| prepolymer | Raw polyol | | isocyanate | | | | | |
| No. | No. | Parts | No. | Parts | Structure contained in molecule | | | |
| D-1 | A-4 | 100 | B-2 | 33.5 | Structural formula (2) | o = 9.1, p = 5.5 | | |
| D-2 | A-5 | 100 | B-3 | 78.4 | Structural formula (1) | R11 = (CH₂)₆ | 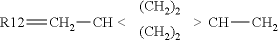 | m = 4.1, n = 1.4 |
| D-3 | A-3 | 100 | B-2 | 33.5 | Structural formula (4) | | R41 = (CH₂)₆ | s = 13.2 |

regarding the isocyanate group-terminated prepolymer D-2 containing the structure represented by structural formula (1) in the molecule, R13 in structural formula (1) was the same as at least one selected from the group consisting of R11 and R12.

### 1-2. Preparation of Conductive Layer Additive, and Production Example

### 1-2-1. Preparation of Polyoxyethylene Polyoxypropylene Alkyl Ethers E-1 and E-2, and Production Examples

### Preparation of Polyoxyethylene Polyoxypropylene Alkyl Ether

Commercial products were used for additives E-1 and E-2 which are polyoxyethylene polyoxypropylene alkyl ethers shown in Table 8 below.

### 1-2-2. Preparation of Polyoxyethylene Alkyl Ether Acetate, and Production Example

### Preparation of Polyoxyethylene Alkyl Ether Acetate

E-3, which is a polyoxyethylene alkyl ether acetate as an additive, shown in Table 8 below, was synthesized.

### Synthesis of Polyoxyethylene Alkyl Ether Acetate E-3.

First, 55.0 g of polyoxyethylene methyl ether (trade name: BLAUNON MP-550, manufactured by AOKI OIL INDUSTRIAL Co., Ltd., the average number of moles of ethylene oxide added is 12 mol with respect to alcohol) and 510 ml of a 1 mol/L aqueous sodium hydroxide solution were mixed, then 71.1 g of potassium permanganate was added, and stirred at room temperature for 6 hours. After that, 760 ml of 2-propanol was added and stirred for 1 hour to quench the excess potassium permanganate, and the by-product manganese oxide was filtered. The aqueous layer was extracted with dichloromethane and purified to yield E-3, which is polyoxyethylene methyl ether acetate. Table 8 shows the structure of R71 in E-3 and the value of x.

### 1-2-3. Preparation of Polyetheramine and Production

### Preparation of Polyetheramine

A commercial product was used for an additive E-4 which is a polyetheramine shown in Table 8 below.

TABLE 8

| No. | Additive | Structure | | |
|---|---|---|---|---|
| E-1 | Polyoxyethylene polyoxypropylene butyl ether | Structural formula (5) | R51 = C₄H₉ | t, u = 17 |
| | (Trade name: UNILUBE 50MB-26 | | | |
| | Manufactured by NOF CORPORATION) | | | |
| E-2 | Polyoxyethylene polyoxypropylene butyl ether | Structural formula (5) | R51 = C₄H₉ | t = 9, u = 10 |
| | (Trade name: UNILUBE 50MB-11 | | | |
| | Manufactured by NOF CORPORATION) | | | |
| E-3 | Polyoxyethylene methyl ether acetate | Structural formula (7) | R71 = CH₃ | x = 11 |
| E-4 | Polyetheramine | Structural formula (6) | R61 = CH₃ | v = 6, w = 29 |
| | (Trade name: JEFFAMINE M-2005 | | | |
| | Manufactured by Huntsman Corporation) | | | |

### 1-2-4. Preparation of Conductive Agent

### Preparation of Carbon Black

Carbon blacks M-1 and M-2, which are conductive agents shown in Table 9 below, were used as commercially available products.

TABLE 9
Conductive agent

| | | Primary | DBP | |
|---|---|---|---|---|
| | | particle | absorption | |
| Conductive | | diameter | amount | |
| agent No. | Material name | [nm] | [ml/100 g] | pH |
| M-1 | MA8 | 24 | 51 | 2.5 |
| | (Manufactured by Mitsubishi | | | |
| | Chemical Corporation) | | | |
| M-2 | MA14 | 40 | 73 | 3 |
| | (Manufactured by Mitsubishi | | | |
| | Chemical Corporation) | | | |

### 1-3. Production Examples of Conductive Layer-Forming Coating Liquid

### 1-3-1. Preparation of Conductive Layer-Forming Coating Liquid F-1

As the material for a conductive layer-forming coating liquid F-1, materials of the type and amount shown in Table 10 below were added to the inside of the reaction vessel and stirred. Next, 2-butanone (MEK) was added so that the total solid ratio is 30 mass %, and then mixed with a sand mill. Subsequently, 2-butanone (MEK) was added to adjust the viscosity of the liquid within the range of 6 to 10 mPa·s to prepare the conductive layer-forming coating liquid F-1.

TABLE 10

| | Parts |
|---|---|
| Material | by mass |
| Hydroxyl-terminated urethane prepolymer C-1 | 100 |
| Isocyanate group-terminated urethane prepolymer D-5 | 54.7 |
| Additive E-1 | 7 |
| Surface adjusting agent (Trade name: TSF4445, | 0.8 |
| Manufactured by Momentive Performance Materials, Inc.) | |
| Carbon black M-1 (Trade name: MA8, Manufactured | 35 |
| by Mitsubishi Chemical Corporation) | |
| Coarse particles (Trade name: ART PEARL C-400T, | 23 |
| Negami Chemical Industrial Co., Ltd.) | |

### 1-3-2. Preparation of Conductive Layer-Forming Coating Liquids F-2 to F-13

Conductive layer-forming coating liquids F-2 to F-13 were prepared by the following method. First, a hydroxyl-terminated urethane prepolymer, an isocyanate group-terminated prepolymer, an additive, a surface adjusting agent, a carbon black, and coarse particles shown in Table 11 below were mixed in the same manner as in the case of the preparation of the conductive layer-forming coating liquid F-1. Thereafter, 2-butanone (MEK) was added to adjust the viscosity of the liquid within the range of 6 to 10 mPa·s to prepare the conductive layer-forming coating liquids F-2 to F-13.

TABLE 11

| | | | Isocyanate group- | | | | Surface | | | |
|---|---|---|---|---|---|---|---|---|---|---|
| Conductive | Hydroxyl-terminated | | terminated urethane | | | | adjusting | | | Coarse |
| layer-forming | urethane prepolymer | | prepolymer | | Additive | | agent | Carbon black | | particles |
| coating liquid | | Parts | | Parts | | Parts | Parts | | Parts | Parts |
| No. | No. | by mass | No. | by mass | No. | by mass | by mass | No. | by mass | by mass |
| F-1 | C-1 | 100 | D-3 | 54.7 | E-1 | 7 | 0.8 | M-1 | 35 | 23 |
| F-2 | C-2 | 100 | D-3 | 54.7 | E-1 | 7 | 0.8 | M-1 | 35 | 23 |
| F-3 | C-3 | 100 | D-2 | 54.7 | E-1 | 7 | 0.8 | M-1 | 35 | 23 |
| F-4 | C-1 | 100 | D-1 | 54.7 | E-1 | 7 | 0.8 | M-1 | 35 | 23 |
| F-5 | C-2 | 100 | D-1 | 54.7 | E-1 | 7 | 0.8 | M-1 | 35 | 23 |
| F-6 | C-4 | 100 | D-3 | 54.7 | E-1 | 7 | 0.8 | M-1 | 35 | 23 |
| F-7 | C-5 | 100 | D-3 | 54.7 | E-1 | 7 | 0.8 | M-1 | 35 | 23 |
| F-8 | C-3 | 100 | D-1 | 54.7 | E-1 | 7 | 0.8 | M-1 | 35 | 23 |
| F-9 | C-1 | 100 | D-3 | 54.7 | E-1 | 6.6 | 0.8 | M-1 | 35 | 23 |
| F-10 | C-1 | 100 | D-3 | 54.7 | E-1 | 16.1 | 0.8 | M-1 | 35 | 23 |
| F-11 | C-1 | 100 | D-3 | 54.7 | E-2 | 7 | 0.8 | M-1 | 35 | 23 |
| F-12 | C-1 | 100 | D-3 | 54.7 | E-4 | 7 | 0.8 | M-1 | 35 | 23 |
| F-13 | C-1 | 100 | D-3 | 54.7 | E-3 | 7 | 0.8 | M-1 | 35 | 23 |

### 1-3-3. Preparation of Conductive Layer-Forming Coating Liquid F-14

Materials of the type and amount shown in Table 12 below were added to the inside of the reaction vessel and stirred. Next, 2-butanone (MEK) was added so that the total solid ratio is 30 mass %, and then mixed with a sand mill. Subsequently, 2-butanone (MEK) was added to adjust the viscosity of the liquid within the range of 6 to 10 mPa·s to prepare a conductive layer-forming coating liquid F-14.

TABLE 12

| | Parts |
|---|---|
| Material | by mass |
| Polytetramethylene ether glycol | 100 |
| (Trade name: PTMG2000, Manufactured by Mitsubishi | |
| Chemical Corporation) | |
| Isocyanate (Trade name: Millionate MR-200, | 20 |
| Manufactured by Tosoh Corporation) | |
| Surface adjusting agent (Trade name: TSF4445, | 1 |
| Manufactured by Momentive Performance Materials, Inc.) | |
| Carbon black M-2 (Trade name: MA14, Manufactured by | 30 |
| Mitsubishi Chemical Corporation) | |
| Coarse particles (Trade name: ART PEARL C-400, | 20 |
| Manufactured by Negami Chemical Industrial Co., Ltd.) | |

### 1-4. Production Example of Conductive Layer Roller

### 1-4-1. Preparation of Substrate

A substrate was prepared by coating a core metal made of stainless steel: SUS304 and having a diameter of 6 mm with a primer (trade name “DY35-051”; manufactured by Dow Toray Co., Ltd.), followed by baking.

### 1-4-2. Preparation of Elastic Layer

The substrate was placed in a mold, and an addition-type silicone rubber composition obtained by mixing the materials shown in Table 13 was injected into a cavity formed in the mold.

TABLE 13

| | Parts |
|---|---|
| Material | by mass |
| Liquid silicone rubber (Trade name: SE6724 A/B, | 100 |
| Manufactured by Dow Toray Co., Ltd.) | |
| Carbon black (Trade name: TOKABLACK #4300, | 16 |
| Manufactured by Tokai Carbon Co., Ltd.) | |
| Curing control agent (Trade name: 1-Ethynyl-1-cyclohexanol, | 0.01 |
| Manufactured by Tokyo Chemical Industry Co., Ltd.) | |
| Platinum catalyst (Trade name: SIP6830.3, | 0.01 |
| Manufactured by GELEST, Inc.) | |

Subsequently, the mold was heated to vulcanize and cure the silicone rubber at a temperature of 150° C. for 15 minutes, and the silicone rubber was demolded, and then further heated at a temperature of 180° C. for 1 hour to complete the curing reaction to obtain an elastic roller provided with an elastic layer with a diameter of 11.5 mm on the outer periphery of the substrate.

### 1-4-3. Production of Conductive Layer Roller G-1

The elastic roller was held at the upper end thereof with the longitudinal direction set to the vertical direction, and immersed (dipped) in the conductive layer-forming coating liquid F-1 to coat the surface of the elastic roller with the coating liquid. The resulting coated matter was air-dried at normal temperature for 30 minutes and then cured by drying in a hot air-circulating drier set at 160° C. for 1 hour. In this way, a conductive layer roller G-1 having a conductive layer with a film thickness of 12 μm formed on the elastic layer was obtained.

### 1-4-4. Production of Conductive Layer Rollers G-2 to G-14

Conductive layer rollers G-2 to G-14 were prepared in the same manner as in the production example of the conductive layer roller G-1 except that in the production example of the conductive layer roller G-1, the conductive layer-forming coating liquid F-1 was changed to F-2 to F-14 shown in Table 14 below.

TABLE 14

| Con- | Conduc- | | | | | | | | | | | | | |
|---|---|---|---|---|---|---|---|---|---|---|---|---|---|---|
| duc- | tive layer- | | | | | | | | | | | | | |
| tive | forming | | | | | | | | | | | | | |
| layer | coating | | | | | | | | | | | | | |
| roller | liquid | Binder resin structure | | | | | | | | | | | | |
| No. | No. | Structure 1 | | | | Structure 2 | | | | | | Additive structure | | |
| G-1 | F-1 | F.(1) | R11 = (CH₂)₅ | R12 = (CH₂)₆ | m,n = 6,9 | F.(4) | R41 = (CH₂)₆ | | | | s = 13.2 | F.(5) | R51 = C₄H₉ | t,u = 17 |
| G-2 | F-2 | F.(1) | R11 = (CH₂)₃ | R12 = (CH₂)₄ | m,n = 8.8 | F.(4) | R41 = (CH₂)₆ | | | | s = 13.2 | F.(5) | R51 = C₄H₉ | t,u = 17 |
| G-3 | F3 | F.(4) | R41 = (CH₂)₆ | | s = 13.2 | F.(1) | R11 = (CH₂)₆ | 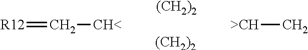 | | | m = 4.1, n = 1.4 | F.(5) | R51 = C₄H₉ | t,u = 17 |
| G-4 | F-4 | F.(1) | R11 = (CH₂)₅ | R12 = (CH₂)₆ | m,n = 6.9 | F.(2) | o = 9.1, p = 5.5 | | | | | F.(5) | R51 = C₄H₉ | t,u = 17 |
| G-5 | F-5 | F.(1) | R11 = (CH₂)₃ | R12 = (CH₂)₄ | m,n = 8.8 | F.(2) | o = 9.1, p = 5.5 | | | | | F.(5) | R51 = C₄H₉ | t,u = 17 |
| G-6 | F-6 | F.(3) | R31 = (CH₂)₃ | R32 = (CH₂)₄ | q = 12, r = 5.1 | F.(4) | R41 = (CH₂)₆ | | | | s = 13.2 | F.(5) | R51 = C₄H₉ | t,u = 17 |
| G-7 | F-7 | F.(3) | R31 = (CH₂)₆ | R32 = (CH₂)₈ | q = 2.7, r = 6.3 | F.(4) | R41 = (CH₂)₆ | | | | s = 13.2 | F.(5) | R51 = C₄H₉ | t,u = 17 |
| G-8 | F-8 | F.(4) | R41 = (CH₂)₆ | | s = 13.2 | F.(2) | o = 9.1, p = 5.5 | | | | | F.(5) | R51 = C₄H₉ | t,u = 17 |
| G-9 | F-9 | F.(1) | R11 = (CH₂)₅ | R12 = (CH₂)₆ | m,n = 6.9 | F.(4) | R41 = (CH2)₆ | | | | s = 13.2 | F.(5) | R51 = C₄H₉ | t,u = 17 |
| G-10 | F-10 | F.(1) | R11 = (CH₂)₅ | R12 = (CH₂)₆ | m,n = 6.9 | F.(4) | R41 = (CH₂)₆ | | | | s = 13.2 | F.(5) | R51 = C₄H₉ | t,u = 17 |
| G-11 | F-11 | F.(1) | R11 = (CH₂)₅ | R12 = (CH₂)₆ | m,n = 6.9 | F.(4) | R41 = (CH₂)₆ | | | | s = 13.2 | F.(5) | R51 = C₄H₉ | t = 9, u = 10 |
| G-12 | F-12 | F.(1) | R11 = (CH₂)₅ | R12 = (CH₂)₆ | m,n = 6.9 | F.(4) | R41 = (CH₂)₆ | | | | s = 13.2 | F.(6) | R61 = CH₃ | v = 6, w = 29 |
| G-13 | F-13 | F.(1) | R11 = (CH₂)₅ | R12 = (CH₂)₆ | m,n = 6.9 | F.(4) | R41 = (CH₂)₆ | | | | s = 13.2 | F.(7) | R71 = CH₃ | x = 11 |
| G-14 | F-14 | — | — | — | — | — | — | — | — | — | — | — | — | — |

In Table 14, “F.” represents “Formula”.

### 1-5. Preparation of Insulating Portion-Forming Material, and Production Examples

### 1-5-1. Production of Insulating Portion-Forming Materials I-1 to I-5

### Preparation of Raw Material Monomers

Commercial products were used for H-1 and H-2, which are 2 types of raw material monomers shown in Table 15 below.

TABLE 15

| No. | Material name |
|---|---|
| H-1 | 2,2-bis(4-hydroxyphenyl)propane |
| | (Trade name: manufactured by Tokyo Chemical |
| | Industry Co., Ltd., Product code B0494) |
| H-2 | 2,2-bis(3-methyl-4-hydroxyphenyl)propane |
| | (Trade name: manufactured by Tokyo Chemical |
| | Industry Co., Ltd., Product code B1567) |

### Synthesis of Insulating Portion-Forming Material I-1

In 1100 ml of a 5 mass % aqueous sodium hydroxide solution, 42.5 g of 2,2-bis(4-hydroxyphenyl)propane (manufactured by Tokyo Chemical Industry Co., Ltd., product code B0494), 37.5 g of 2,2-bis(3-methyl-4-hydroxyphenyl)propane (manufactured by Tokyo Chemical Industry Co., Ltd., product code B1567), and 0.1 g of hydrosulfite were dissolved. To this mixture, 500 ml of methylene chloride was added and stirred, and 60 g phosgene was then blown thereinto in 60 minutes while the mixture was kept at 15° C.

After the blowing of the phosgene ended, 1.3 g of p-t-butylphenol (hereinafter, abbreviated as “PTBP”; manufactured by Tokyo Chemical Industry Co., Ltd., product code: B0383) was added thereto as a molecular weight modifier and was stirred to emulsify the reaction liquid. After emulsifying, 0.4 ml of triethylamine was added thereto and was stirred at 23° C. for 1 hour to cause polymerization.

After completion of the polymerization, the reaction liquid was separated into an aqueous phase and an organic phase, the organic phase was neutralized with phosphoric acid, and washing with water was repeated until the conductivity of the washing liquid (aqueous phase) reached 10 μS/cm or less. The obtained polymer solution was added dropwise to warm water kept at 45° C., and the solvent was removed by evaporation to obtain a white powder precipitate. The obtained precipitate was filtered and dried at 110° C. for 24 hours to obtain an insulating portion-forming material I-1.

### Measurement of Weight-Average Molecular Weight of Insulating Portion-Forming Material I-1

The apparatus used to measure the weight-average molecular weight (Mw) of the insulating portion-forming material in the present production example, and conditions are as follows.

First, a sample is dissolved in tetrahydrofuran (THF) at room temperature for 24 hours. Then, the obtained solution is filtered through a solvent-resistant membrane filter “Mysyori Disc” (manufactured by Tosoh Corporation) with a pore size of 0.5 μm, thereby obtaining a sample solution. Note that the sample solution is prepared to have a concentration of 0.5 mass %. This sample solution is measured under the following conditions:
Apparatus: HLC-8320GPC (detector: RI) (manufactured by Tosoh Corporation)
Column: Two Shodex LF-404 and LF-404 (manufactured by Showa Denko K.K.)
Eluent: Tetrahydrofuran (THF)
Flow rate: 0.4 ml/min
Oven temperature: 40.0° C.
Sample injection amount: 0.10 ml

To calculate the molecular weight of the sample, a molecular weight calibration curve created using a standard polystyrene resin (for example, a trade name “EasiVial PS-H polystyrene”; manufactured by Agilent Technology) is used.

The molecular weight of the insulating portion-forming material I-1 was measured and found to be Mw=56000.

### 1-5-2. Preparation of Insulating Portion-Forming Material I-2, and Production

A commercial product was used for an acrylate monomer shown in Table 16 below.

TABLE 16

| Insulating portion- | |
|---|---|
| forming material No. | Material name |
| I-2 | Pentaerythritol tetraacrylate |
| | (Trade name: A-TMMT Manufactured by |
| | Shin-Nakamura Chemical Co., Ltd.) |

### 1-6. Production Examples of Insulating Portion-Forming Coating Liquids

### 1-6-1. Preparation of Insulating Portion-Forming Coating Liquid J-1

The insulating portion-forming material I-1 in an amount of 100 parts by mass was weighed, MEK was added so that the concentration was 2.0 mass %, and the material was dissolved well to prepare an insulating portion-forming coating liquid J-1.

### 1-6-2. Preparation of Insulating Portion-Forming Coating Liquids J-2 and J-3

Insulating portion-forming coating liquids J-2 and J-3 were prepared in the same manner as the insulating portion-forming coating liquid J-1 except that in the preparation of the insulating portion-forming coating liquid J-1, the insulating portion-forming material was changed to the materials and concentrations shown in Table 17 below.

### 1-6-3. Preparation of Insulating Portion-Forming Coating Liquid J-4

The insulating portion-forming material I-2 in an amount of 100 parts by mass was weighed, then 5.0 parts by mass of a photopolymerization initiator (trade name: Omnirad184, manufactured by IGM Resins Co., Ltd.) was weighed, MEK was added so that the concentration was 2.0 mass %, and the contents were dissolved well to prepare an insulating portion-forming coating liquid J-4.

TABLE 17

| Insulating | Insulating portion- | | Photopolymerization | | |
|---|---|---|---|---|---|
| portion- | forming material | | initiator | | Concen- |
| forming coating | | Parts | Material | Parts | tration |
| liquid No. | No. | by mass | name | by mass | Mass % |
| J-1 | I-1 | 100 | — | — | 2.0 |
| J-2 | I-1 | 100 | — | — | 1.0 |
| J-3 | I-1 | 100 | — | — | 7.0 |
| J-4 | I-2 | 100 | Omnirad184 | 5.0 | 2.0 |

### 1-7. Production Examples of Developing Rollers and Comparative Developing Rollers

### 1-7-1. Production Example of Developing Roller K-1

The conductive layer roller G-1 was held at the upper end thereof with the longitudinal direction set to the vertical direction, and immersed (dipped) in the insulating portion-forming coating liquid J-1 to coat the surface of the conductive layer roller G-1 with the coating liquid. The resulting coated matter was air-dried at normal temperature for 30 minutes and then dried in a hot air-circulating drier set at 90° C. for 1 hour. In this way, the developing roller K-1 in which the insulating portion was formed on the conductive layer was obtained. The physical properties of the developing roller K-1 are shown in Table 16-1 and Table 16-2.

### 1-7-2. Production Examples of Developing Rollers K-2 to K-15

Developing rollers K-2 to K-15 were obtained in the same manner as the developing roller K-1 except that in the production example of the developing roller K-1, the conductive layer roller and the insulating portion-forming coating liquid were changed to those shown in Table 18-1 below. The physical properties of the developing rollers K-2 to K-15 are shown in Tables 18-1 and 18-2.

### 1-7-3. Production Example of Developing Roller K-16

The conductive layer roller G-14 was held at the upper end thereof with the longitudinal direction set to the vertical direction, and immersed (dipped) in the insulating portion-forming coating liquid J-4 to coat the surface of the conductive layer roller G-14 with the coating liquid. The resulting coated matter was air-dried at normal temperature for 30 minutes and then dried in a hot air-circulating drier set at 90° C. for 1 hour to obtain a conductive layer roller G-14 to which a mixture of the insulating portion-forming material and the photopolymerization initiator was attached.

Thereafter, the outer surface of the conductive layer roller G-14 was irradiated with ultraviolet rays such that the cumulative light amount became 2000 mJ/cm² to cure the insulating portion-forming material. In this way, the developing roller K-16 in which the insulating portion was formed on the conductive layer was obtained. A high-pressure mercury lamp (trade name: handy-type UV curing apparatus, manufactured by Marionetwork) was used as the ultraviolet irradiation apparatus. The physical properties of the developing roller K-16 are shown in Table 18-1, and Table 18-2.

TABLE 18-1

| | | | Physical properties of conductive layer | | | | | | |
|---|---|---|---|---|---|---|---|---|---|
| | | | Physical | | | | | | Dispersion state |
| Developing | Insulating | | properties of | | | | | | of carbon black |
| roller/ | portion- | | carbon black | | | Minimum | Surface | | Dispersion circle- |
| comparative | forming | Conductive | Primary | DBP | | value | potential | | equivalent diameter |
| developing | coating | layer | particle | absorption | | of | V_{[N]} − | | Mean |
| roller | liquid | roller | diameter | amount | | impedance | V₁ | τ₂ | Rc |
| No. | No. | No. | [nm] | [ml/100 g] | pH | [Ω] | [V] | [Sec] | [nm] |
| K-1 | J-1 | G-1 | 24 | 51 | 2.5 | 9.1E+06 | 5.7 | 2.6 | 55.2 |
| K-2 | J-1 | G-2 | 24 | 51 | 2.5 | 8.7E+06 | 12.5 | 4.1 | 55.9 |
| K-3 | J-1 | G-3 | 24 | 51 | 2.5 | 7.4E+06 | 14.2 | 4.6 | 52.1 |
| K-4 | J-1 | G-4 | 24 | 51 | 2.5 | 2.8E+06 | 3.2 | 1.8 | 54.3 |
| K-5 | J-1 | G-5 | 24 | 51 | 2.5 | 1.5E+06 | 3.2 | 1.5 | 59.2 |
| K-6 | J-1 | G-6 | 24 | 51 | 2.5 | 2.1E+06 | 3.5 | 1.6 | 58.0 |
| K-7 | J-1 | G-7 | 24 | 51 | 2.5 | 2.0E+06 | 3.8 | 1.6 | 59.1 |
| K-8 | J-1 | G-8 | 24 | 51 | 2.5 | 2.4E+06 | 3.2 | 1.9 | 58.2 |
| K-9 | J-1 | G-9 | 24 | 51 | 2.5 | 8.6E+06 | 4.5 | 1.9 | 57.4 |
| K-10 | J-1 | G-10 | 24 | 51 | 2.5 | 6.6E+06 | 7.2 | 1.8 | 56.1 |
| K-11 | J-1 | G-11 | 24 | 51 | 2.5 | 7.7E+06 | 6.4 | 1.8 | 57.0 |
| K-12 | J-1 | G-12 | 24 | 51 | 2.5 | 6.3E+06 | 5.1 | 1.6 | 55.0 |
| K-13 | J-1 | G-13 | 24 | 51 | 2.5 | 2.2E+06 | 3.8 | 1.5 | 58.9 |
| K-14 | J-2 | G-1 | 24 | 51 | 2.5 | 9.1E+06 | 5.7 | 2.5 | 55.2 |
| K-15 | J-3 | G-1 | 24 | 51 | 2.5 | 9.1E+06 | 5.7 | 2.6 | 55.2 |
| K-16 | J-4 | G-14 | 40 | 73 | 3 | 1.4E+04 | 1.9 | 0.6 | 120.1 |
| L-1 | — | G-14 | 40 | 73 | 3 | 1.4E+04 | 1.9 | 0.6 | 120.1 |

| | | | Physical properties of conductive layer | | | | | |
|---|---|---|---|---|---|---|---|---|
| | | | Dispersion state of carbon black | | | | | |
| Developing | Insulating | | Dispersion circle- | | Inter-wall | | | |
| roller/ | portion- | | equivalent diameter | | distance | | | |
| comparative | forming | Conductive | Standard | | | Standard | | |
| developing | coating | layer | deviation | | Mean | deviation | | Work |
| roller | liquid | roller | σc | | d | σd | | function |
| No. | No. | No. | [nm] | σc/Rc | [nm] | [nm] | σd/d | [eV] |
| K-1 | J-1 | G-1 | 33.1 | 0.600 | 111.6 | 64.1 | 186.112 | 4.6 |
| K-2 | J-1 | G-2 | 32.9 | 0.589 | 108.9 | 62.1 | 185.031 | 4.6 |
| K-3 | J-1 | G-3 | 31.1 | 0.597 | 102.3 | 57.2 | 171.377 | 4.6 |
| K-4 | J-1 | G-4 | 31.8 | 0.586 | 100.7 | 56.9 | 171.950 | 4.6 |
| K-5 | J-1 | G-5 | 38.0 | 0.642 | 103.8 | 57.2 | 161.709 | 4.6 |
| K-6 | J-1 | G-6 | 34.7 | 0.598 | 106.5 | 60.9 | 178.012 | 4.6 |
| K-7 | J-1 | G-7 | 34.9 | 0.591 | 104.9 | 61.1 | 177.639 | 4.6 |
| K-8 | J-1 | G-8 | 35.3 | 0.607 | 105.8 | 60.9 | 174.435 | 4.6 |
| K-9 | J-1 | G-9 | 34.5 | 0.601 | 99.8 | 56.6 | 166.044 | 4.6 |
| K-10 | J-1 | G-10 | 34.2 | 0.610 | 101.2 | 57.0 | 166.004 | 4.6 |
| K-11 | J-1 | G-11 | 34.9 | 0.612 | 98.7 | 56.7 | 161.201 | 4.6 |
| K-12 | J-1 | G-12 | 32.0 | 0.582 | 102.3 | 57.4 | 175.828 | 4.6 |
| K-13 | J-1 | G-13 | 37.0 | 0.628 | 143.5 | 83.2 | 228.436 | 4.6 |
| K-14 | J-2 | G-1 | 33.1 | 0.600 | 111.6 | 64.1 | 186.112 | 4.6 |
| K-15 | J-3 | G-1 | 33.1 | 0.600 | 111.6 | 64.1 | 186.112 | 4.6 |
| K-16 | J-4 | G-14 | 89.2 | 0.743 | 121.1 | 99.8 | 163.051 | 4.6 |
| L-1 | — | G-14 | 89.2 | 0.743 | 121.1 | 99.8 | 163.051 | 4.6 |

In the table, for example, 9.1E+06 indicates 9.1×10⁶. The same applies to the other tables below. Regarding the impedance measurement of the developing rollers K-1 to K-16 and the comparative developing roller L-1, the minimum value of the impedance indicates the minimum value of the value of the impedance at the frequency of 1.0×10⁰ Hz to 1.0×10¹ Hz.

TABLE 18-2

| Developing | Insulating | | Physical properties of insulating portion | | | | |
|---|---|---|---|---|---|---|---|
| roller/ | portion- | | Proportion of | Volume | | | |
| comparative | forming | Conductive | total area of | resistivity of | Surface | | |
| developing | coating | layer | insulating | insulating | potential | | Work |
| roller | liquid | roller | portion | portion | V₁ | τ₁ | function |
| No. | No. | No. | [%] | [Ω · cm] | [V] | [Sec] | [eV] |
| K-1 | J-1 | G-1 | 30 | 2.8E+14 | 15.2 | 2971.6 | 4.6 |
| K-2 | J-1 | G-2 | 31 | 2.8E+14 | 14.6 | 2895.6 | 4.6 |
| K-3 | J-1 | G-3 | 30 | 2.8E+14 | 14.7 | 2812.2 | 4.6 |
| K-4 | J-1 | G-4 | 30 | 2.8E+14 | 15.0 | 2787.3 | 4.6 |
| K-5 | J-1 | G-5 | 30 | 2.8E+14 | 14.7 | 3047.9 | 4.6 |
| K-6 | J-1 | G-6 | 30 | 2.8E+14 | 15.4 | 3202.1 | 4.6 |
| K-7 | J-1 | G-7 | 30 | 2.8E+14 | 14.9 | 3129.8 | 4.6 |
| K-8 | J-1 | G-8 | 30 | 2.8E+14 | 15.2 | 3095.8 | 4.6 |
| K-9 | J-1 | G-9 | 29 | 2.8E+14 | 15.1 | 2888.1 | 4.6 |
| K-10 | J-1 | G-10 | 30 | 2.8E+14 | 14.9 | 3136.3 | 4.6 |
| K-11 | J-1 | G-11 | 30 | 2.8E+14 | 14.9 | 2922.2 | 4.6 |
| K-12 | J-1 | G-12 | 30 | 2.8E+14 | 14.7 | 2796.4 | 4.6 |
| K-13 | J-1 | G-13 | 30 | 2.8E+14 | 15.0 | 2917.4 | 4.6 |
| K-14 | J-2 | G-1 | 15 | 2.8E+14 | 6.8 | 2782.0 | 4.6 |
| K-15 | J-3 | G-1 | 49 | 2.8E+14 | 30.1 | 2922.5 | 4.6 |
| K-16 | J-4 | G-14 | 30 | 7.9E+13 | 10.9 | 101.9 | 4.6 |
| L-1 | — | G-14 | 0 | — | — | — | 4.7 |

### 1-7-4. Production Example of Comparative Developing Roller L-1

The conductive layer roller G-14 was a comparative developing roller L-1. The physical properties of the comparative developing roller L-1 are also shown in Table 18-1 and Table 18-2. In the measurement of the surface potential of the comparative developing roller L-1, the value of V_{INI} was set to the value of the surface potential of the conductive layer of the comparative developing roller L-1 because the surface potential after 30.00 seconds to 100.00 seconds was 0 V.

### 2. PRODUCTION EXAMPLE OF TONER

### 2-1. Production Example of Toner Particle

### 2-1-1. Production Example of Toner Particle P-1

### Production of Charge Control Resin 1

Into a pressure-capable reaction vessel equipped with a reflux condenser, a stirrer, a thermometer, a nitrogen introduction tube, a dropping device, and a decompression device, 250 parts of methanol, 150 parts of 2-butanone, and 100 parts of 2-propanol were added as solvents, and 83 parts of styrene, 12 parts of butyl acrylate, and 5 parts of 2-acrylamido-2-methylpropanesulfonic acid were added as monomers, followed by heating to the reflux temperature while stirring.

Then, a solution obtained by diluting 0.45 parts of t-butyl peroxy-2-ethylhexanoate, which is a polymerization initiator, with 20 parts of 2-butanone was added dropwise over 30 minutes, and stirring was continued for 5 hours. Subsequently, a solution obtained by diluting 0.28 parts of t-butyl peroxy-2-ethylhexanoate with 20 parts of 2-butanone was added dropwise over 30 minutes, and stirring was further continued for 5 hours to complete the polymerization.

The polymer obtained after removing the polymerization solvent by vacuum distillation was coarsely pulverized to 100 μm or less using a cutter mill equipped with a 150-mesh screen, thereby obtaining Charge Control Resin 1. The glass transition temperature (Tg) of the obtained polymer was approximately 70° C.

### Production of Toner Particle

Into a four-necked vessel, 710 parts of ion exchanged water and 850 parts of a 0.1 mol/L aqueous solution of Na₃PO₄ were added, and the mixture was maintained at 60° C. while stirring at 200 s⁻¹ using a high-speed stirrer T.K. Homomixer (manufactured by Tokushu Kika Kogyo Kabushiki Kaisha). Then, 68 parts of a 1.0 mol/L aqueous solution of CaCl₂ was gradually added thereto to prepare an aqueous dispersion medium containing a dispersion stabilizer.
Styrene: 125 parts
n-butyl acrylate: 35 parts
Copper phthalocyanine pigment (Pigment Blue 15:3): 12 parts
Polyester resin (copolymer of terephthalic acid and propylene oxide-modified bisphenol A (2 mol adduct); acid value: 10 mgKOH/g; glass transition temperature (Tg): 70° C.; weight-average molecular weight (Mw): 10,500): 10 parts
Charge control resin 1: 1.85 parts
Fischer-Tropsch wax (melting point: 78° C.): 15 parts

The above materials were stirred for 3 hours using an attritor (manufactured by NIPPON COKE & ENGINEERING CO., LTD.) to disperse each component in the polymerizable monomers, thereby preparing a monomer mixture.

To the monomer mixture, 20.0 parts of 1,1,3,3-tetramethylbutyl peroxy-2-ethylhexanoate (50% toluene solution), which is a polymerization initiator, was added to prepare a polymerizable monomer composition.

The polymerizable monomer composition was introduced into the aqueous dispersion medium and granulated for 5 minutes while maintaining the rotation speed of the stirrer at 167 s⁻¹. Thereafter, the high-speed stirrer was replaced with a propeller-type stirrer, the internal temperature was raised to 75° C., and the mixture was reacted for 6 hours with gentle stirring.

Next, the temperature inside of the vessel was raised to 85° C. and maintained for 5 hours, followed by cooling to obtain a slurry. Dilute hydrochloric acid was added to the vessel containing the slurry to remove the dispersion stabilizer. Furthermore, filtration, washing, drying, and classification were performed to obtain a toner particle P-1.

### 2-1-2. Production Example of Toner Particle P-2

### Production Example of Resin Fine Particle Dispersion 1

Styrene: 350 parts
n-butyl acrylate: 75 parts
Acrylic acid: 10 parts
Dodecanethiol: 10 parts

420 parts of the solution prepared by mixing the above materials, 6 parts of a nonionic surfactant (Nonipol 400, manufactured by SANYO CHEMICAL INDUSTRIES, LTD.), and 10 parts of an anionic surfactant (Neogen R, manufactured by DKS CO. Ltd.) were placed into a flask together with a solution in which these surfactants were dissolved in 550 parts of ion exchanged water, followed by dispersion and emulsification. While stirring and mixing gently for 10 minutes, 50 parts of ion exchanged water in which 4 parts of ammonium persulfate had been dissolved was added. Thereafter, the inside of the flask was sufficiently purged with nitrogen, and the mixture was heated in an oil bath under stirring until the internal temperature reached 70° C., followed by continuing the emulsion polymerization for 5 hours to obtain resin fine particle dispersion 1.

The resin fine particles in the resin fine particle dispersion 1 had a volume average particle diameter (D50) of 155 nm as measured using a laser diffraction particle size distribution analyzer (model LA-700, manufactured by HORIBA, Ltd.). In addition, the glass transition temperature of the resin was measured to be 54° C. using a differential scanning calorimeter (model DSC-50, manufactured by Shimadzu Corporation) at a ramp rate of 10° C./min. The weight-average molecular weight (in terms of polystyrene) was measured to be 33,000 using a molecular weight analyzer (model HLC-8020, manufactured by Tosoh Corporation) with THE as the solvent.

### Production Example of Resin Fine Particle Dispersion 2

Styrene: 400 parts
n-butyl acrylate: 100 parts
Acrylic acid: 4 parts
n-dodecyl mercaptans: 6 parts

A monomer solution was prepared by mixing the above components, and the monomer solution and a surfactant aqueous solution prepared by dissolving 10 g of an anionic surfactant Neogen RK (manufactured by DKS CO. Ltd.) in 1,130 g of ion exchanged water were introduced into a two-necked flask and emulsified by stirring at a rotation speed of 10,000 r/min using a homogenizer (Ultra-Turrax T50, manufactured by IKA). Thereafter, the inside of the flask was purged with nitrogen, and the contents were heated in a water bath under gentle stirring until the temperature reached 70° C., followed by addition of 350 parts of ion exchanged water in which 6.56 g of ammonium persulfate had been dissolved to initiate polymerization. After the reaction was continued for 7 hours, the reaction solution was cooled to room temperature to obtain resin fine particle dispersion 2.

The resin fine particles in the resin fine particle dispersion 2 had a volume average particle diameter (D50) of 180 nm as measured using a laser diffraction particle size distribution analyzer (model LA-700, manufactured by HORIBA, Ltd.). The glass transition temperature of the resin was measured to be 65° C. using a differential scanning calorimeter (model DSC-50, manufactured by Shimadzu Corporation) at a ramp rate of 10° C./min. The weight-average molecular weight (in terms of polystyrene) was measured to be 26,000 using a molecular weight analyzer (model HLC-8020, manufactured by Tosoh Corporation) with THE as the solvent.

### Production of Colorant Fine Particle Dispersion

Cyan pigment (Pigment Blue 15:3, manufactured by Dainichiseika Color & Chemicals Mfg. Co., Ltd.): 100.0 parts
Anionic surfactant (Neogen RK, manufactured by DKS CO. Ltd.): 15.0 parts
Ion exchanged water: 885.0 parts

The above materials were mixed and dissolved, and dispersed for about 1 hour using a high-pressure impact disperser Nanomizer (manufactured by YOSHIDA KIKAI CO., LTD.) to prepare a colorant fine particle dispersion (solid content concentration: 10 mass %) in which the colorant was dispersed. The volume-based median diameter of the colorant fine particles was 0.2 μm.

### Production of Wax Fine Particle Dispersion

Ester waxes (behenyl behenate, melting point 75° C.): 100.0 parts
Anionic surfactant (Neogen RK, manufactured by DKS CO. Ltd.): 10.0 parts
Ion exchanged water: 880.0 parts

After the above components were placed into a container equipped with a stirring device and heated to 90° C., dispersion treatment was performed for 60 minutes under circulation using the CREAMIX W MOTION (manufactured by M. Technique Co., Ltd.) at a shearing and stirring section having a rotor outer diameter of 3 cm and a clearance of 0.3 mm, with a rotor rotation speed of 310 s⁻¹ and a screen rotation speed of 310 s⁻¹. Thereafter, the mixture was cooled to 40° C. under a cooling condition of a rotor rotation speed of 33.3 s⁻¹, a screen rotation speed of 33.3 s⁻¹, and a cooling rate of 10° C./min, thereby obtaining a wax fine particle dispersion (solid concentration: 10 mass %). The volume-based median diameter of the wax fine particles was 0.15 μm.

### Formation of Toner Particle

Resin fine particle dispersion 1: 45.0 parts
Colorant fine particle dispersion: 10.0 parts
Wax fine particle dispersion: 15.0 parts
1 mass % calcium chloride aqueous solution: 20.0 parts
Ion exchanged water: 110.0 parts

After mixing and dispersing the above materials using a homogenizer (Ultra-Turrax T50, manufactured by IKA), the mixture was heated in a water bath to 45° C. while stirring with stirring blades. The temperature was maintained at 45° C. for 1 hour to obtain an aqueous dispersion containing aggregated particles (aggregation process). The volume-average particle diameter (Dv) of the aggregated particles was measured to be 5.7 μm.

After adding 40.0 parts of a 5 mass % aqueous solution of trisodium citrate to the aqueous dispersion, the temperature was raised to 85° C. while stirring was continued, and the mixture was held at that temperature for 120 minutes to obtain an aqueous dispersion containing fused core particles (primary fusion process). The volume-average particle diameter (Dv) of the core particles was measured to be 6.4 μm.

Subsequently, while continuing stirring, water was added to the water bath, and the aqueous dispersion of the core particles was cooled to 25° C.

Subsequently, 12.1 parts of the resin fine particle dispersion 2 was added. Subsequently, stirring was performed for 10 minutes, and then 60.0 parts of a 2 mass % calcium chloride aqueous solution was added dropwise, followed by heating to 35° C. In this state, a small amount of the solution was extracted as needed, passed through a 2 μm microfilter, and stirring was continued at 35° C. until the filtrate became transparent.

After confirming that the filtrate became transparent and that the resin fine particles adhered to the core particles to form a shell-adhered body, the aqueous dispersion of the shell-adhered body was heated to 40° C. and stirred for 1 hour, followed by the addition of 35.0 parts of a 5 mass % trisodium citrate aqueous solution, and stirred for 3.0 hours while heating to 65° C. (secondary fusion process).

Subsequently, the obtained solution was cooled to 25° C., followed by filtration and solid-liquid separation, after which 800 parts of ion exchanged water was added to the solid content and stirred for 30 minutes for washing. Thereafter, filtration and solid-liquid separation were performed again.

As described above, filtration and washing were repeated until the electrical conductivity of the filtrate became 150 S/cm or less in order to eliminate the influence of residual surfactant, and the obtained solid content was dried and classified to obtain toner particles P-2.

### 2-1-3. Production Example of Toner Particle P-3

The toner particle P-3 was obtained in the same manner as the toner particle P-2, except that the retention time at 85° C. in the primary fusion process for forming the toner particle was changed to 60 minutes.

### 2-1-4. Production Example of Toner Particle P-4

6 parts of cyan pigment

(Pigment Blue 15:3, manufactured by Dainichiseika Color & Chemicals Mfg. Co., Ltd.)
Styrene-butyl acrylate-maleic acid butyl half-ester copolymer

(Glass transition point Tg=63° C.) 100 parts
Iron complex of monoazo dye (negative-charging performance charge control agent) 2 parts
Low molecular weight polyethylene

(DSC endothermic peak: 106.7° C., Mw/Mn=1.08) 4 parts

The above materials were mixed using a blender, then melt-kneaded with a twin-screw extruder heated to 110° C., after which the kneaded mixture was cooled, coarsely pulverized with a hammer mill, finely pulverized with a mechanical pulverizer, and classified to obtain toner particles P-4.

### 2-2. Production Example of Fine Particles

### 2-2-1. Preparation of Fine Particles Q-1 to Q-8

Commercial products were used for fine particles Q-1 to Q-8. In addition, the conductivity of the fine particles is also shown in Table 19 below.

TABLE 19

| Fine particle/ | | | | | |
|---|---|---|---|---|---|
| external | | Metal | Particle | Conductivity | Work |
| additive | | element | diameter | @1.0 × 10⁻² Hz | function |
| No. | Material | contained | [nm] | [S/m] | [eV] |
| Q-1 | Aluminum oxide TM-DA | Al | 120 | 8.2.E−07 | 4.4 |
| | (Manufactured by TAIMEI | | | | |
| | CHEMICALS Co., Ltd.) | | | | |
| Q-2 | Titanium oxide MT-500B | Ti | 35 | 2.5.E−08 | 5.2 |
| | (Manufactured by TAYCA Co., Ltd.) | | | | |
| Q-3 | Conductive titanium oxide EC-300E | Ti | 300 | 1.7.E+01 | 4.8 |
| | (Manufactured by Titan Kogyo, Ltd) | | | | |
| Q-4 | Fine zinc oxide | Zn | 280 | 2.0.E−09 | 4.5 |
| | (manufactured by SAKAI | | | | |
| | CHEMICAL INDUSTRY CO., LTD.) | | | | |
| Q-5 | Strontium titanate SW-100 | Ti | 80 | 2.6.E−06 | 4.7 |
| | (Manufactured by Titan Kogyo, Ltd) | | | | |
| Q-6 | Aluminum oxide Alu C | Al | 13 | 6.7.E−08 | 4.4 |
| | (manufactured by Nippon | | | | |
| | Aerosil Co., Ltd.) | | | | |
| Q-7 | Aluminum oxide AKP-50 | Al | 200 | 1.6.E−07 | 4.4 |
| | (manufactured by Sumitomo | | | | |
| | Chemical Co., Ltd.) | | | | |
| Q-8 | Aluminum oxide AA-04 | Al | 500 | 1.6.E−07 | 4.4 |
| | (manufactured by Sumitomo | | | | |
| | Chemical Co., Ltd.) | | | | |
| Q-9 | Zirconium phosphate | Zr | 22 | 2.1.E−02 | 5.1 |
| Q-10 | Titanium phosphate | Ti | 30 | 5.0.E−05 | 5.1 |
| R-1 | Fumed silica RY200S | (Si) | 15 | 8.3.E−16 | 5.6 |
| | (manufactured by Nippon | | | | |
| | Aerosil Co., Ltd.) | | | | |

In the table, the particle size indicates the number-average particle diameter of the primary particles of the fine particles.

### 2-2-2. Production Example of Fine Particle Q-9

Ion exchanged water: 100.0 parts
Sodium phosphate (12 hydrate): 8.5 parts
After mixing the above materials, 60.0 parts of zirconium ammonium lactate (ZC-300, manufactured by Matsumoto Fine Chemical Co., Ltd.), corresponding to 7.2 parts as zirconium ammonium lactate, were added at room temperature while stirring at 10,000 rpm using a T.K. Homomixer (manufactured by Tokushu Kika Kogyo Kabushiki Kaisha). 1 mol/L hydrochloric acid was added to adjust the pH to 7.0. The temperature was adjusted to 75° C., and the reaction was carried out for 1 hour while maintaining stirring.

Thereafter, the solid content was collected by centrifugal separation. Subsequently, the process of redispersing in ion exchanged water and collecting the solid content by centrifugal separation was repeated three times to remove ions such as sodium. The mixture was again dispersed in ion exchanged water and dried by spray drying to obtain zirconium phosphate fine particles Q-9 having a number-average particle diameter of 22 nm. The conductivity of Q-9 is also shown in Table 19.

### 2-2-3. Production Example of Fine Particle Q-10

ion exchanged water: 100.0 parts
Sodium phosphate (12 hydrate): 8.5 parts

After mixing the above materials, 17.5 parts of ammonium titanium lactate (TC-300, Matsumoto Fine Chemical Co., Ltd.) (corresponding to 7.2 parts as ammonium titanium lactate) were added while stirring at 10,000 rpm at room temperature using a T.K. Homomixer (manufactured by Tokushu Kika Kogyo Kabushiki Kaisha). 1 mol/L hydrochloric acid was added to adjust the pH to 7.0. The temperature was adjusted to 75° C., and the reaction was carried out for 1 hour while maintaining stirring.

Thereafter, the solid content was collected by centrifugal separation. Subsequently, the process of redispersing in ion exchanged water and collecting the solid content by centrifugal separation was repeated three times to remove ions such as sodium. The particles were dispersed again in ion exchanged water and dried by spray drying to obtain titanium phosphate fine particles Q-10 having a number average particle diameter of 22 nm. The conductivity of Q-10 is also shown in Table 19 below.

### 2-2-4. Preparation of External Additive R-1

Commercially available fumed silica (RY200S, manufactured by Nippon Aerosil Co., Ltd.) was used as the external additive R-1. The conductivity of the external additive R-1 is also shown in Table 19.

### 2-3. Production Example of Toner

### 2-3-1. Production of Toner S-1

Toner particles P-1: 100 parts
Fine particles Q-1: 3.0 parts
External additive R-1: 0.5 parts

The above material were externally mixed using FM10C (manufactured by NIPPON COKE & ENGINEERING CO., LTD.).

The external addition was conducted under the following conditions: amount of toner particles to be charged: 1.8 kg, the rotation speed: 60 s⁻¹, and external addition time: 15 minutes. After that, the particles were sieved with a mesh having an opening size of 200 μm, thereby obtaining a toner S-1. The physical properties of the toner S-1 are shown in Table 20.

### 2-3-2. Production of Toners S-2 to S-15

The toners S-2 to S-15 were produced in the same manner to the toner S-1 except that the types and amounts of toner particles, fine particles, and external additives were changed to those in Table 20. Physical properties are shown in Table 20.

### 2-3-3. Production of Comparative Toners T-1 to T-5

Comparative Toners T-1 to T-5 were produced in the same manner to the toner S-1 except that the types and amounts of toner particles, fine particles, and external additives were changed to those in Table 20. Physical properties are shown in Table 20.

TABLE 20

| | | | | | | Toner property | | | | |
|---|---|---|---|---|---|---|---|---|---|---|
| | | | | | | | | Number- | | Volume |
| Toner/ | | | | | | Abundance | | average | | average |
| comparative | Toner | Fine | | External | | ratio of | | length of fine | | particle |
| toner | particle | particle | | additive | | metal element | | particle | Average | diameter |
| No. | No. | No | parts | No. | parts | Element | [atomic % ] | [μm] | circularity | [μm] |
| S-1 | P-1 | Q-1 | 3.0 | R-1 | 0.5 | Al | 5.1 | 0.12 | 0.982 | 6.8 |
| S-2 | P-1 | Q-1 | 2.0 | R-1 | 0.5 | Al | 2.0 | 0.11 | 0.982 | 6.8 |
| S-3 | P-1 | Q-1 | 5.0 | R-1 | 0.5 | Al | 9.8 | 0.12 | 0.982 | 6.8 |
| S-4 | P-1 | Q-1 | 8.0 | R-1 | 0.5 | Al | 20.0 | 0.12 | 0.982 | 6.8 |
| S-5 | P-1 | Q-2 | 3.0 | R-1 | 0.5 | Ti | 5.7 | 0.03 | 0.982 | 6.8 |
| S-6 | P-1 | Q-3 | 4.0 | R-1 | 0.5 | Ti | 4.6 | 0.29 | 0.982 | 6.8 |
| S-7 | P-1 | Q-4 | 4.0 | R-1 | 0.5 | Zn | 5.3 | 0.27 | 0.982 | 6.8 |
| S-8 | P-1 | Q-5 | 3.0 | R-1 | 0.5 | Ti | 5.0 | 0.09 | 0.982 | 6.8 |
| S-9 | P-1 | Q-9 | 3.0 | R-1 | 0.5 | Zr | 5.0 | 0.02 | 0.982 | 6.8 |
| S-10 | P-1 | Q-10 | 3.0 | R-1 | 0.5 | Ti | 5.0 | 0.03 | 0.982 | 6.8 |
| S-11 | P-2 | Q-1 | 3.0 | R-1 | 0.5 | Al | 5.3 | 0.11 | 0.973 | 6.5 |
| S-12 | P-1 | Q-6 | 3.0 | R-1 | 0.5 | Al | 6.5 | 0.01 | 0.982 | 6.8 |
| S-13 | P-1 | Q-7 | 4.0 | R-1 | 0.5 | Al | 4.4 | 0.20 | 0.982 | 6.8 |
| S-14 | P-1 | Q-8 | 5.0 | R-1 | 0.5 | Al | 4.8 | 0.50 | 0.982 | 6.8 |
| S-15 | P-1 | Q-2 | 3.0 | — | — | Ti | 6.0 | 0.03 | 0.982 | 6.8 |
| T-1 | P-2 | — | — | R-1 | 0.5 | — | 0.0 | — | 0.973 | 6.5 |
| T-2 | P-2 | Q-2 | 1.0 | R-1 | 0.5 | Ti | 1.0 | 0.03 | 0.973 | 6.5 |
| T-3 | P-2 | Q-2 | 15.0 | — | — | Ti | 26.3 | 0.03 | 0.973 | 6.5 |
| T-4 | P-3 | Q-2 | 3.0 | R-1 | 0.5 | Ti | 5.3 | 0.03 | 0.962 | 6.7 |
| T-5 | P-4 | Q-2 | 3.0 | R-1 | 0.5 | Ti | 5.1 | 0.03 | 0.945 | 7.1 |

### 3. PRODUCTION EXAMPLE OF DEVELOPING APPARATUS

As a process cartridge, Toner Cartridge 318 (Cyan) (manufactured by Canon Inc.) was prepared. Next, in order to reduce the torque of the developing apparatus, the toner supply roller was removed from the developing apparatus of the process cartridge. Further, the developing roller was removed from the above-described developing apparatus, and a developing roller K-1 was loaded. In addition, the toner was removed from the developing apparatus, 70 g of toner S-1 was filled, and the developing apparatus X-1 and a process cartridge including the developing apparatus X-1 were produced.

### 3-2. Production Examples of Developing Apparatuses X-2 to X-44

The developing apparatuses X-2 to X-44 were produced in the same manner to the developing apparatus X-1 except that the developing roller and the toner were changed to those shown in Table 21.

### 3-3. Production of Comparative Developing Apparatuses Y-1 to Y-6

The comparative developing apparatuses Y-1 to Y-6 were produced in the same manner to the developing apparatus X-1 except that the developing rollers (comparative developing rollers) and the toner (comparative toner) were changed as shown in Table 21.

TABLE 21

| Developing | Developing | |
|---|---|---|
| apparatus/comparative | roller/comparative | Toner/comparative |
| developing apparatus No. | developing roller No. | toner No. |
| X-1 | K-1 | S-1 |
| X-2 | K-1 | S-2 |
| X-3 | K-1 | S-3 |
| X-4 | K-1 | S-4 |
| X-5 | K-1 | S-5 |
| X-6 | K-1 | S-6 |
| X-7 | K-1 | S-7 |
| X-8 | K-1 | S-8 |
| X-9 | K-1 | S-9 |
| X-10 | K-1 | S-10 |
| X-11 | K-1 | S-11 |
| X-12 | K-1 | S-12 |
| X-13 | K-1 | S-13 |
| X-14 | K-1 | S-14 |
| X-15 | K-1 | S-15 |
| X-16 | K-2 | S-1 |
| X-17 | K-3 | S-1 |
| X-18 | K-4 | S-1 |
| X-19 | K-5 | S-1 |
| X-20 | K-6 | S-1 |
| X-21 | K-7 | S-1 |
| X-22 | K-8 | S-1 |
| X-23 | K-9 | S-1 |
| X-24 | K-10 | S-1 |
| X-25 | K-11 | S-1 |
| X-26 | K-12 | S-1 |
| X-27 | K-13 | S-1 |
| X-28 | K-14 | S-1 |
| X-29 | K-15 | S-1 |
| X-30 | K-16 | S-1 |
| X-31 | K-16 | S-2 |
| X-32 | K-16 | S-3 |
| X-33 | K-16 | S-4 |
| X-34 | K-16 | S-5 |
| X-35 | K-16 | S-6 |
| X-36 | K-16 | S-7 |
| X-37 | K-16 | S-8 |
| X-38 | K-16 | S-9 |
| X-39 | K-16 | S-10 |
| X-40 | K-16 | S-11 |
| X-41 | K-16 | S-12 |
| X-42 | K-16 | S-13 |
| X-43 | K-16 | S-14 |
| X-44 | K-16 | S-15 |
| Y-1 | K-16 | T-1 |
| Y-2 | K-16 | T-2 |
| Y-3 | K-16 | T-3 |
| Y-4 | K-16 | T-4 |
| Y-5 | K-16 | T-5 |
| Y-6 | L-1 | S-15 |

### 4. EXAMPLES

### 4-1. Example 1

Hereinafter, the evaluation method and the evaluation criteria of the present disclosure will be described.

As the electrophotographic image forming apparatus, a remodeling machine of a commercially available laser printer, LBP-7600C (manufactured by CANON INC.) was used. The configuration of the remodeling machine is shown in FIG. 11. As a modification, in addition to the power supplies 14C and 15C, an external high-voltage power supply 20C was connected so that an arbitrary potential difference could be established between the developing blade and the developing roller.

As the process cartridge for evaluation, a process cartridge to which the developing apparatus X-1 is attached was used.

In addition, yellow, magenta, and black cartridges were inserted into the yellow, magenta, and black stations, respectively, with the product toner removed and the remaining toner detection mechanism disabled, and the evaluation was performed.

Note that the work function of the developing blade (made of SUS304) installed in the above-described developing apparatus was 4.7 eV.

Initial Ghost Image Evaluation and Density Non-Uniformity Image Evaluation in Low-Temperature and Low-Humidity Environment

The low-temperature and low-humidity environment is an environment in which the toner is likely to charge up in response to rubbing with a contact member. Therefore, especially in cases where the toner supply roller is eliminated or the peripheral speed difference between the toner supply roller and the developing roller is reduced, it becomes more difficult for the toner on the developing roller to be replaced, making ghost images more likely to occur.

The above process cartridge, the remodeling machine of the above laser printer, and the evaluation paper (GFC81 [manufactured by Canon], A4: 81.4 g/m²) were left to stand for 24 hours under a low-temperature and low-humidity environment of 15° C. and 10% relative humidity.

The process cartridge that had been left to stand was mounted in the remodeling machine of the laser printer, and the potential difference between the developing blade and the developing roller during operation of the developing apparatus was set to −300 V. In addition, the potential difference was maintained at −300 V at all times, including during the timing corresponding to the interval between sheets of paper during image output, that is, even during non-image formation periods.

Under these conditions, five sheets of ghost evaluation images (images composed of a 10 mm-wide solid black area from the leading edge in the image conveyance direction, a 2 mm-wide solid white area, and a 200 mm area of 50% density halftone) were continuously output. It should be noted that the 10 mm in the image conveyance direction is narrower than one full rotation of the developing roller, and by printing the 10 mm-wide solid black area, toner is mostly developed only on a partial region of the developing roller. If the toner on the developing roller cannot be spontaneously replaced, a difference in the number of rubbing occurrences arises between the region where toner was consumed and the region where toner was not consumed on the developing roller, causing a difference in the toner charge amount. At this time, in the 50% density halftone area of the ghost evaluation image, a density difference (ghost) having the same shape as the 10 mm-wide solid black area appears.

The obtained image was evaluated based on the following evaluation criteria. The results are shown in Table 22 below.

### Initial Ghost Image Evaluation

Rank A: A ghost cannot be visually recognized in all the obtained five images.
Rank B: A ghost can be visually recognized very slightly from any of the five images obtained.
Rank C: A ghost can be slightly visually recognized from any of the five images obtained.
Rank D: A ghost can be clearly visually recognized from any of the five images obtained.

Ghost Image Evaluation and Density Non-Uniformity Image Evaluation After Durability Test Under Low-Temperature and Low-Humidity Environment

The low-temperature and low-humidity environment, as described above, is an environment in which the toner is likely to become charged up due to rubbing against the contact member, making it difficult for the toner on the developing roller to be replaced, thereby making ghost images more likely to occur. Furthermore, since the toner is difficult to be replaced, in a case where the developing apparatus is used over a durability test, the toner on the developing roller continues to undergo repeated rubbing by contact members such as the developing blade. As a result, the toner deteriorates and undergoes melt adhesion to the developing roller. When toner is melt-adhered to the developing roller, unevenness occurs in the charge amount of toner and the toner amount of toner transport on the developing roller, which appears as a fog-like density non-uniformity image.

In addition, in a low-temperature and low-humidity environment, toner components, in particular, particularly fine particles such as external additives, are more likely to adhere to the developing roller due to the durability, making the triboelectric series between the toner and the developing blade more susceptible to change.

The above process cartridge, the remodeling machine of the above laser printer, and the evaluation paper (GFC81 [manufactured by Canon], A4: 81.4 g/m²) were left to stand for 24 hours under a low-temperature and low-humidity environment of 15° C. and 10% relative humidity.

The process cartridge that had been left to stand was installed in the remodeling machine of the laser printer, and the potential difference between the developing blade and the developing roller was set to be constantly −300 V even during non-image formation, that is, during the interval between sheets of paper to be output. Under this condition, 20,000 images with a print percentage of 2% were output.

Subsequently, five sheets of ghost evaluation images (images composed of a 10 mm-wide solid black area from the leading edge in the image conveyance direction, a 2 mm-wide solid white area, and a 200 mm area of 50% density halftone) were continuously output.

The obtained image was evaluated based on the following evaluation criteria. The results are shown in Table 22 below.

### Ghost Image Evaluation After Durability Test

Rank A: A ghost image cannot be visually recognized in all the five images.
Rank B: A ghost image was faintly visually recognized in one of the five images.
Rank C: A ghost image was slightly visually recognized in one of the five images.
Rank D: A ghost image can be clearly visually recognized from any of the five images.
   Image Evaluation of Image Density Non-Uniformity after Durability Test
Rank A: All five output images showed no visible image density non-uniformity in the halftone area.
Rank B: A very slight image density non-uniformity was visually recognized in the halftone area of one of the five output images.
Rank C: A slight image density non-uniformity was visually recognized in the halftone area of one of the five output images.
Rank D: An image density non-uniformity was clearly visually recognized in the halftone area of one of the five output images.

### Evaluation of Toner Transportability in High-Temperature and High-Humidity Environment

In a high-temperature and high-humidity environment, the insulating portion of the developing roller tends to have difficulty becoming charged. Therefore, particularly in a case where the toner supply roller is eliminated, or in a case where the difference in peripheral speed between the toner supply roller and the developing roller is reduced, the toner transport amount of the developing roller tends to decrease. When the toner transport amount decreases, the image density decreases toward the rear end of the printed image during solid black image printing.

The process cartridge, the remodeling machine of the laser printer, and the evaluation paper (GFC81 [manufactured by Canon Inc.]A4:81.4 g/m²) were allowed to stand for 24 hours in an environment of a temperature of 30° C. and a relative humidity of 80%, which is a high temperature and high humidity environment.

The process cartridge, which had been left to stand in the above-described environment, was installed in the remodeling machine of the laser printer, and the potential difference between the developing blade and the developing roller during the operation of the developing apparatus was set to −300 V. Under this condition, one all-black image was output.

The density of the resulting all-black image was measured using a spectrodensitometer (trade name: X-Rite 504, manufactured by SDG Co., Ltd.). A value obtained by subtracting the arithmetic mean of the image densities at 5 points within 20.0 mm from the rear end in the image transporting direction from the arithmetic mean of the image densities at 5 points within 20.0 mm from the tip end in the image transporting direction was obtained as an image density difference.

The obtained image was evaluated based on the following evaluation criteria. The results are shown in Table 22 below.

### Image Evaluation of Image Density Non-uniformity After Durability Test

Rank A: The image density difference is less than 0.10
Rank B: The image density difference is 0.10 or more and less than 0.20
Rank C: The image density difference is 0.20 or more and less than 0.30
Rank D: The image density difference is 0.30 or more

### 4-2. Examples 2 to 44 and Comparative Examples 1 to 6

Evaluation was performed in the same manner as in Example 1 except that the developing apparatuses X-2 to X-44 and the comparative developing apparatuses Y-1 to Y-6 were used. The evaluation results are shown in Table 22 below.

TABLE 22

| | | | | In low temperature and | | | In high- |
|---|---|---|---|---|---|---|---|
| | | | | low-humidity environment | | | temperature |
| | Developing | Developing | | | Ghost | Density non- | and high- |
| | apparatus/ | roller/ | | | image | uniformity | humidity |
| | comparative | comparative | Toner/ | Initial | evaluation | image | environment |
| Example/ | developing | developing | comparative | ghost | after | evaluation | Toner |
| comparative | apparatus | roller | toner | image | durability | after | transportability |
| example No. | No. | No. | No. | evaluation | test | durability test | evaluation |
| Example 1 | X-1 | K-1 | S-1 | A | A | A | A |
| Example 2 | X-2 | K-1 | S-2 | A | A | B | A |
| Example 3 | X-3 | K-1 | S-3 | A | A | A | A |
| Example 4 | X-4 | K-1 | S-4 | A | A | A | A |
| Example 5 | X-5 | K-1 | S-5 | A | A | A | A |
| Example 6 | X-6 | K-1 | S-6 | A | B | A | A |
| Example 7 | X-7 | K-1 | S-7 | B | B | B | A |
| Example 8 | X-8 | K-1 | S-8 | A | A | A | A |
| Example 9 | X-9 | K-1 | S-9 | A | A | A | A |
| Example 10 | X-10 | K-1 | S-10 | A | A | A | A |
| Example 11 | X-11 | K-1 | S-11 | A | A | B | A |
| Example 12 | X-12 | K-1 | S-12 | A | A | A | A |
| Example 13 | X-13 | K-1 | S-13 | A | A | A | A |
| Example 14 | X-14 | K-1 | S-14 | B | B | A | A |
| Example 15 | X-15 | K-1 | S-15 | A | A | A | A |
| Example 16 | X-16 | K-2 | S-1 | A | A | A | A |
| Example 17 | X-17 | K-3 | S-1 | A | A | A | A |
| Example 18 | X-18 | K-4 | S-1 | A | A | A | A |
| Example 19 | X-19 | K-5 | S-1 | A | A | A | A |
| Example 20 | X-20 | K-6 | S-1 | A | A | A | A |
| Example 21 | X-21 | K-7 | S-1 | A | A | A | A |
| Example 22 | X-22 | K-8 | S-1 | A | A | A | A |
| Example 23 | X-23 | K-9 | S-1 | A | A | A | A |
| Example 24 | X-24 | K-10 | S-1 | A | A | A | A |
| Example 25 | X-25 | K-11 | S-1 | A | A | A | A |
| Example 26 | X-26 | K-12 | S-1 | A | A | A | A |
| Example 27 | X-27 | K-13 | S-1 | A | A | A | A |
| Example 28 | X-28 | K-14 | S-1 | A | A | A | A |
| Example 29 | X-29 | K-15 | S-1 | A | A | A | A |
| Example 30 | X-30 | K-16 | S-1 | B | B | B | A |
| Example 31 | X-31 | K-16 | S-2 | B | B | C | A |
| Example 32 | X-32 | K-16 | S-3 | B | B | B | A |
| Example 33 | X-33 | K-16 | S-4 | B | B | B | A |
| Example 34 | X-34 | K-16 | S-5 | B | B | B | A |
| Example 35 | X-35 | K-16 | S-6 | B | C | C | B |
| Example 36 | X-36 | K-16 | S-7 | C | C | C | A |
| Example 37 | X-37 | K-16 | S-8 | B | B | B | A |
| Example 38 | X-38 | K-16 | S-9 | B | B | B | A |
| Example 39 | X-39 | K-16 | S-10 | B | B | B | A |
| Example 40 | X-40 | K-16 | S-11 | B | B | C | A |
| Example 41 | X-41 | K-16 | S-12 | B | B | B | A |
| Example 42 | X-42 | K-16 | S-13 | B | B | B | A |
| Example 43 | X-43 | K-16 | S-14 | C | C | B | A |
| Example 44 | X-44 | K-16 | S-15 | B | B | B | A |
| C.E. 1 | Y-1 | K-16 | T-1 | D | D | D | A |
| C.E. 2 | Y-2 | K-16 | T-2 | D | D | D | A |
| C.E. 3 | Y-3 | K-16 | T-3 | U* | U* | U* | U* |
| C.E. 4 | Y-4 | K-16 | T-4 | D | D | D | A |
| C.E. 5 | Y-5 | K-16 | T-5 | D | D | D | A |
| C.E. 6 | Y-6 | L-1 | S-15 | D | D | D | D |

In Table 22, “C.E.” represents Comparative Example, and “U” represents Unable to evaluate. * In Comparative Example 3, due to poor transferability caused by an excessive decrease in toner charge, the toner could not be sufficiently transported to the evaluation paper, and image evaluation was not possible.

From the above results, by adopting the developing apparatus of the present disclosure, even in a state in which the drive torque of the developing apparatus is reduced, it is possible to suppress the occurrence of ghost images, density non-uniformity images, and toner transport failure without relying on the control of the potential difference between the developing roller and the developing blade during non-image formation.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-145429, filed Aug. 27, 2024, which is hereby incorporated by reference herein in its entirety.

What is claimed is:

1. A developing apparatus comprising:
a developing roller and a toner, wherein
the developing roller comprises
a substrate having a conductive outer surface, and
a conductive layer on the outer surface of the substrate,
an outer surface of the developing roller is formed of at least a first region and a second region having higher conductivity than the first region,
the first region and the second region are placed adjacent to each other,
the first region is placed on an outer surface of the conductive layer,
the toner comprises a toner particle and a fine particle, the fine particle comprises a compound comprising a metal element,
the metal element is at least one element selected from the group consisting of a titanium element, an aluminum element, a zirconium element, and a zinc element,
when the toner surface is measured by X-ray photoelectron spectroscopy, the abundance ratio of the metal element is 2.0 to 20.0 atomic %, and
an average circularity of the toner is 0.970 or more.

2. The developing apparatus according to claim 1, wherein
a conductivity of the fine particle obtained by impedance measurement is 1.0×10⁻⁹ to 1.0×10² S/m.

3. The developing apparatus according to claim 1, wherein
when an EDS mapping image of constituent elements in a cross section of the toner obtained by analyzing a cross section of the toner observed by a scanning transmission electron microscope using an energy-dispersive X-ray spectrometer is obtained,
a number average length of fine particles having signals derived from the metal element, in a normal direction to a contour of the toner particle at a contact point between the fine particles having signals derived from the metal element and the toner particle, is 0.01 to 0.50 μm.

4. The developing apparatus according to claim 1, wherein
a compound comprising the metal element is at least one selected from the group consisting of titanium oxide, aluminum oxide, zinc oxide, strontium titanate, zirconium phosphate, and titanium phosphate.

5. The developing apparatus according to claim 1, wherein
when a square observation region with a side length of 300 μm is placed on the outer surface of the developing roller such that an axial direction of the developing roller and one side of the observation region are parallel to each other, a proportion of a total area of the first region to an area of the square observation region is 10 to 60 area %.

6. The developing apparatus according to claim 1, wherein
in a case where when a corona discharger having a grid portion with a width of 3.0 mm is placed in an environment at a temperature of 23° C. and a relative humidity of 50% such that a distance between the grid portion and the outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/see to charge the outer surface of the developing roller, and a potential of the outer surface at t seconds after passage of the grid portion is measured,
a change in the potential at 30.00≤t≤100.00 is fitted to a formula (X′) below by a least squares method to obtain V_{0,1} [V] and τ₁ [sec], τ₁ is 60.0 seconds or more:
$${V}_{1} ( t ) = {V}_{0 , 1} exp ( - t / {τ}_{1} ) . \qquad ( X ’ )$$

7. The developing apparatus according to claim 1, wherein
in a case where when a corona discharger having a grid portion with a width of 3.0 mm is placed in an environment at a temperature of 23° C. and a relative humidity of 50% such that a distance between the grid portion and the outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured,
a change in the potential at 30.00≤t≤100.00 is fitted to a formula (X′) below by a least squares method to obtain V_{0,1} [V] and τ₁ [sec], when a value of a potential V₁(t) at the time of substituting t=0.06 [sec] into the Formula (X′) is denoted by V₁ [V], V₁ is 5.0 V or more:
$${V}_{1} ( t ) = {V}_{0 , 1} exp ( - t / {τ}_{1} ) . \qquad ( X ’ )$$

8. The developing apparatus according to claim 1, wherein
in a case where when a corona discharger having a grid portion with a width of 3.0 mm is placed in an environment at a temperature of 23° C. and a relative humidity of 50% such that a distance between the grid portion and the outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured,
the potential at t=0.06 [sec] is denoted by V_{INI} [V],
a change in the potential at 30.00≤t≤100.00 is fitted to a formula (X′) below by a least squares method to obtain V_{0,1} [V] and τ₁ [sec], when a value of a potential V₁(t) at the time of substituting t=0.06 [sec] into the Formula (X′) is denoted by V₁ [V], V_{INI}−V₁ is less than 20.0 V:
$${V}_{1} ( t ) = {V}_{0 , 1} exp ( - t / {τ}_{1} ) . \qquad ( X ’ )$$

9. The developing apparatus according to claim 1, wherein
in a case where when a corona discharger having a grid portion with a width of 3.0 mm is placed in an environment at a temperature of 23° C. and a relative humidity of 50% such that a distance between the grid portion and an outer surface of the developing roller is 1.0 mm and a direction of the width of the grid portion is aligned with an axial direction of the developing roller, then a voltage of 8 kV is applied to the grid portion and the corona discharger is relatively moved along the axial direction of the developing roller at a speed of 400 mm/sec to charge the outer surface of the developing roller, and a potential of the outer surface at t seconds after passage of the grid portion is measured,
a change in the potential at 0.06≤t≤100.00 is fitted to a formula (Y) below by a least squares method to obtain V_{0,2} [V] and τ₂ [sec],
τ₂ is 6.0 seconds or less:
$$V ( t ) = {V}_{1} ( t ) + {V}_{2} ( t ) \qquad ( Y )$$
$$in the formula ( Y ) , {V}_{2} ( t ) = {V}_{0 , 2} exp ( - t / {τ}_{2} ) . \qquad ( Z )$$

10. The developing apparatus according to claim 1, wherein,
when a metal film is directly provided on the outer surface of the developing roller, and while changing a frequency between 1.0×10⁻¹ to 1.0×10⁵ Hz, an AC voltage with an amplitude of 50 V is applied between the outer surface of the substrate and the metal film while a DC voltage of 50 V is applied in an environment at a temperature of 23° C. and a relative humidity of 50%, an impedance at a frequency of 1.0×10⁰ to 1.0×10¹ Hz is 1.0×10⁶Ω or more.

11. The developing apparatus according to claim 1, wherein
the conductive layer comprises a polyurethane.

12. The developing apparatus according to claim 1, wherein
the conductive layer comprises a polyurethane having a polycarbonate structure.

13. The developing apparatus according to claim 12, wherein
the polyurethane satisfies at least two of the following (A), (B), and (C):
(A) the polyurethane has a structure represented by a structural formula (1) below in a molecule;
(B) the polyurethane has one or both structures of a structure represented by a structural formula (2) below and a structure represented by a structural formula (3) below in a molecule; and
(C) the polyurethane has a structure represented by a structural formula (4) below in a molecule: 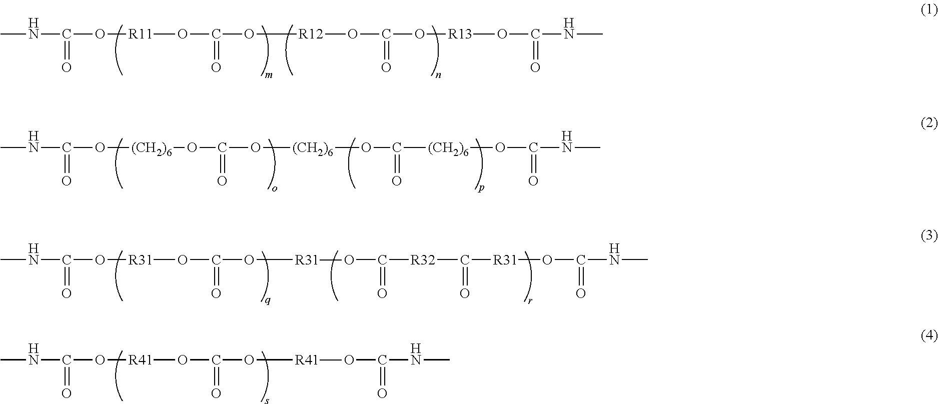
in the structural formula (1), R11, R12, and R13 represent a divalent hydrocarbon group having 3 to 9 carbon atoms, provided that R11 and R12 are different from each other, and R13 is the same as at least one selected from a group consisting of R11 and R12, m and n are average numbers of moles added, and each independently represent a number of 1.0 or more,
in the structural formula (2), o and p are average numbers of moles added, and each independently represent a number of 1.0 or more,
in the structural formula (3), R31 and R32 each independently represent a divalent hydrocarbon group having 3 to 8 carbon atoms, q and r are average numbers of moles added, and each independently represent a number of 1.0 or more,
in the structural formula (4), R41 represents a divalent hydrocarbon group having 6 to 9 carbon atoms, and s is an average number of moles added, and represents a number of 1.0 or more.

14. The developing apparatus according to claim 1, wherein
the conductive layer comprises a carbon black.

15. The developing apparatus according to claim 11, wherein
the conductive layer comprises at least one selected from the group consisting of a compound represented by a structural formula (5) below, a compound represented by a structural formula (6) below, and a compound represented by a structural formula (7) below. 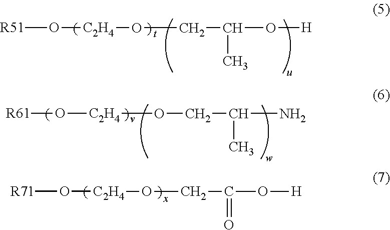
in the structural formula (5), R51 represents a monovalent hydrocarbon group having 1 to 12 carbon atoms, and t and u are average numbers of moles added, and each independently represent a number of 1.0 or more,
in the structural formula (6), R61 represents a monovalent hydrocarbon group having 1 to 8 carbon atoms, and v and w are average numbers of moles added, and each independently represent a number of 1.0 or more,
in the structural formula (7), R71 represents a monovalent hydrocarbon group having 1 to 12 carbon atoms, and x is an average number of moles added, and represents a number of 1.0 or more.

16. A process cartridge configured to be attachable to and detachable from a main body of an electrophotographic image forming apparatus, the process cartridge comprising a developing unit, wherein the developing unit comprises the developing apparatus according to claim 1.

17. An electrophotographic image forming apparatus comprising a developing unit, wherein the developing unit comprises the developing apparatus according to claim 1.
